(19) United States
(12) Patent Application Publication
(10) Pub. No.: US 2014/0234640 A1
(43) Pub. Date: Aug. 21, 2014

(54) GAS BARRIER FILM, MANUFACTURING METHOD THEREOF, AND SUBSTRATE FOR ELECTRONIC ELEMENT USING THE SAME

(71) Applicants: Junichi Kohno, Tokyo (JP); Hidetoshi Ezure, Tokyo (JP)

(72) Inventors: Junichi Kohno, Tokyo (JP); Hidetoshi Ezure, Tokyo (JP)

(73) Assignee: Konica Minolta, Inc., Tokyo (JP)

(21) Appl. No.: 14/241,201

(22) PCT Filed: Aug. 24, 2012
(86) PCT No.: PCT/JP2012/071454

§ 371 Date: Feb. 26, 2014

(30) Foreign Application Priority Data
Aug. 31, 2011 (JP) 2011-189749

(51) Int. Cl. G02B 1/10

(52) U.S. Cl. CPC G02B 1/105
USPC 428/452; 428/533; 264/447; 264/129

(57) ABSTRACT

Provided are a gas barrier film which has excellent transparency, surface smoothness, gas barrier property and adhesivity and a manufacturing method thereof, and a substrate for an electronic element using the same. The gas barrier film of the present invention has a sheet substrate which contains a surface-modified cellulose nanofiber in which at least a part of hydrogen atoms in a hydroxyl group in a cellulose nanofiber are substituted with acyl groups each having 1 to 8 carbon atoms and has a content of a matrix resin of 10% by mass or less with respect to the total amount of the cellulose nanofiber and the matrix resin, and a gas barrier layer which is formed on at least one surface of the sheet substrate. The manufacturing method of the gas barrier film of the present invention has a step A of obtaining surface-modified cellulose nanofiber by substituting as least a part of hydrogen atoms in a hydroxyl group in the cellulose nanofiber with acyl groups each having 1 to 8 carbon atoms and forming the surface-modified cellulose nanofiber into a film by a melt extrusion method or a solution casting method, and a step B of forming a bas barrier layer on the sheet substrate.

### TECHNICAL FIELD

The present invention relates to a gas barrier film and a manufacturing method thereof, and a substrate for an electronic element using the same.

### BACKGROUND ART

In general, glass plates have been extensively used as display element substrates such as liquid crystal and organic EL, color filter substrates, solar battery substrates, and the like. However, plastic materials have been studied as substitutes for the glass plates in recent years for the reason that a glass plate easily breaks, cannot be bent, is not suitable for lightening its weight due to a large specific gravity, and so on.

For example, a resin substrate obtained by impregnating an unwoven fabric with an epoxy resin and thermally curing (Patent Literature 1) and a plastic substrate for liquid crystal display element made of a complex containing cellulose and a resin other than cellulose (Patent Literature 2) have been known.

However, the above described plastic materials for substitutes for glass are interior in transparency and a coefficient of linear expansion as compared to glass plates, and thus have problems such as generation or deterioration in transparency, and warpage and breakage by curl, etc., due to a heat treatment, and the like, in production steps. Furthermore, since a void ratio of an unwoven fabric is uneven, permeation of a resin is not uniform when the unwoven fabric sheet is impregnated with the resin and bubbles are generated, which causes a problem such as defects. Therefore, application of the above described substitute materials to use for substrates of display elements, and the like, is difficult.

As methods for improving these problems, a technique of improving permeation or a matrix resin (matrix material) by modifying a cellulose nanofiber, and a technique of forming a cellulose nanofiber and a matrix resin into a film by a melt blending method or a solution cast method are disclosed (Patent Literatures 3 and 4).

On the other hand, high gas barrier property is required in substrates for various display elements in addition to the above described performance. Therefore, many trials such as providing various hard coat layers and gas barrier layers on one surface of both surfaces of a substrate to further improve gas barrier characteristics from the level inherent to the substrate have been carried out in recent years.

Examples of a method of imparting gas barrier property without accompanying performance deterioration in a liquid crystal display element and an organic EL element include a method of depositing a gas barrier layer made of SiO₂, and the like, a method of forming a gas barrier layer by coating an application-based silica material such as an organic solvent solution of alkoxysilane and heating to cause a three-dimensional reaction, and a method of forming a gas barrier layer by coating a polysilazane-containing liquid and performing a modification treatment (such as a plasma treatment and an ultraviolet irradiation) (for example, Patent Literature 5).

### CITATION LIST

### Patent Literature

Patent Literature 1: US Patent Application Publication No. 2004/132867

Patent Literature 2: Japanese Patent Application Laid-open No. 2006-316253

Patent Literature 3: Japanese Patent Application Laid-open No. 2008-208231

Patent Literature 4: Japanese Patent Application Laid-Open No. 2008-209595

Patent Literature 5: Japanese Parent Application Laid-Open No. 2007-237588

### SUMMARY OF INVENTION

### Technical Problem

In cellulose nanofiber substrates as disclosed in the above described Patent Literatures 3 and 4, matrix resins such as a cellulose resin exist around the cellulose fiber. Since these techniques accompany blending of a cellulose nanofiber and a matrix resin, surface smoothness and transparency are insufficient.

The gas barrier layer as disclosed in Patent Literature 5 has a problem such that an applicable substrate is limited. For example, when the gas barrier layer described in Patent Literature 5 is formed on a surface of a cellulose nanofiber substrate having a matrix resin as described in the above Patent Literature 3 or 4, there was a problem that. layer interfacial separation between the matrix resin and the cellulose nanofiber and unevenness of minute surface properties are caused by a modification treatment in formation of the gas barrier layer, and gas barrier property is not only improved, but adhesivity between the substrate and the gas barrier layer and surface smoothness are also damaged.

As described above, it was difficult to obtain a plastic substrate satisfying transparency, smoothness, adhesivity, and gas barrier property, which are required in a display element substrate by the techniques described in Patent Literatures 3 to 5.

The present invention was achieved in view or the problems described above, and an object thereof is to provide a gas barrier film having excellent transparency, surface smoothness, gas barrier property and adhesivity, a manufacturing method of the gas barrier film, and a substrate for an electronic element using the gas barrier film.

### Solution to Problem

Inventors of the present invention conducted intensive studies in view of the problems described above, and as a result, found that the problems are solved by forming a gas barrier film on a substrate which does not substantially contain a matrix resin and is constituted with a surface-modified cellulose nanofiber in which at least a part of hydrogen atoms in a hydroxyl group in cellulose in the surface of the cellulose nanofiber are substituted with acyl groups each having 1 to 8 carbon atoms, and the present invention was thus achieved.

That is, the object of the present invention described above as achieved by the following constitution.

(1) A gas barrier film including a sheet substrate which contains a surface-modified cellulose nanofiber in which at least a part of hydrogen atoms in a hydroxyl group in a cellulose nanofiber are substituted with acyl groups each having 1 to 8 carbon atoms and has a content of a matrix resin of 10% by mass or less with respect to the total amount of the cellulose nanofiber and the matrix resin, and a gas barrier layer which is formed on at least one surface of the sheet substrate.

(2) The gas barrier film according to the item (1), wherein the acyl group includes a propanoyl group.

(3) The gas barrier film according to the item (1) or (2), wherein the gas barrier layer contains at least one of silicon oxide or silicon nitride oxide.

(4) A manufacturing method of a gas barrier film, including a step A of obtaining a surface-modified cellulose nanofiber by substituting at least a part of hydrogen atoms in a hydroxyl group in a cellulose nanofiber with acyl groups each having 1 no 8 carbon atoms and forming the surface-modified cellulose nanofiber into a film by a melt extrusion method or a solution cast method, and a step B of forming a gas barrier layer on the sheet substrate.

(5) The manufacturing method according to the item (4), wherein a stretching treatment or/and a heat calendering treatment are performed after forming a film in the step A.

(6) The manufacturing method according to the item (4) or (5), wherein the step B includes an excimer irradiation treatment after applying a coating liquid containing a polysilazane compound onto the sheet substrate.

(7) A substrate for an electronic element using the gas barrier film according to any one of the items (1) to (3) or a gas barrier films which is manufactured by the manufacturing method according to any one of the items (4) to (6).

### Effects of the Invention

A sheet substrate constituting the gas barrier film of the present invention does not substantially contain a matrix resin, and thus, various gas barrier layers can be formed, and high-level transparency, surface smoothness, gas barrier property and adhesivity are attempted to be achieved. In particular, favorable adhesivity can be kept even in the case of being thermally treated in a manufacturing step of an electronic element.

### BRIEF DESCRIPTION OF DRAWING

FIG. 1 is a cross-sectional schematic diagram showing a basic structure of the gas barrier film that is one embodiment of the present invention.

### DESCRIPTION OF EMBODIMENTS

Hereinbelow, embodiments for carrying out the present invention are explained in reference to the attached drawing. In addition, the invention is not limited only to the embodiments below. A size ratio in the figure is exaggerated as a matter of convenience for explanation and may be different from an actual ratio.

According to one embodiment of the present invention, provided is a gas barrier film including a sheet substrate which contains a surface-modified cellulose nanofiber in which at least a part of hydrogen atoms in a hydroxyl group in the cellulose nanofiber are substituted with acyl groups each having 1 to 8 carbon atoms and has a content of a matrix resin of 10% by mass or less with respect to the total amount of the cellulose nanofiber and the matrix resin, and a gas barrier layer which is formed on at least one surface of the sheet substrate.

The present invention is characterized by forming a gas barrier layer formed on a substrate which is constituted with a specific surface-modified cellulose nanofiber and has a small content of a matrix resin (substantially does not contain a matrix resin). That is, it was found that high-level transparency, surface smoothness, gas barrier property, and adhesivity can be achieved as compared to a conventional resin-impregnated film using a matrix resin by use of a film substrate which does not substantially contain a matrix resin and is obtained by forming a surface-modified cellulose nanofiber into a film, and the present invention thus reached completion.

The detailed mechanism of the present invention has not been revealed yet, but by use of a cellulose nanofiber in which the surface of the cellulose nanofiber is substituted with an acyl group without substantially containing a matrix resin, since an amorphous resin component (acyl group component) in the surface layer is molten to uniformly spread while intertwist with the cellulose nanofiber component is kept, a gap of refractive indices is less and uniformity of nanofibers in the film is also preferable as compared to a system mixing a matrix resin. Therefore, transparency and adhesivity can be maintained even when the invention is thermally processed in a later manufacturing step of an electronic element.

Hereinbelow, the present invention are explained in detail.

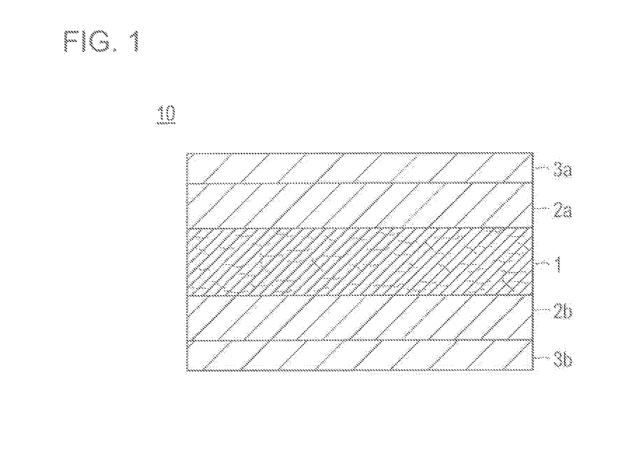

FIG. 1 is a cross-sectional schematic diagram showing a basic structure of the gas barrier film that is one embodiment of the present invention. As shown in FIG. 1, a gas barrier film 10 is constituted with a sheet substrate 1, a pair of intermediate layers (an intermediate layer 2a and an intermediate layer 2b) which sandwiches the sheet substrate 1, and a pair of gas barrier layers (a gas barrier layer 3a and a gas barrier layer 3b) which sandwiches a laminated material made of the sheet substrate 1 and the intermediate layers (2a and 2b). Specifically, intermediate layers (2a, 2b) are provided on the both surfaces of the sheet substrate 1, and the gas barrier layers 3 are laminated on the upper parts of the intermediate layers (2a, 2b).

In the embodiment shown in FIG. 1, the intermediate layers (2a, 2b) are interposed between the sheet substrate 1 and the gas barrier layers 3. When the intermediate layers (2a, 2b) are interposed between the sheet substrate 1 and the gas barrier layers (3a, 3b), the film thickness for the intermediate layers are increased, and formation of the gas barrier layers are uniformly preformed, and therefore, gas barrier property can be improved. Note that an effect of improving gas barrier characteristics due to the intermediate layers is restrictive, and sufficient gas barrier characteristics are not exerted only with the intermediate layers. However, in the present invention, gas barrier layers may be formed on a sheet substrate, and the gas barrier layers (3a, 3b) may be directly laminated on the upper surface of the sheet substrate 1 without placing the intermediate layers (2a, 2b).

In the embodiment shown in FIG. 1, the gas barrier layers (3a, 3b) are formed on the both surfaces of the sheet substrate 1, but a gas barrier layer (3a or 3b) may be formed only on one surface of the sheet substrate 1.

Furthermore, the present invention may also take a structure in which an intermediate layer (2a or 2b) is provided on one surface of the sheet substrate 1 and an intermediate layer is not provided on the other surface.

Hereinbelow, members constituting the gas barrier film 10 are explained.

(Sheet Substrate)

The sheet substrate 1 is constituted by containing a surface-modified cellulose nanofiber in which at least a part of hydrogen atoms in a hydroxyl group in the cellulose nanofiber are substituted with acyl groups each having 1 to 8 carbon atoms (hereinbelow, also simply referred to as “surface-modified cellulose nanofiber”) and, if necessary, a trace amount of a matrix resin, and additives such as a carbon radical scavenger, a primary antioxidant, a secondary antioxidant, an acid capturing agent, an ultraviolet absorber, a plasticizer, a mat binder, an optical anisotropy controlling agent, and a crosslinking agent.

(a) Cellulose Nanofiber

A cellulose nanofiber used in the present invention is referred to as a cellulose fiber having an average fiber diameter of 1 to 1,000 nm. It is preferably a fiber having a fiber diameter of 4 to 400 nm. When the average fiber diameter of the fiber is 400 nm or less, decrease of transparency can be suppressed since the average fiber diameter is smaller than the wavelength of visible light. When the average fiber diameter is 4 nm or more, manufacture is easy. A fiber with a fiber diameter of preferably 4 to 200 nm, more preferably 4 to 100 nm, and further more preferably 4 to 50 nm is used for the purpose of enhancing strength of a sheet substrate.

The “cellulose fiber” is referred to as a cellulose microfibril which constitutes the basic skeleton of a plant cell wall, or a constituting fiber thereof, and is generally an aggregate made from single fibers (crystalline fiber obtained by combining several tens of cellulose molecular chains with hydrogen bonds) each having a fiber diameter of about 4 nm. A cellulose fiber containing 40% or more of a crystal structure is preferable from the viewpoint of attaining high strength and low thermal expansion.

The cellulose nanofiber may be formed from a material in which single fibers are not aligned but present taking sufficient spaces so as to mutually intertwist. In this case, the fiber diameter is a diameter of a single fiber. Alternatively, the cellulose nanofiber may be a material obtained by aggregating several single fibers as a bundle to constitute one line of thread and, in this case, the fiber diameter is defined as a diameter of one line of thread.

A cellulose nanofiber used in the present invention may have an average fiber diameter set within the above described range and also contain a fiber with a fiber diameter out of the range. However, a ratio of fibers with fiber diameters out of the range with respect to the whole cellulose nanofiber is preferably 20% by mass or less, and more preferably fiber diameters of all cellulose nanofibers are within the range described above.

The length of the nanofiber is not particularly limited, and the average fiber length is preferably 50 nm or more, and more preferably 100 nm or more. When the average fiber length is within such a range, intertwist of fibers is preferable and a reinforcement effect is high, and increase of thermal expansion can be suppressed.

In the present invention, 100 fibers are randomly selected from an image obtained by observation of the cellulose nanofiber by use of a transmission electron microscope (TEM) (for example, H-1700FA model (manufactured by Hitachi, Ltd.)) or a scanning electron microscope (SEM) at 10,000 magnifications, a fiber diameter (diameter) and a fiber length per a fiber are analyzed using an image processing software (for example, WINROOF) and the “average fiber diameter” and the “average fiber length” are calculated as number average values of these fiber diameter and fiber length.

A cellulose nanofiber can be obtained by performing a fibrillation treatment on a raw material cellulose fiber. Examples of the raw material cellulose fiber include fibers separated from plant fibers such as pulp derived from plants, woods, cotton, linen, bamboo, cotton, kenaf, hemp, jute, banana, coconuts and seaweeds, fibers separated from animal fibers produced by sea squirt that is a marine animal, or a bacteria cellulose produced by acetic acid bacteria. Among these examples, fibers separated from plant fibers are preferable, and fibers obtained from pulp and cotton are particularly preferable.

A fibrillation treatment of a raw material cellulose fiber is not limited as long as a cellulose fiber maintains a fibrous state, and examples include mechanical fibrillation treatments using a homogenizer and a grinder and chemical fibrillation treatments using oxidation catalysts such as 2,2,6,6-tetramethylpiperidine-1-oxyl radical (TEMPO). Further, a raw material cellulose fiber may be miniaturized to be a microfibril state using an enzyme, or the like, in order to promote these fibrillation treatments.

As a specific method of a mechanical fibrillation treatment, for example, first, a raw material cellulose fiber such as a pulp is charged into a dispersion vessel containing water to have an amount of 0.1 to 3% by mass, and a fibrillation treatment is carried out on the raw material cellulose fiber with a high pressure homogenizer to thus obtain a water dispersion of a cellulose fiber that is fibrillated into microfibril having an average fiber diameter of about 0.1 to 10 μm. Then, by repeating grinding treatments with a grinder, or the like, a cellulose nanofiber having an average fiber diameter of about 2 to several hundreds nm can be obtained. An example of a grinder used in the above described grinding treatment includes a pure fine mill (manufactured by KURITA MACHINERY MFG. CO., LTD).

As another method, a method of using a high pressure homogenizer in which a dispersion liquid of a raw material cellulose fiber is sprayed from each of a pair of nozzles at a high pressure of about 250 MPa and the sprayed flows are collided each other at a high speed, thereby pulverizing a cellulose fiber has been known. Examples of devices to be used include “HOMOGENIZER” manufactured by SANWA MACHINERY TRADING CO., LTD. and “ULTIMAIZER SYSTEM” manufactured by SUGINO MACHINE LIMITED.

As a specific method of a chemical fibrillation treatment, for example, a method of an oxidation treatment carried out on a raw material cellulose fiber using an oxidation catalyst and, if necessary, a co-oxidant is included. According to the method, a primary hydroxyl group present in the C6 position of a pyranose unit is oxidized into carboxyl and chemically fibrillated by mutual electrostatic repulsion among fibrils. In addition, a carboxyl group is introduced into a molecule of a raw material cellulose fiber by undergoing an oxidation reaction treatment, but there may be a case that an aldehyde group is partially introduced depending on a degree of progress of the oxidation treatment. Therefore, a hydroxyl group in the fibrillated fiber after the oxidation treatment is resulted in being substituted with at least one of an aldehyde group and a carboxyl group.

As an oxidation catalyst, an N-oxyl compound can be used. A preferable example is at least one selected from the group consisting of 2,6,6-tetramethylpiperidine-N-oxyl (TEMPO), 4-acetoamide-TEMPO, 4-carboxy-TEMPO, 4-phosphonoxy-TEMPO, 2-azaadamantane-N-oxyl, 1-methyl-2-azaadamantane-N-oxyl, and 1,3-dimethyl-2-azaadamantane-N-oxyl (DMAO) from the viewpoint of a good reaction speed at normal temperature. In particular, in order to achieve high transparency and heat resistance in a film, it is preferred to use a method in which 2,2,6,6-tetramethylpiperidine-1-oxy radical (TEMPO) is used as an oxidation catalyst, a primary hydroxyl group in a cellulose amorphous region is oxidized and carboxyl is introduced to thus chemically fibrillate the raw material cellulose fiber by use of mutual electrostatic repulsion among fibrils.

A preferable example of a co-oxidant is at least one selected from the group consisting of hypohalogenous acids or salts thereof, halogenous acids or salts thereof, perchloric acids or salts thereof, hydrogen peroxide and organic acid peroxide. As salts among the co-oxidants described above, at least one salt selected from the group consisting of alkali metals, magnesium and alkaline earth metals is preferable, and in particular, hypohalogenous acid salts of alkali metals, for example, sodium hypochlorite and sodium hypobromite are more preferable. When a hypohalogenous acid salt such as sodium hypochlorite is used, it is particularly preferable to promote a reaction in the presence of an alkali metal bromide, for example, sodium bromide, for the purpose of accelerating a reaction speed. When a co-oxidant is reacted with an oxidation catalyst to promote an oxidation reaction, in a polymer chain constituted with a pyranose unit, the primary hydroxyl group in the C6 position is only selectively oxidized even to be a carboxyl group through aldehyde in a molecular chain level, thus being preferable.

The oxidation reaction described above is preferably performed by dispersing a raw material cellulose fiber into a solvent. The solvent is required not to show significant reactivity with the raw material cellulose fiber, an oxidation catalyst and a co-oxidant in an oxidation reaction and handling conditions, and to preferably disperse fibrillated fibers and fibers after introduction of a carboxyl group. In particular, water is the most preferable from the viewpoint of low cost and handling. During the oxidation reaction, a concentration of the raw material cellulose fiber based on water being a solvent is preferably set to 0.1% by mass or more and 3% by mass or less.

As for a specific method and conditions for obtaining modified fibrillated fibers introduced with a carboxyl group by reacting the above described oxidation catalyst and, if necessary, a co-oxidant, those disclosed in Japanese Patent Application Laid-Open No. 2008-1728 can be favorably used.

Such chemical fibrillation based on electrostatic repulsion of a carboxyl group in the C6 position can provide a uniform and smaller fiber diameter as compared to mechanical fibrillation.

A cellulose fiber is an insoluble natural fiber having a polymerization degree generally within the range from 1,000 to 3,000 (several tens of thousands to several millions by weight average molecular weight). In the present invention, a fiber diameter of a crystalline fibril after fibrillation is important and an insoluble natural fiber having a polymerization degree (weight average molecular weight) within the range may be used.

For the “weight average molecular weight” in the present invention, a value measured using high performance liquid chromatography in the measurement conditions described below is adopted.

Solvent: methylene chloride
Columns: Shodex K806, K805, K803G (three columns manufactured by Showa Denko K. K. are connected to be used)
Column temperature: 25° C.
Sample concentration: 0.1% by weight
Detector: RI Model 504 (manufactured by GL Sciences Inc.)
Dump: L6000 (manufactured by Hitachi, Ltd.)
Flow rate: 1.0 ml/min
Calibration curve: Standard polystyrene STK standard polystyrene (manufactured by TOSOH CORPORATION)), calibration curves from 13 samples having weight average molecular weights from 1,000,000 to 500 are used.

(b) Surface-Modified Cellulose Nanofiber

The surface-modified cellulose nanofiber in the present invention is obtained by substituting at least a part of hydrogen atoms in the 2nd position, 3rd position and/or 6th position of hydroxyl groups (—OH) in a glucose unit or cellulose which constitutes the cellulose nanofiber with acyl groups each having 1 to 8 carbon atoms by chemical modification.

Cellulose is a linearly polymerized material obtained from a large number of β-glucose molecules with glycoside bonds and has hydroxyl groups in the C2 position, the C3 position and the C6 position. Accordingly, a cellulose nanofiber that is not chemically modified generally contains the following chemical formula (A) as a repeating unit.

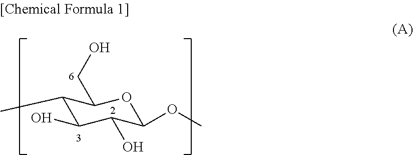

In the surface-modified cellulose nanofiber according to the present embodiment, at least one hydroxyl group among the C2 position, the C3 position and the C6 position in the cellulose nanofiber described above is esterified. That is, the cellulose nanofiber according to the present embodiment has an acyl group having 1 to 8 carbon atoms in at least one of the C2 position, the C3 position and the C6 position.

More specifically, the surface-modified cellulose nanofiber of the present invention is assumed that hydrogen atoms in hydroxyl groups in the surface of the cellulose nanofiber are substituted with acyl groups and considered to be a fiber having a core shell shaped cross-section in which a crystalline nanofiber component is the core and an amorphous modified cellulose ester component (acyl group component) is the shell.

An average fiber diameter and an average fiber length of the surface-modified cellulose nanofiber are similar to the prescription of the average fiber diameter and the average fiber length for the cellulose nanofiber described above.

An acyl group having 1 to 8 carbon atoms is not particularly limited, and examples thereof include a formyl group, an acetyl group, a propionyl group (propanoyl group), an isopropionyl group, a butanoyl group (butyryl group), an isobutanoyl group (isobutyryl group), a valeryl group, an isovaleryl group, a 2-methylvaleryl group, a 3-methylvaleryl group, a 4-methylvaleryl group, a t-butylacetyl group, a pivaloyl group, a caproyl group, a 2-ethylhexanoyl group, a 2-methylhexanoyl group, a heptanoyl group, an octanoyl group and a benzoyl group. Among these groups, an acyl group having 2 to 4 carbon atoms is preferable, an acetyl group, a propionyl group and a butanoyl group are more preferable, and a propionyl group is particularly preferable. That is, in a particularly preferable embodiment, the acyl group includes a propionyl group. Since a propionate component is preferable in flowability, and the like, as compared to the other acyl group components, transparency and smoothness can be enhanced. In addition, hydrogen atoms in hydroxyl groups in the cellulose nanofiber may be substituted with single kind of acyl groups or plural kinds of acyl groups.

By substituting at least one part of hydrogen atoms in hydroxyl groups in the cellulose nanofiber with acyl groups, the surface layer of the fiber can be made amorphous (made into a resin), and flexibility can be imparted to the crystalline cellulose nanofiber while intertwist of cellulose nanofiber components are maintained. Accordingly, even in the case of not mixing with a matrix resin, molding processability is excellent and uniform film formation can be achieved. Furthermore, by making the surface layer of the fiber amorphous (making into a resin), transparency and surface smoothness can be improved.

A substitution degree of acyl groups in the cellulose nanofiber is preferably 0.5 to 2.5. The substitution degree of 0.5 or more is preferable since the resin component (the acyl component) in the fiber surface is large, film formation property and transparency are improved and, further, defects can be reduced. The substitution degree of 2.5 or less is preferable since a crystalline nanofiber part (core part) is large, and intertwist among nanofibers increases and heat ray expansion is thus excellent. The substitution degree is more preferably 0.5 to 2.0.

As shown in the chemical formula (A) described above, a glucose unit having β-1,4 bonds, which constitute a cellulose, has from hydroxyl groups (—OH) in the C2 position, the C3 position and the C6 position. The “substitution degree of acyl groups in the cellulose nanofiber” indicates an average number of acyl groups in one glucose unit and shows whether any of hydrogen atoms in the C2 position, the C3 position and the C6 position in a hydroxyl group in one glucose unit is substituted with an acyl group. That is, when all hydrogen atoms in the C2 position, the C3 position and the C6 position in a hydroxyl group are substituted with acyl groups, the substitution degree (the maximum substitution degree) is 3.0. Acyl groups may be averagely substituted with hydrogen atoms in the C2 position, the C3 position and the C6 position in a glucose unit, or may be substituted by distribution. The substitution degree is found according to the method prescribed in ASTM-D817-96.

The degree of crystallinity of the surface-modified cellulose nanofiber is preferably 30 to 90%. Then the degree of crystallinity is 30% or more, deterioration in heat ray expansion property of a nanofiber and accompanied deterioration in heat ray expansion property of a film can be suppressed. On the other hand, when the degree of crystallinity is 90% or less, decrease of film formation property, transparency and surface smoothness can be suppressed. The degree of crystallinity is more preferably 50 to 90%, and further more preferably 40 to 80%.

A degree of crystallinity can be calculated by the method described below.

[Calculation Method of Degree of Crystallinity]

A degree of crystallinity CrI was calculated based on the mathematical formula (1) described below by measuring an X-ray diffraction intensity. Note that I₈ represents a diffraction peak intensity at 2θ=8° and I₁₈ represents a diffraction peak intensity at 2θ=18°.

A diffraction peak intensity is different depending on a resin and can be calculated by subtracting the base line intensity from a peak intensity of each spectral.

[Mathematical Formula 1]

CrI=(I₈−I₁₈)/I₈ Mathematical Formula (1)

(Mixing Cellulose Nanofibers with Different Substitution Degrees and Degrees of Crystallinity)

In the present invention, the surface-modified cellulose nanofiber is preferably a mixture of surface-modified cellulose nanofibers having different substitution degrees of acyl groups and degrees of crystallinity. Mixing nanofibers with different substitution degrees and degrees of crystallinity is effective because stability of performance (transparency and productivity) is improved. Specifically, it is preferred that a surface-modified cellulose nanofiber having a low substitution degree of acyl groups and a high degree of crystallinity and a surface-modified cellulose nanofiber having a high substitution degree of acyl groups and a low degree of crystallinity are mixed to be used. The former is a fiber that is advantageous to reduction in thermal expansion, and the latter is a fiber that is advantageous to transparency and productivity. Mixing these fibers is preferable since stability of performance that is an effect of the present invention is more stabilized.

The surface-modified cellulose nanofiber in the present invention can be substituted and modified with a functional group other than an acyl group within the range which does not damage the effect of the present invention. As a modification method, a known method such as chemically modifying a hydroxyl group in a cellulose nanofiber with a modifier such as acids, alcohols, halogenation reagents, acid anhydrides, isocyanates, and silane coupling agents can be employed.

(c) Matrix Resin

It is one characteristic in the present invention that the sheet substrate 1 contains a matrix resin in an amount of 10% by mass or less with respect to the total amount of cellulose nanofiber and the matrix resin. The content of the matrix resin is preferably 5% by mass or less, more preferably 3% by mass or less, and further more preferably 1% by mass or less, and particularly preferably 0% by mass, in other words, the matrix resin is not contained.

The “matrix resin” is referred to as an inorganic polymer or an organic polymer which has a molecular weight of 10,000 or more. Specifically, examples of the inorganic polymer include glass and ceramics such as a silicate material and a titanate material, and examples of the organic polymer include cellulose-based resins such as a cellulose resin and a cellulose ester resin, vinyl-based resins, polycondensation resins, polyaddition resins, addition condensation resins, and ring-opening polymerization resins.

(d) Other Additives

The sheet substrate is preferably added with the following additives such as (1) a carbon radical scavenger, (2) a primary antioxidant, (3) a secondary antioxidant, (4) an acid capturing agent, (5) an ultraviolet absorber, (6) a plasticizer, (7) a mat binder, (8) an optical anisotropy controlling agent, and (9) a crosslinking agent for the purpose of further improving performance of a gas barrier film, and a substrate for an electronic element, which is produced using the gas barrier film. In particular, when a melt extrusion method described later is used, at least one or more of (2) a primary antioxidant, (3) a secondary antioxidant, and (6) a plasticizer are preferably added, and all of (2), (3) and (6) are particularly preferably added. On the other hand, when a melt cast method is used, at least one or more of (6) a plasticizer and (9) a crosslinking agent are preferably added, and all the two of (6) and (9) are particularly preferably added.

(1) Carbon Radical Scavenger

The sheet substrate preferably contains at least one or more carbon radical scavengers. A “carbon radical scavenger” means a compound that has a group capable of rapidly allowing a carbon radical to perform an addition reaction (for example, unsaturated groups of double bond, triple bond, etc.) and also gives a stable generated product that does not cause a subsequent reaction such as polymerization after addition of the carbon radical.

As the carbon radical scavenger described above, a compound having a group (an unsaturated group such as a (meth)acryloyl group and an aryl group) which rapidly reacts with a carbon radical in a molecule and having radical polymerization inhibition ability such as phenol-based and lactone-based compounds is useful, and a compound, expressed by the general formula (1) or (2) described below is particularly preferable.

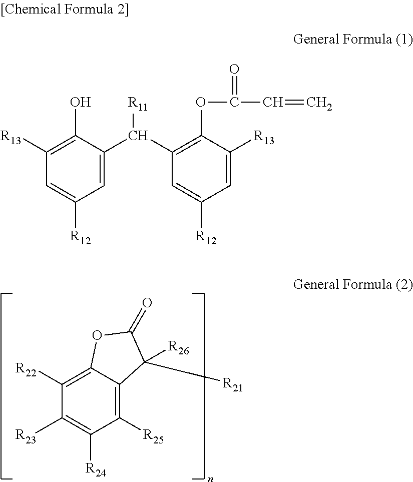

In the general formula (1), R₁₁ represents a hydrogen atom or an alkyl group having 1 to 10 carbon atom, preferably a hydrogen atom or an alkyl group having 1 to 4 carbon atoms, and particularly preferably a hydrogen atom or a methyl group.

R₁₂ and R₁₃ each independently represents an alkyl group having 1 to 8 carbon atoms, and may have a linear chained structure, a branched structure or a ring structure.

R₁₂ and R₁₃ each has a structure expressed by “*—C(CH₃)₂—R′” which preferably contains a quaternary carbon atom (* represents a connection site to an aromatic ring, and R′ represents an alkyl group having 1 to 5 carbon atoms).

R₁₂ more preferably represents a tert-butyl group, a tert-amyl group or a tert-octyl group. R₁₃ more preferably represents a tert-butyl group and a tert-amyl group. As a compound expressed by the general formula (1) described above, examples thereof include “Sumilizer GM, Sumilizer GS” (both are product names, manufactured by Sumitomo Chemical Company, Limited.) as commercially available products.

Specific examples (I-1 to I-18) of the compound expressed by the general formula (1) are listed below, but the present invention is not limited thereto.

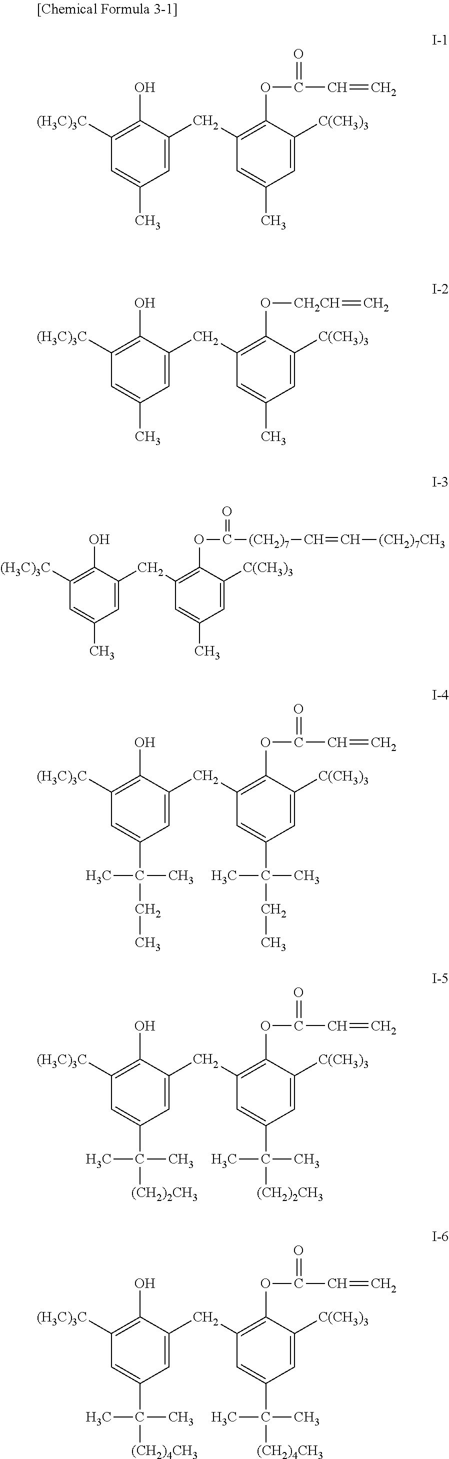

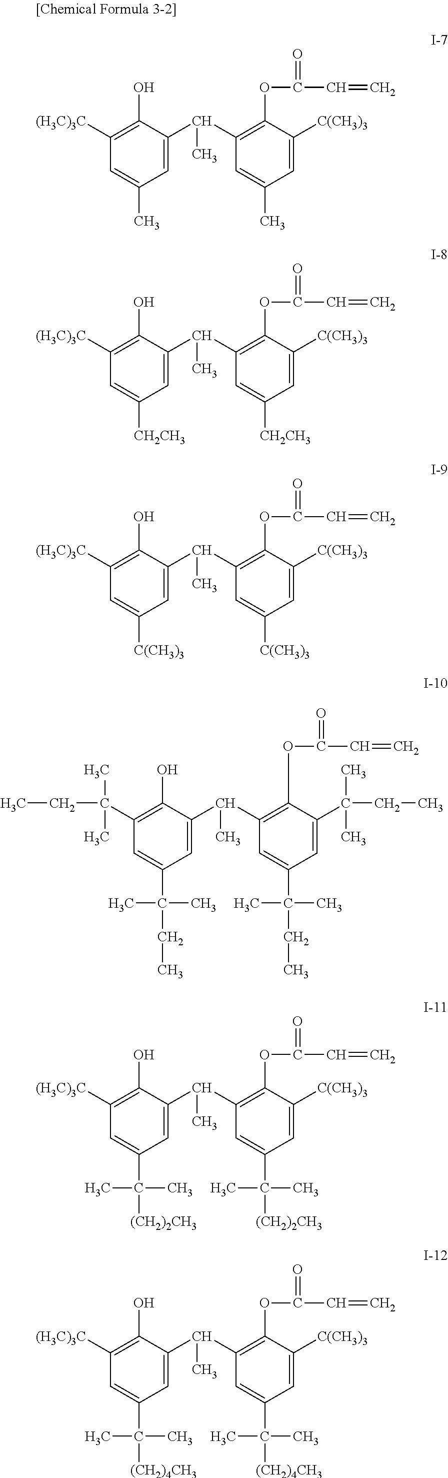

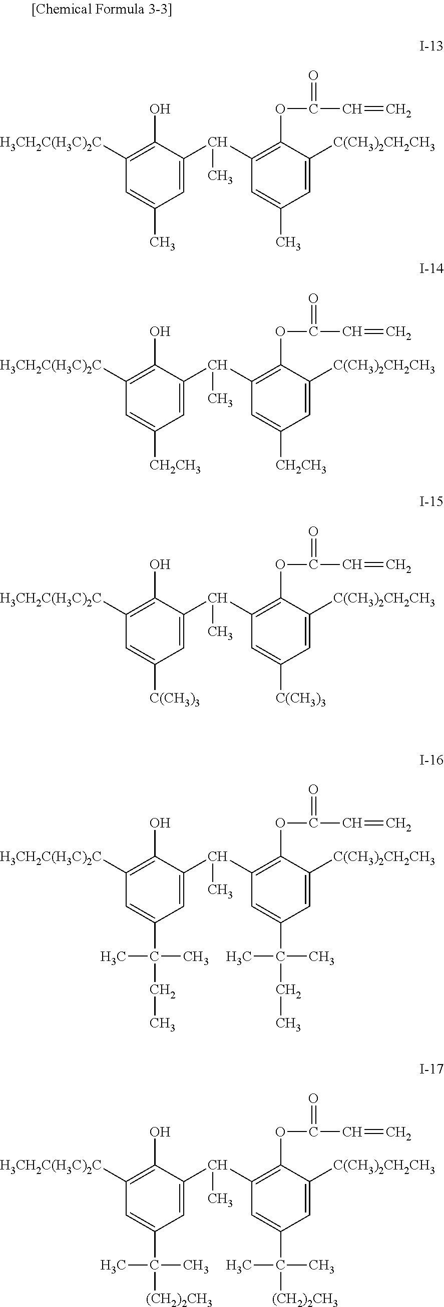

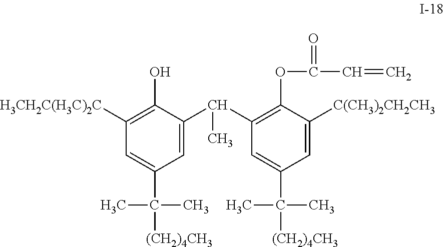

In the general formula (2) described above, R₂₂ to R₂₅ each independently represents a hydrogen atom or a substituent and the substituents expressed by R₂₂ to R₂₅ are not particularly limited, and examples thereof include alkyl groups (such as methyl group, ethyl group, propyl group, isopropyl group, t-butyl group, pentyl group, hexyl group, octyl group, dodecyl group, and trifluoromethyl group), cycloalkyl groups (such as cyclopentyl group and cyclohexyl group), aryl groups group (such as phenyl group sued naphthyl group), acylamino groups (such as acetylamino group and benzoylamino group), alkylthio groups (such as methylthio group and ethylthio group), arylthio groups (such as phenylthio group and naphthylthio group), alkenyl groups (such as vinyl group, 2-propenyl group, 3-butenyl group, 1-methyl-3-propenyl group, 3-pentenyl group, 1-methyl-3-butenyl group, 4-hexenyl group and cyclohexenyl group), halogen atoms (such as fluorine atom, chlorine atom, bromine atom and iodine atom), alkynyl groups (such as propargyl group), heterocyclic groups (such as pyridyl group, thiazolyl group, oxazolyl group, and imidasolyl group), alkylsulfonyl groups (such as methylsulfonyl group and ethylsulfonyl group), arylsulfonyl groups (such as phenylsulfonyl group and naphthylsulfonyl group), alkylsulfinyl groups (such as methylsulfinyl group), arylsulfinyl groups (such as phenylsulfinyl group), phosphono groups, acyl groups (such as acetyl group, pivaloyl group and benzoyl group), carbamoyl groups (such as aminocarbonyl group, methylaminocarbonyl group, dimethylaminocarbonyl group, buthylaminocarbonyl group, cyclohexylaminocarbonyl group, phenylaminocarbonyl group and 2-pyridylaminocarbonyl group), sulfamoyl groups (such as aminosulfonyl group, methylaminosulfonyl group, dimethylaminosulfonyl group, butylaminosulfonyl group, hexylaminosulfonyl group, cyclohexylaminosulfonyl group, octylaminosulfonyl group, dodecylaminosulfonyl group, phenylaminosulfonyl group, naphthylaminosulfonyl group and 2-pyridylaminosulfonyl group), sulfoneamide group (such as methane sulfoneamide group and benzene sulfoneamide group), cyano groups, alkoxy groups (such as methoxy group, ethoxy group and propoxy group, aryloxy groups (such as phenoxy group and naphthyloxy group), heterocyclic oxy group, siloxy group, acyloxy groups (such as acetyloxy group and benzoyloxy group), sulfonic acid groups, sulfonic acid salts, aminocarbonyloxy group, amino groups (such as amino group, ethylamino group, dimethylamino group, butylamino group, cyclopentylamino group, 2-ethylhexylamino group, and dodecylamino group), anilino groups (such as phenylamino group, chlorophenylamino group, toluidino group, anisidino group, naphthylamino group and 2-pyridyl amino group), imide groups, ureide groups (such as methylureide group, ethylureide group, pentylureide group, cyclohexylureide group, octyleide group, dodecyleide group, phenyleide group, naphthyleide group and 2-pyridyl aminoleide group), alkoxycarbonylamino groups (such as methoxycarbonylamino group and phenoxycarbonylamino group), alkoxycarbonyl groups (such as methoxycarbonyl group, ethoxycarbonyl group and phenoxycarbonyl), aryloxycarbonyl groups (such as phenoxycarbonyl group), heterocycliothio groups, thioureide groups, carboxyl groups, carboxylic acid salts, hydroxyl groups, mercapto groups, nitro groups. these substituents may be further replaced with similar substituents.

In the general formula (2) described above, R₂₆ represents a hydrogen atom or a substituent, and examples of a substituent expressed by R₂₆ include groups similar to the substituents expressed by R₂₂ to R₂₅ described above.

In the general formula (2), n represents 1 or 2.

In the general formula (2), when n is 1, R₂₁ represents a substituent, and when n is 2, R₂₁ represents a divalent connecting group. When R₂₁ represents a substituent, examples of the substituent include groups similar to the substituents expressed by R₂₂ to R₂₅ described above.

When R₂₁ represents a divalent connecting group, example of the divalent connecting group include an alkylene group which may has a substituent, an arylene group which may has a substituent, an oxygen atom, a nitrogen atom, a sulfur atom, or combinations of these connecting groups.

In the general formula (2), n is preferably 1.

Next, specific examples of a compound expressed by the general formula (2) in the present invention are shown, but the present invention is not limited to the specific examples below.

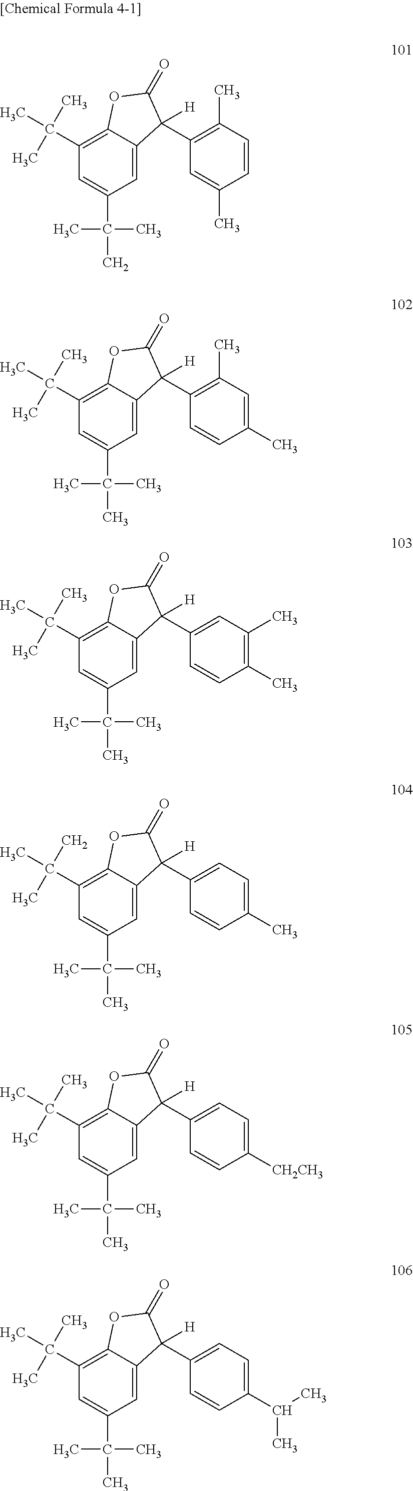

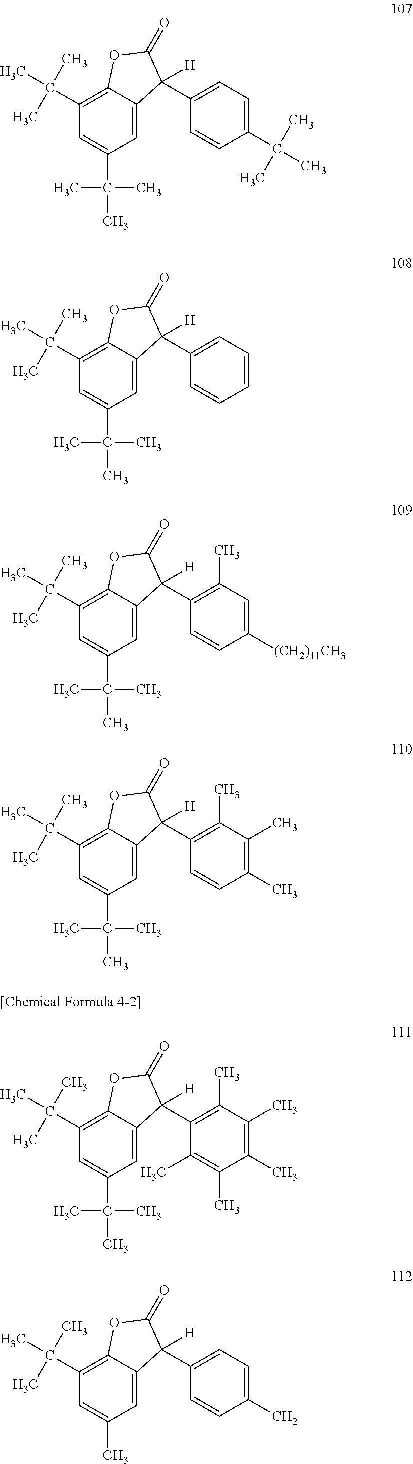

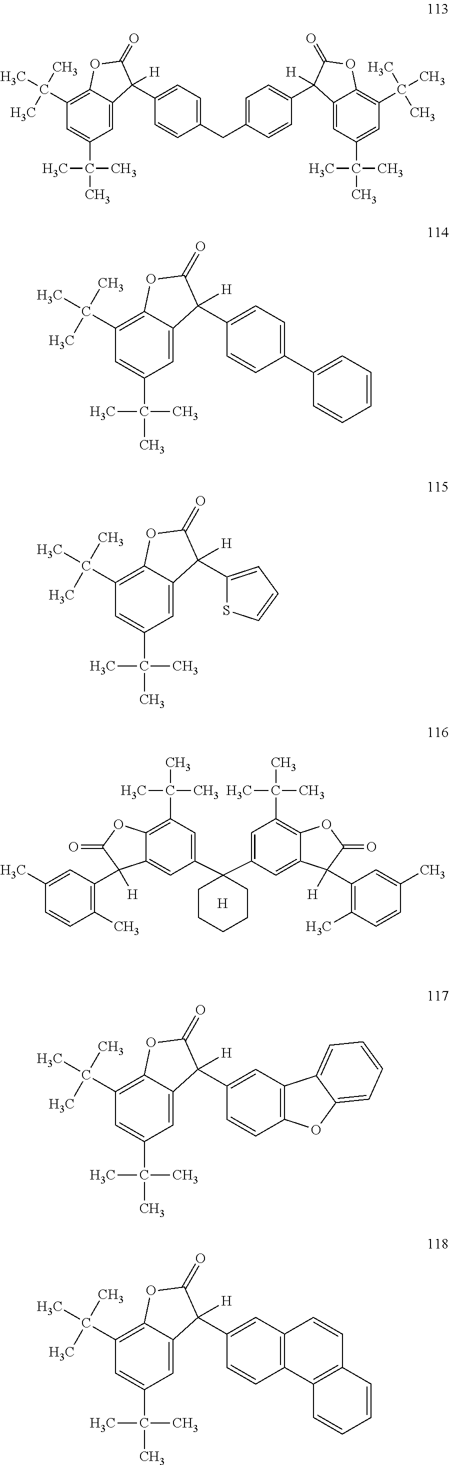

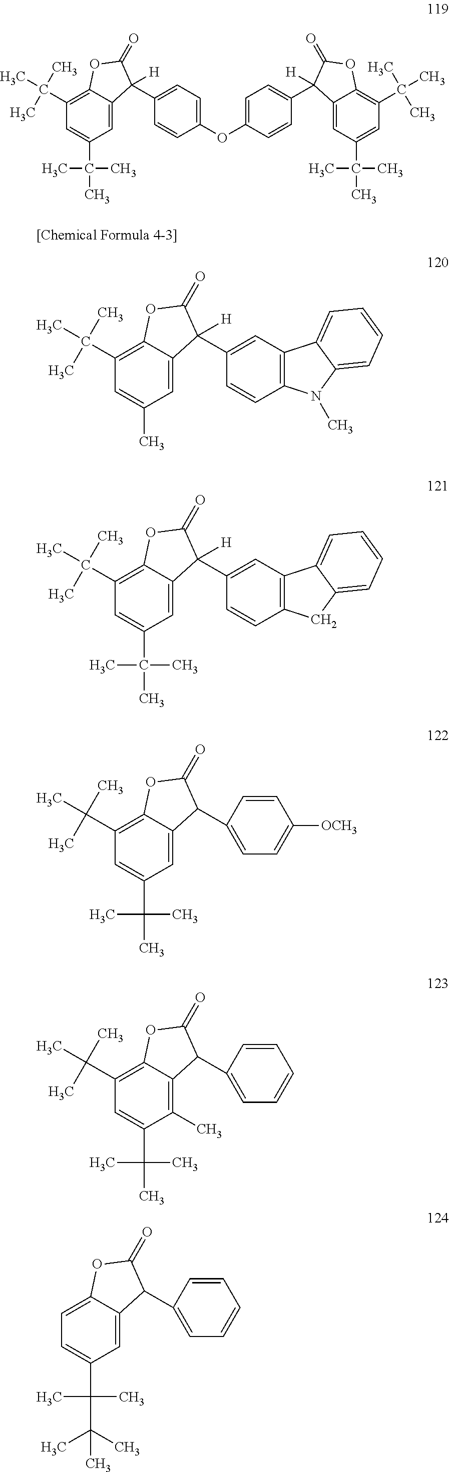

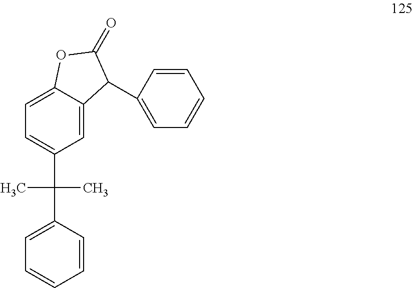

A carbon radical scavenger described above can be used solely or in combination of two or more thereof, and the blending amount is suitably selected within the range that does not damage the object of the present invention, and is generally preferably added in an amount of 0.001 to 10.0 parts by mass, more preferably 0.01 to 5.0 parts by mass, and particularly preferably 0.1 to 1.0 parts by mass, with respect to the total amount of the surface-modified cellulose group (100 parts by mass).

(2) Primary Antioxidant

A sheet substrate preferably contains at least one or more primary antioxidants having an ability of providing a hydrogen radical to a peroxy radical.

The “primary antioxidant having an ability of providing a hydrogen radical to a peroxy radical” is a compound having at least one or more hydrogen atoms that are rapidly drawn out by a peroxy radical in a molecule, and is preferably an aromatic compound substituted with a hydroxyl group or a primary or secondary amino group or a heterocyclic compound having a steric hindrance group, and more preferably a phenol compound having an alkyl group in the ortho position or a hindered amine compound.

(Phenol Compound)

A phenol compound preferably used in the present invention includes, for example, 2,6-dialkylphenol derivatives such as those described in the sections 12 to 14 in U.S. Pat. No. 4,839,405. Such compounds include a compound expressed by the general formula (3) described below.

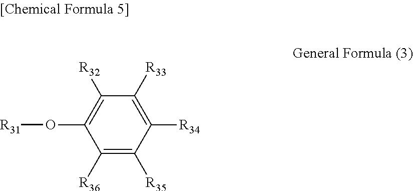

In the formula, R₃₁ to R₃₆ each represents a hydrogen atom or a substituent. Examples of the substituent include halogen atoms (such as fluorine atom and chlorine atom), alkyl groups (such as methyl group, ethyl group, isopropyl group, hydroxyethyl group, methoxymethyl group, trifluoromethyl group and t-butyl group), cycloalkyl groups (such as cyclopentyl group and cyclohexyl group), aralkyl groups (such as benzyl group and 2-phenethyl group), aryl groups (such as phenyl group, naphthyl group, p-tolyl group and p-chlorophenyl group), alkoxy groups (such as methoxy group, ethoxy group, isopropoxy group and butoxy group), aryloxy groups (such as phenoxy group), cyano groups, acylamino groups (such as acetylamino group and propionylamino group), alkylthio groups (such as methylthio group, ethylthio group and butylthio group), arylthio groups (such as phenylthio group), sulfonylamino groups (such as methanesulfonylamino group and benzene sulfonylamino group), ureide groups (such as 3-methylureide group, 3,3-dimethyleide group and 1,3-dimethyleide group), sulfamoylamino groups (such as dimethylsulfamoylamino group), carbamoyl groups (such as methylcarbamoyl group, ethylcarbamoyl group and dimethylcarbamoyl group), sulfamoyl groups (such as ethylsulfamoyl group and dimethylsulfamoyl group), alkoxycarbonyl groups (such as methoxycarbonyl group and ethoxycarbonyl group), aryloxycarbonyl groups (such as phenoxycarbonyl group), sulfonyl groups (such as methanesulfonyl group, butanesulfonyl group and phenylsulfonyl group), acyl groups (such as acetyl group, propanoyl group and butyroyl group), amino groups (methylamino group, ethylamino group and dimethylaminogroup), cyano groups, hydroxy groups, nitro groups, nitroso groups, amineoxide groups (such as pyridine-oxide group), imide groups (such as phthalimide group), disulfide groups (such as benzenedisulfide group and benzothiazolyl-2-disulfide group), carboxyl groups, sulfo groups, and heterocyclic groups (such as pyrrole group, pyrrolidyl group, pyrazolyl group, imidazolyl group, pyridyl group, benzimidazolyl group, benzthiazolyl group and benzoxazolyl group). These substituents may be further replaced.

The phenol compound is preferably a compound in which R₃₁ is a hydrogen atom, and R₃₂ and R₃₆ are t-butyl groups. Specific examples of the phenol compound include n-octadecyl 3-(3,5-di-t-butyl-4-hydroxyphenyl)-propionate, n-octadecyl 3-(3,5-di-t-butyl-4-hydroxyphenyl)-acetate, n-octadecyl 3,5-di-t-butyl-4-hydroxybenzoate, n-hexyl 3,5-di-t-butyl-4-hydroxyphenyl benzoate, n-dodecyl 3,5-di-t-butyl-4-hydroxyphenyl abenzoate, neo-dodecyl 3-(3,5-di-t-butyl-4-hydroxyphenyl) propionate, dodecyl β(3,5-di-t-butyl-4-hydroxy phenyl) propionate, ethyl α-(4-hydroxy-3,5-di-t-butylphenyl) isobutylate, octadecyl α-(4-hydroxy-3,5-di-t-butylphenyl) isobutylate, octadecyl α-(4-hydroxy-3,5-di-t-butyl-4-hydroxyphenyl) propionate, 2-(n-octylthio)ethyl 3,5-di-t-butyl-4-hydroxy-benzoate, 2-(n-octylthio)ethyl 3,5-di-t-butyl-4-hydroxy-phenyl acetate, 2-(n-octadecylthio)ethyl 3,5-di-t-butyl-4-hydroxyphenyl acetate, 2-(n-octadecylthio)ethyl 3,5-di-t-butyl-4-hydroxy-benzoate, 2-(2-hydroxyethylthio)ethyl 3,5-di-t-butyl-4-hydroxybenzoate, diethyl glycol bis-(3,5-di-t-butyl-4-hydroxy-phenyl) propionate, 2-(n-octadecylthio)ethyl 3-(3,5-di-t-butyl-4-hydroxyphenyl) propionate, stearylamide-N,N-bis-[ethylene 3-(3,5-di-t-butyl-4-hydroxyphenyl) propionate], n-butylimino-N,N-bis-[ethylene 3-(3,5-di-t-butyl-4-hydroxyphenyl) propionate], 2-(2-stearoyloxyethylthio) ethyl 3,5-di-t-butyl-4-hydroxybenzoate, 2-(2-stearoyloxyethylthio) ethyl 7-(3-methyl-5-t-butyl-4-hydroxyphenyl) heptanoate, 1,2-propyleneglycol bis-[3-(3,5-di-t-butyl-4-hydroxyphenyl) propionate], ethyleneglycol bis-[3-(3,5-di-t-butyl-4-hydroxyphenyl) propionate], neopentylglycol bis-[3-(3,5-di-t-butyl-4-hydroxyphenyl) propionate], ethyleneglycol bis-(3,5-di-t-butyl-4-hydroxyphenyl acetate, glycerin-1-n-octadecanoate-2,3-bis-(3,5-di-t-butyl-4-hydroxyphenyl acetate), pentaerythritoltetrakis-[3-(3′,5′-di-t-butyl-4′-hydroxyphenyl) propionate], 3,9-bis-{2-[3-(3-tert-butyl-4-hydroxy-5-methylphenyl)propionyloxy]-1,1-dimethylethyl}-2,4,8,10-tetraoxaspiro[5,5]undecane, 1,1,1-trimethylolethane-tris-[3-(3,5-di-t-butyl-4-hydroxy phenyl) propionate], sorbitol hexa-[3-(3,5-di-t-butyl-4-hydroxyphenyl) propionate], 2-hydroxyethyl 7-(3-methyl-5-t-butyl4-hydroxyphenyl) propionate, 2-stearoyloxyethyl 7-(3-methyl-5-t-butyl-4-hydroxyphenyl) heptanoate, 1,6-n-hexanediol-bis[(3′,5′-di-t-butyl-4-hydroxyphenyl) propionate], and pentaerythritoltetrakis (3,5-di-t-butyl-4-hydroxyhydrocinnamate). The above described types or phenol compounds are commercially available as, for example, trade names such as “Irganox 1076” and “Irganox 1010” manufactured by BASF Japan Ltd.

The phenol compounds described above can be used solely or in combination of two or more compounds, and the blending amount thereof can be suitably selected within the range which does not damage the object of the present invention, and is generally preferably added in an amount of 0.001 to 10.0 parts by mass, more preferably 0.05 to 5.0 parts by mass, and particularly preferably 0.1 to 2.0 parts by mass with respect to the total amount of the surface-modified cellulose nanofiber (100 parts by mass).

(Hindered Amine Compounds)

As the hindered amine compound, a compound expressed by the general formula (4) described below is preferable.

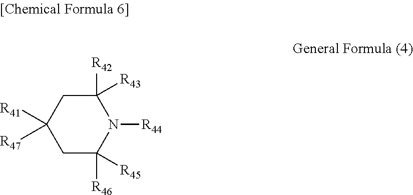

In the formula, R₄₁ to R₄₇ represents substituents. The substituents are synonymous with the substituents expressed by R₃₁ to R₃₆ in the general formula (3) described above. R₄₄ is preferably a hydrogen atom or a methyl group, R₄₇ is preferably a hydrogen atom, and R₄₂, R₄₃, R₄₅ and R₄₆ are preferably methyl groups. Specific examples of the hindered amine compounds include bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(N-octoxy-2,2,6,6-tetramethyl-4-piperidyl) sebacate, bis(N-benzyloxy-2,2,6,6-tetramethyl-4-piperidyl) sebacate, bis(N-cyclohexyloxy-2,2,6,6-tetramethyl-4-piperidyl) sebacate, bis(1,2,2,6,6-pentamethyl-4-piperidyl) 2-(3,5-di-t-butyl-4-hydroxybenzyl)-2-butyl malonate, bis(1-acroyl-2,2,6,6-tetramethyl-4-piperidyl) 2,2-bis(3,5-di-t-butyl-4-hydroxybenzyl)-2-butyl malonate, bis(1,2,2,6,6-pentamethyl-4-piperidyl) decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl) amino-N-(2,2,6,6-tetramethyl-4-piperidyl)propioneamide, tetrakis(2,2,6,6-tetramethyl-4-piperidyl) 1,2,3,4-butanetetracarboxylate, and tetrakis(1,2,2,6,6-pentamethyl-4-piperidyl) 1,2,3,4-butanetetracarboxylate.

The hindered amine compound may also be a polymer type compound, and specific examples thereof include high molecular weight HALS obtained by plurally bonding piperidine rings through a triazine skeleton such as N,N′,N″,N″′-tetrakis-[4,6-bis-[butyl(N-methyl-2,2,6,6-tetramethylpiperidine-4-yl)amino]-triazine-2-yl]-4,7-diazadecane-1,10-diamine, a polycondensate of dibutylamine, 1,3,5-triazine-N,N′-bis(2,2,6,6-tetramethyl-4-piperidyl)-1,6-hexamethylenediamine and N-(2,2,6,6-tetramethyl-4-piperidyl)butylamine, a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], a polycondensate of 1,6-hexanediamine-N,N′-bis(2,2,6,6-tetramethyl-4-piperidyl) and morpholine-2,4,6-trichloro-1,3,5-triazine, and poly[(6-morpholino-s-triazine-2,4-diyl)[(2,2,6,6-tetramethyl-4-piperidyl)imino]-hexamethylene[(2,2,6,6-tetramethyl-4-piperidyl)imino]]; and a compound obtained by bonding piperidine rings through an ester bond such as a polymerized product of succinic acid dimethyl and 4-hydroxy-2,2,6,6-tetramethyl-1-piperidine ethanol, and a mixed esterified product of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane, but the hindered amine compound is not limited thereto. Note that a polymer type hindered amine compound has a number average molecular weight (Mn) of 500 to 10,000.

Among these compounds, preferable are a polycondensate of dibutylamine, 1,3,5-triazine and N,N′-bis(2,2,3,6-tetramethyl-4-piperidyl)butylamine; poly[{(1,1,3,3-tetramethylbutyl)amino-1,3,5-triazine-2,4-diyl]{(2,2,6,6-tetramethyl-4-piperidyl)imino}hexamethylene[(2,2,6,6-tetramethyl-4-piperidyl)imino}]; a polymerized product of succinic acid dimethyl and 4-hydroxy-2,2,6,6-tetramethyl-1-piperidine ethanol, and the like, each having a number average molecular weight (Mn) or 2,000 to 5,000.

The above described type of a hindered amine is commercially available as, for example, trade names such as “Tinuvin 144” and “Tinuvin 770” manufactured by BASF Japan Ltd., and “Adekastab LA-52” manufactured by ADEKA Corporation.

The hindered amine compounds described above can be used solely or in combination of two or more compounds, and the blending amount thereof can be suitably selected within the range which does not damage the object of the present invention, and is generally preferably added in an amount of 0.001 to 10.0 parts by mass, more preferably 0.05 to 5.0 parts by mass, and particularly preferably 0.1 to 2.0 parts by mass with respect to the total amount of the surface-modified cellulose nanofiber (100 parts by mass).

(3) Secondary Antioxidant

The sheet substrate preferably contains at least one or more secondary antioxidants having a reduction action to peroxide.

The “secondary antioxidant having a reduction action to peroxide” means a reducing agent which rapidly reduces peroxide to convert into a hydroxyl group.

The secondary antioxidant having a reduction action to peroxide is preferably a phosphor-based compound or a sulfur-based compound.

(Phosphor-Based Compound)

The phosphor-based compound is preferably a phosphor-based compound selected from the group consisting of phosphite, phosphonite, phosphinite and tertiary phosphane, and specifically a compound having a partial structure expressed by the following general formulas (5-1), (5-2), (5-3), (5-4) and (C-5) in its molecule.

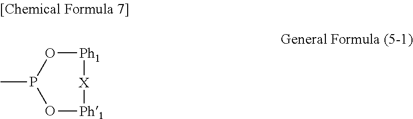

In the formula, Ph₁ and Ph₁′ represent substituents. The substituents are synonymous with the substituents expressed by R₃₁ to R₃₆ in the general formula (3) described above. More preferably, Ph₁ and Ph₁′ each represent a phenylene group, and a hydrogen atom in the phenylene group may be substituted with a phenyl group, an alkyl group having 1 to 8 carbon atoms, a cycloalkyl group leaving 5 to 8 carbon atoms, an alkylcycloalkyl group having 6 to 12 carbon atoms, or an aralkyl group having 7 to 12 carbon atoms. Ph₁ and Ph₁′ may be the same or different each other. X represents a single bond, a sulfur atom, or a —CHR+ group. R represents a hydrogen atom, an alkyl group having 1 to 8 carbon atoms or a cycloalkyl group having 5 to 8 carbon atoms. Ph₁ and Ph₁′ may also be substituted with substituents which are synonymous with the substituents expressed by R₃₁ to R₃₅ in the general formula (3) described above.

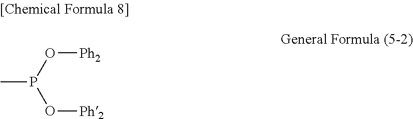

In the formula, Ph₂ and Ph₂′ represent substituents. The substituents are synonymous with the substituents expressed by R₃₁ to R₃₆ in the general formula (3) described above. More preferably, Ph₂ and Ph₂′ each represents a phenyl group or a biphenyl group, and a hydrogen atom in the phenyl group or the biphenyl group may be substituted an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₂ and Ph₂′ may be the same or different each other. Ph₂ and Ph₂′ may also be substituted with substituents which are synonymous with the substituents expressed by R₃₁ to R₃₆ in the general formula (3) described above.

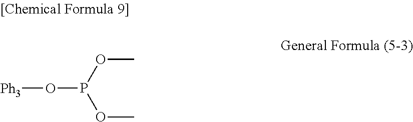

In the formula, Ph₃ represents a substituent. The substituent is synonymous with the substituents expressed by R₃₁ to R₃₆ in the general formula (3) described above. More preferably, Ph₃ represents a phenyl group or a biphenyl group, and a hydrogen atom in the phenyl group or the biphenyl group may be substituted with an alkyl group having 1 to 8 carbon atoms, a cycloalkyl group having 5 to 8 carbon atoms, an aklylcycloalkyl group having 7 to 12 carbon atoms, or an aralkyl group having 7 to 12 carbon atoms. Ph₃ may also be substituted with substituents which are synonymous with the substituents expressed by R₃₁ to R₃₆ in the general formula (3) described above.

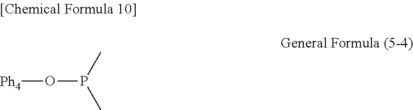

In the formula, Ph₄ represents a substituent. The substituent is synonymous with the substituents expressed by R₃₁ to R₃₆ in the general formula (3) described above. More preferably, Ph₄ represents an alkyl group having 1 to 20 carbon atoms or a phenyl group, and the alkyl group or the phenyl group may also be substituted with substituents which are synonymous wish the substituents expressed by R₃₁ to R₃₆ in the general formula (3) described above.

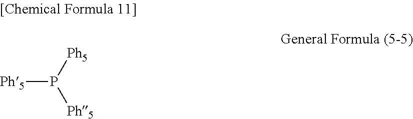

In the formula, Ph₅, Ph₅′ and Ph₅″ beach represents a substituent. The substituent is synonymous with the substituents expressed by R₃₁ to R₅₆ in the general formula (3) described above. More preferably, Ph₅, Ph₅′ and Ph₅″ each represents an alkyl group having 1 to 20 carbon atoms or a phenyl group, and the alkyl group or the phenyl group may also be substituted with substituents which are synonymous with the substituents expressed by R₃₁ to R₃₆ in the general formula (3) described above.

Specific examples of the phosphor-based compound include monophosphite-based compounds such as triphenyl phosphite, diphenylisodecyl phosphite, phenyldisodecyl phosphite, tris(nonylphenyl) phosphite, tris(dinonylphenyl) phosphite, tris(2,4-di-t-butylphenyl) phosphite, 10-(3,5-di-t-butyl-4-hydroxybenzyl)-9,10-dihydro-9-oxz-10-phosphaphenanthrene-10-oxide, 6-[3-(3-t-butyl-4-hydroxy-5-methylphenyl)propoxy]-2,4,8,10-tetra-t-butyldibenz[d,f][1,3,2]dioxaphosphepin, and tridecyl phosphite; diphosphite-based compounds such as 4,4′-butylidene-bis(3-methyl-6-t-butylphenyl-di-tridecyl phosphite), and 4,4′-isopropylidene-bis(phenyl-di-alkyl(C12 to C15) phosphite); phosphonite-based compounds such as triphenyl phosphonite, tetrakis(2,4-di-tert-butyl-5-methylphenyl)[1,1-biphenyl]-4,4′-diylbisphosphonite; phosphinite-based compounds such as triphenyl phosphinite and 2,6-dimethylphenyldipheyl phosphinite; and phosphine-based compounds such as triphenylphosphine and tris(2,6-dimethoxyphenyl)phosphine.

The above described type of a phosphor-based compound is commercially available as, for example, trade names such as “Sumilizer GP” manufactured by Sumitomo Chemical Company, Limited., “Adekastab PEP-24G”, “Adekastab PEP-36” and “Adekastab 3010” manufactured by ADEKA Corporation, “IRGAFOS P-EPQ” manufactured by BASF Japan Ltd., and “GSY-P101” “Tinuvin 144” and “Tinuvin 770” manufactured by Sakai Chemical Industry Co., Ltd.

The phosphor-based compounds described above can be used solely or in combination of two or more thereof, and the blending amount is suitably selected within the range which does not damage the object of the present invention, and is generally preferably added in an amount of 0.001 to 10.0 parts by mass more, preferably 0.05 to 5.0 parts by mass, and particularly preferably 0.05 to 2.0 parts by mass, with respect to the total amount or the surface-modified cellulose nanofiber (100 parts by mass).

(Sulfur-Based Compound)

The sulfur-based compound, is preferably a sulfur-based compound expressed by the general formula (6) described below.

[Chemical Formula 12]

R₆₁—S—R₆₂ General Formula (6)

In the formula, R₆₁ and R₆₂ represent substituents. The substituents are synonymous with the substituents expressed by R₃₁ to R₃₆ in the general formula (3) described above.

Specific examples of the sulfur-based compound include dilauryl-3,3-thiodipropionate, dimyristyl-3,3′-thiodipropionate, distearyl-3,3-thiodipropionate, laurylstearyl 3,3-thiodipropionate, pentaerythritoltetrakis(β-lauryl-thio-propionate), and 3,9-bis(2-dodecylthioethyl)-2,4,8,10-tetraoxaspiro[5,5]undecane.

The above described type of a sulfur-based compound is commercially available as, for example, trade names such as “Sumilizer TPL-R” and “Sumilizer TP-D” manufactured by Sumitomo Chemical Company, Limited.

The sulfur-based compounds described above can be used solely or in combination of two or more thereof, and the blending amount is suitably selected within the range which does not damage the object of present invention, and is generally preferably added in an amount of 0.001 to 10.0 parts by mass, more preferably 0.05 to 5.0 parts by mass, and particularly preferably 0.05 to 2.0 parts by mass, with respect to the total amount of the surface-modified cellulose nanofiber (100 parts by mass).

(3) Acid Capturing Agent

A sheet substrate preferably contains an acid capturing agent as a stabilizer since decomposition is promoted also by an acid under such a high temperature environment as performing melt film formation.

Is the acid capturing agent, a compound that inactivates an acid when reacted with acid can be used without limitation and, in particular, a compound having an epoxy group as described in the U.S. Pat. No. 4,137,201 is preferable. Such an epoxy compound as an acid capturing agent is known in this technical field and includes metal epoxy compounds (for example, compounds conventionally used in a vinyl chloride polymer composition and with a vinyl chloride polymer composition) such as various diglycidyl ethers of polyglycol, in particular, polyglycol derived by condensation of ethylene oxide, and the like, in an amount of about 8 to 40 mol per 1 mol of polyglycol, and diglycidyl ether of glycerol; a epoxidized ether condensation product; diglycidyl ether of bisphenol A (that is, 4,4′-dihydroxydiphenyldimethylmethane); epoxidized unsaturated fatty acid esters (in particular, an alkyl ester having about 4 to 2 carbon atoms in a fatty acid having 2 to 22 carbon atoms (for example, butylepoxy stearate), and the like); and epoxidized vegetable oils and unsaturated natural oils (these are referred to as epoxidized natural glycerides or unsaturated fatty acids in some cases, and these fatty acids each generally contains 12 to 22 carbon atoms), which can by typically represented and exemplified by compositions of various epoxidized long-chain fatty acid triglycerides (for example, epoxidized soybean-oil and epoxidized linseed-oil). In addition, as a commercially available epoxy group-containing resin compound, EPON 815C and other epoxidized ether oligomer condensation products expressed by the general formula (7) described below can also be preferably used.

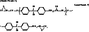

In the formula, n represents an integer from 0 to 12. Other acid capturing agents that can be used include those described in paragraphs 87 to 105 in Japanese Patent Application Laid-Open No. 5-194788.

The acid capturing agents described above can be used solely or in combination of two or more thereof, and the blending amount is suitably selected within the range which does not damage the object of the present invention, and is generally preferably added in an amount of 0.001 to 10.0 parts by mass, more preferably 0.00 to 0.0 parts by mass, and particularly preferably 0.05 to 2.0 parts by mass, with respect to the total amount of the surface-modified cellulose nanofiber (100 parts by mass).

In addition, the acid capturing agent may also be referred to as an acid scavenger, an acid trapping agent, an as acid catcher, and the like, to a resin, and these names can be used without any difference in the present invention.

(5) Ultraviolet Absorber

The sheet substrate can contain an ultraviolet absorber. An ultraviolet absorber has a purpose of improving durability by absorbing an ultraviolet ray with a wavelength of 400 nm or less and, in particular, a transmission at a wavelength of 370 nm is preferably 10% or less, more preferably 5% or less, and further more preferably 2% or less. Furthermore, for a use in a liquid crystal display device, an ultraviolet absorber with less absorption of a visible light with a wavelength of 400 nm or more is preferable from the viewpoint of liquid crystal display property.

The above described ultraviolet absorber is not particularly limited, and examples thereof include oxybenzophenone-based compounds, benzotriazole-based compounds, salicylic acid ester-based compounds, benzophenone-based compounds, cyanoacrylate-based compounds, triazine-based compounds, nickel complex salt-based compounds, and inorganic powder. Benzotriazole-based compounds, benzophenone-based compounds and triazine-based compounds are preferable and benzotriazole-based compounds and benzophenone-based compounds are particularly preferable.

Specific examples of the benzotriazole-based compounds include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5′,6″-tetrahydrophthalimidemethyl)-5′-methylphenyl)benzotriazole, 2,2-methylenebis (4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2-40 -hydroxy-3′-tert-butyl-5′-(2-octyloxycarbonylethyl)-phenyl)-5-chlorobenzotriazole, 2-(2′-hydroxy-3′-(1-methyl-phenylethyl)-5′-(1,1,3,3-tetramethylbutyl)-phenyl)benzotriazole, 2-(2H-benzotriazole-2-yl)-6-(linear chain and side chain dodecyl)-4-methylphenol, and a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, and examples are not limited thereto.

In addition, as commercially available products, examples include TINUVIN 171, TINUVIN 900, TINUVIN 928, TINUVIN 360 (all manufactured by BASF JAPAN LTD.), LA31 (manufactured by ADEKA Corporation), and RUVA-100 (manufactured by Otsuka Chemical Co., Ltd).

Specific examples of the benzophenone-based compounds include 2,4-dihydroxybenzophenone, 2,2′-dihydroxy-4-methoxybenzophenone, 2-hydroxy-4-methoxy-5-sulfobenzophenone, and bis(2-methoxy-4-hydroxy-5-benzoylphenylmethane), and examples are not limited thereto.

In addition, a function as an ultraviolet absorber may also be imparted by introducing a benzotriazole structure or a triazine structure into a part of a molecular structure of other additives such as a plasticizer, an antioxidant and an acid capturing agent.

The above described ultraviolet absorber can be used solely or in combination of two or more thereof.

A blending amount of an ultraviolet absorber is suitably selected within the range which does not damage the object of the present invention, and is generally preferably added in an amount of 0.1 to 5 parts by mass, more preferably 0.2 to 3 parts by mass, and particularly preferably 0.5 to 2 parts by mass, with respect to the total amount of the surface-modified cellulose nanofiber (100 parts by mass).

(6) Plasticizer

The sheet substrate can contain a plasticizer. In the present invention, a plasticizer means a compound which has a molecular weight from 500 to 10,000 and is capable of improving brittleness and imparting flexibility. In the present invention, a plasticizer can improve hydrophilicity of the surface-modified cellulose nanofiber and moisture permeability of a gas barrier film, and has a function as a moisture permeation inhibitor.

In a preferable embodiment of the present invention, a plasticizer is added in order to reduce a melting temperature and a melt viscosity of a film constituting material during melt extrusion. Herein, the melting temperature means a temperature in a state or heating a material and expressing flowability. A polymer material is required to be heated to at least higher temperature than a glass transition temperature to make the polymer material melt-flow. An elastic modulus and a viscosity are decreased due to calorie absorption and flowability is expressed at a temperature at least higher than a glass transition temperature. However, decrease of the molecular weight of the surface-modified cellulose nanofiber is caused by thermal decomposition at the same time with melting at a high temperature, which may give an adverse effect on dynamic characteristics, and the like, of an obtained film, and a resin thus needs to be molten at a low temperature. Therefore, a plasticizer having a lower melting point or glass transition temperature than the glass transition temperature of the surface-modified cellulose nanofiber can be added in order to decrease a melting temperature of a film substituting material.

A plasticizer is not particularly limited and ester-based plasticizers made of polyvalent alcohols and monovalent carboxylic acids and ester-based plasticizers made of polyvalent carboxylic acids and monovalent alcohols are preferable.

(Polyvalent Alcohol Ester-Based Plasticizer)

Examples of a polyvalent alcohol that is a raw material of an ester-based plasticizer include the following materials, but the present invention is not limited thereto. The examples include adonitol, arbitol, ethylene glycol, glycerin, diglycerin, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, ditrimethylolpropane, trimethylolethane, pentaerythritol, dipentaerythritol and xylitol. Particularly, ethylene glycol, glycerin and trimethylolpropane are preferable.

Specific examples of an ethylene glycol ester-based plasticizer that is a part of polyvalent alcohol ester-based plasticizers include ethylene glycol alkyl ester-based plasticizers such as ethylene glycol diacetate and ethylene glycol dibutylate; ethylene glycol cycloalkyl ester-based plasticizers such as ethylene glycol dicyclopropyl carboxylate, ethylene glycol dicyclohekyl carboxylate; and ethylene glycol aryl ester-based plasticizers such as ethylene glycol dibenzoate and ethylene glycol di-4-methyl benzoate. These alkylate group, cycloalkylate group, and arylate group may be the same or different, and may be further substituted. Also, the substituents may be mixtures of the alkylate group, cycloalkylate group and arylate group or covalently bound one another. An ethylene glycol moiety may also be substituted, and a partial structure of an ethylene glycol ester may also be pendant on a polymer partially or regularly, and may also be introduced into a part of a molecular structure of an additive such as an antioxidant, an acid capturing agent, and an ultraviolet absorber.

Specific examples of a glycerin ester-based plasticizer that is a part of polyvalent alcohol ester-based plasticizers include glycerinalkyl esters such as triacetin, tributyrin, glycerin diacetate caprylate, and glycerin olate propionate; glycerincycloalkylesters such as glycerin tricyclopropyl carboxylate and glycerin tricyclohexyl carboxylate; glycerinaryl esters such as glycerin tribenzoate, glycerin 4-methyl benzoate; diglycerin alkylesters such as diglycerin tetraacetylate, diglycerin tetrapropionate, diglycerin acetate tricaprylate, diglycerin tetralaurate; diglycerin cycloalkyl esters such as diglycerin tetracyclobutyl carboxylate, diglycerin tetracyclopentyl carboxylate; diglycerin aryl esters such as diglycerin tetrabenzoate and diglycerin 3-methyl benzoate. These alkylate group, cycloalkylate group, and arylate group may be the same or different, and may be further substituted. Also, the substituents may be mixtures of the alkylate group, cycloalkate group and arylate group or covalently bound one another. Glycerin and diglycerin moieties may also be substituted and partial structures of a glycerin ester and a diglycerin ester may also be pendant on a polymer partially or regularly, and may also be introduced into a part of a molecular structure of an additive such as an antioxidant, an acid capturing agent, and an ultraviolet absorber.

Specific examples of other polyvalent alcohol ester-based plasticizers include polyvalent alcohol ester-based plasticizers described from paragraphs 30 to 33 in Japanese Patent Application Laid-Open No. 2003-12823, and polyvalent alcohol diglycerin plasticizers described from paragraphs 64 to 74 in Japanese Patent Application Laid-Open No. 2006-188663.

These alkylate group, cycloalkylate group and arylate group may be the same or different, and may be further substituted. Also, the substituents may be mixtures of the alkylate group, cycloalkylate group and arylate group or covalently bound one another. A polyvalent alcohol moiety may also be substituted, and a partial structure of a polyvalent alcohol may also be pendant on a polymer partially or regularly, and may also be introduced into a part of a molecular structure of an additive such as an antioxidant, an acid capturing agent, and an ultraviolet absorber.

Among the above described ester-based plasticizers made of a polyvalent alcohol and a monovalent carboxylic acid, an alkyl polyvalent alcohol aryl ester is preferable, and specific examples thereof include ethylene glycol dibenzoate, glycerin tribenzoate, diglycerin tetrabenzoate, pentaerythritol tetrabenzoate, trimethylolpropane tribenzoate, the exemplified compound 16 described in paragraph 31 in Japanese Patent Application Laid-Open No. 2003-12823, and the exemplified compound 48 described in paragraph 71 in Japanese Patent Application Laid-Open No. 2006-188663.

(Polyvalent Carboxylase Acid Ester-Based Plasticizers)

Specific examples of a dicarboxylic acid ester-based plasticizers which is a part of polyvalent carboxylic acid ester-based plasticizers include alkyl dicarboxylic acid alkyl ester-based plasticizers such as didodecyl malonate, dioctyl adipate and dibutyl sebacate; alkyl dicarboxylic acid cycloalkyl ester-based plasticizers such as dicyclopentyl succinate and dicyclohexyl adipate; alkyl dicarboxylic acid aryl ester-based plasticizers such as diphenyl succinate and di-4-methylphenyl glutarate; cycloalkyl dicarboxylic acid alkyl ester-based plasticizers such as dihexyl-1,4-cyclohexanedicarboxylate and didecyclbicyclo[2.2.1]heptane-2,3-dicarboxylate; cycloalkyl dicarboxylic acid cycloalkyl ester-based plasticizers such as dicyclohexyl-1,2-cyclobutane dicarboxylate and dicyclopropyl-1,2-cyclohexyl dicarboxylate; cycloalkyl dicarboxylic acid aryl ester-based plasticizers such as diphenyl-1,1-cyclopropyl dicarboxylate and di-2-naphthyl-1,4-cyclohexane dicarboxylate; aryl dicarboxylic acid alkyl ester-based plasticizers such as diethyl phthalate, dimethyl phthalate, dioctyl phthalate, dibutyl phthalate and di-2-ethylhexyl phthalate; aryl dicarboxylic acid cycloalkyl ester-based plasticizers such as dicyclopropyl phthalate and dicyclohexyl phthalate; and aryl dicarboxylic acid aryl ester-based plasticizers such as diphenyl phthalate and di-4-methylphenyl phthalate. These alkoxy groups and cycloalkoxy groups may be the same or different, and may be substituted once or further substituted. Also, the substituents may be mixtures of the alkoxy groups and cycloalkoxy groups or covalently bound one another. An aromatic ring in phthalic acid may also be substituted and a multimer such as a dimer, a trimer, and a tetramer.

A partial structure or a phthalic acid ester may also be pendant on a polymer partially or regularly, and may also be introduced into a part of a molecular structure of an additive such as an antioxidant, an acid capturing agent, and an ultraviolet absorber.

Hydrogen atoms in an alkyl group, a cycloalkyl group and an aryl group, which are derived from a monovalent alcohol, may be substituted with alkoxycarbonyl groups. An example of such a plasticizer includes ethylphthalylethyl glycolate.

Examples of other polyvalent carboxylic acid ester-based plasticizers include alkyl polyvalent carboxylic acid alkyl ester-based plasticizers such as tridodecyl tricarbanilate, tributyl-meso-butane-1,2,3,4-tetracarboxylate; alkyl polyvalent carboxylic acid cycloalkyl ester-based plasticizers such as tricyclohexyl tricarbanilate, tricyclopropyl-2-hydroxy-1,2,3-propanetricarboxylate; alkyl polyvalent carboxylic acid aryl ester-based plasticizers such as triphenyl 2-hydroxy-1,2,3-propane tricarboxylate, and tetra-3-methyl phenyltetrahydrofuran-2,3,4,5-tetracarboxylate; cycloalkyl polyvalent carboxylic acid alkyl ester-based plasticizers such as tetrahexyl-1,2,3,4-cyclobutanetetracarboxylate, tetrabutyl-1,2,3,4-cyclopentanetetracarboxylate; cycloalkyl polyvalent carboxylic acid cycloalkyl ester-based plasticizers such as tetracyclopropyl-1,2,3,4-cyclobutanetetracarboxylate, tricyclohexyl-1,3,5-cyclohexyl tricarboxylate; cycloalkyl polyvalent carboxylic acid aryl ester-based plasticizers such as triphenyl-1,3,5-cyclohexyl tricarboxylate and hexa-4-methylphenyl-1,2,3,4,5,6-cyclohexyl hexacarboxylate; aryl polyvalent carboxylic acid alkyl ester-based plasticizers such as tridodecylbenzene-1,2,4-tricarboxylate and tetraoctylbenzene-1,2,4,5-tetracarboxylate; aryl polyvalent carboxylic acid cycloalkyl ester-based plasticizers such as tricyclopentylbenzene-1,3,5-tricarboxylate and tetracyclohexylbenzene-1,2,3,5-tetracarboxylate; and aryl polyvalent carboxylic acid aryl ester-based plasticizers such as triphenylbenzene-1,3,5-tetracarboxylate and hexa-4-methylphenylbenzene-1,2,3,4,5,6-hexacarboxylate. These alkoxy groups and cycloalkoxy groups may be the same or different, or may be substituted once or further substituted. The substituents may be mixtures of these alkyl groups and cycloalkyl groups or covalently bound one another. An aromatic ring in phthalic acid may also be substituted and a multimer such as a dimer, a trimer and a tetramer. A partial structure of a phthalic acid ester may also be pendant on a polymer partially or regularly, and may also be introduced into a part of a molecular structure of an additive such as an antioxidant, an acid capturing agent, and an ultraviolet absorber.

Among ester-based plasticizers made of polyvalent carboxylic acid and a monovalent alcohol, an alkyl dicarboxylic acid alkyl ester is preferable, and a specific example includes dioctyl adipate described above.

(Other Plasticizers)

Examples of the other plasticizers used in the present invention include phosphoric acid ester-based plasticizers, carbohydrate ester-based plasticizers and polymer plasticizers.

(Phosphoric Acid Ester-Based Plasticizers)

Specific examples of the phosphoric acid ester-based plasticizers include phosphoric acid alkyl esters such as triacetyl phosphate and tributyl phosphate; phosphoric acid cycloalkyl esters such as tricyclebenzyl phosphate and cyclohexyl phosphate; phosphoric acid aryl esters such as triphenyl phosphate, tricresyl phosphate, cresylphenyl phosphate, octyldiphenyl phosphate, diphenylbiphenyl phosphate, trioctyl phyosphate, tributyl phosphate, trinaphthyl phosphate, trixylyl osphate, and trisortho-biphenylphosphate. These substituents may be the same or different, and may be further substituted. Also, the substituents may be mixtures of an alkyl group, a cycloalkyl group and an aryl group or covalently bound one another.

Examples also include phosphoric acid esters of alkylenebis(dialkyl phosphate) such as ethylenebis(dimethyl phosphate) and butylenebis(diethyl phosphate), alkylenebis(diaryl phosphate) such as ethylenebis(diphenyl phosphate) and propylenebis(dinaphthylphosphate), arylenebis(dialkyl phosphate) such as phenylenebis(dibutyl phosphate) and biphenylenebis(dioctyl phosphate), and arylenebis (diaryl phosphate) such as phenylenebis(diphenyl phosphate) and naphthalenebis(ditolyl phosphate). These substituents may be the same or different, and may be further substituted. Also, the substituents may be mixtures of an alkyl group, a cycloalkyl group and an aryl group or covalentyl bound one another.

A partial structure of a phosphoric acid ester may also be pendant on a polymer partially or regularly, and may also be introduced into a part of a molecular structure of an additive such as an antioxidant, an acid capturing agent and an ultraviolet absorber. Among the above described compounds, phosphoric acid aryl ester and arylenebis(diaryl phosphate) are preferable, and specifically, triphenyl phosphate and phenylenebis(diphenyl phosphate) are preferable.

(Carbohydrate Ester-Based Plasticizers)

Carbohydrate means monosaccharide, disaccharide or trisaccharide in which saccharide is present in a form of a pyranose or a furanose (6-membered ring or 5-membered ring). Unlimited examples of carboxylate include glucose, saccharose, lactose, cellobiose, mannose, xylose, ribose, galactose, arabinose, fructose, sorbose, cellotriose and raffinose. A carboxylate ester indicates a material forming an ester compound obtained by dehydration and condensation of a hydroxyl group in carbohydrate and carboxylic acid and specifically means an aliphatic carboxylic acid ester or as aromatic carboxylic acid ester of carbohydrate. Examples of aliphatic carboxylic acid include acetic acid and propionic acid, and examples of aromatic carboxylic acid include benzoic acid, toluic acid and anisic acid. Carbohydrate has the number of hydroxyl groups depending on its kind, a part of hydroxyl groups and carboxylic acid may be reacted to form an ester compound, or all of the hydroxyl groups and carboxylic acid may be reacted to form an ester compound. It is preferred in the present invention that all of the hydroxyl groups and carboxylic acid may be reacted to form an ester compound.

Specific examples of carboxylate ester-based plasticizers preferably include glucose pentaacetate, glucose pentapropionate, glucose pentabutylate, saccharose octaacetate and saccharose octabenzoate, among these examples, saccharose octaacetate and saccharose octabenzoate are more preferable, and saccharose octabenzoate is particularly preferable.

A part of examples of these compounds are listed below, but the present invention is not limited thereto.

MONOPET SB: manufactured by Dai-ichi Kogyo Seiyaku Co., Ltd.

MONOPET SOA: manufactured by Dai-ichi Kogyo Seiyaku Co., Ltd.

(Polymer Plasticizers)

Specific examples of a polymer plasticizer include aliphatic hydrocarbon-based polymers, alicyclic hydrocarbon polymers, acrylic polymers such as poly(ethyl methacrylate), poly(methylmethacrylate), a copolymer of methyl methacrylate and 2-hydroxy ethyl methacrylate (for example, any copolymerization ratio between 1:99 and 99:1), vinyl-based polymers such as polyvinylisobutyl ether and poly-N-vinylpyrrolidone, styrene-based polymers such as polystyrene and poly 4-hydroxystyrene, polyesters such as polybutylene succinate, polyethylene terephthalate and polyethylene naphthalate, polyethers such as polyethylene oxide and polypropylene oxide, polyamide, polyurethane, and polyurea. The number average molecular weight is preferably about 1,000 to 10,000, and particularly preferably 5,000 to 10,000. When the number average molecular weight as 1,000 or more, a problem of volatility can be suppressed, and when it is 10,000 or less, functions of a plasticizer can be exerted and mechanical properties of an optical film can be improved. Each of these polymer plasticizers may be a single polymer made of one kind of repeated units or a copolymer having plural repeated structures. Two or more polymers described above may also be used in combination.

The above described plasticizers can be used solely or two or more of the plasticizers can be used in combination, when two or more plasticizers are used, at least one of the plasticizers is preferably a polyvalent alcohol ester-based plasticizer.

A blending amount of a plasticizer is suitably selected within the range which does not damage the object of the present invention, but a blending amount of 0.1 to 20% by mass is preferably added, and 0.2 to 10 parts by mass is more preferably added, with respect to the total amount of the surface-modified nanofiber (100 parts by mass).

(7) Mat Binder

A sheet substrate can contains a mat binder in order to impart sliding property, and optical and mechanical functions.

Examples of the mat binder include fine particles of inorganic compounds or fine particles of organic compounds. A mat binder with a shape of a sphere, a bar, a needle, a layer or a flat plate is preferably used.

Examples of the mat binder include inorganic fine particles and crosslinked polymer fine particles of metallic oxides, phosphates, silicates, carbonates, and the like, such as silicon dioxide, titanium dioxide, aluminum oxide, zirconium oxide, calcium carbonate, kaolin, talc, calcined calcium silicate, hydrated calcium silicate, aluminum silicate, magnesium silicate, calcium phosphate, and the like. In particular, silicon dioxide is preferable since haze in a film can be reduced.

These fine particles are preferably surface-treated with an organic substance since haze in a film can be reduced. The surface treatment is preferably carried out with halosilanes, alkoxysilanes, silazane, siloxane, or the like.

When an average particle diameter of a fine particle is large, an effect of a sliding property is significant and, on the contrary, when an average particle diameter is small, transparency is excellent. In general, an average particle diameter of a primary particle of the fine particle is within the range from 0.01 to 1.0 μm. An average particle diameter of a primary particle of the fine particle is preferably from 5 to 50 nm, and more preferably from 7 to 14 nm. These fine particles are preferably used since the fine particles generate unevenness with a size from 0.01 to 1.0 μm on a substrate surface.

Such fine particles of silicon dioxide are commercially available as trade names of AEROSIL 200, 200V, 300, R972, R972V, R974, R202, R812, OX50, TT600, NAX50, and the like, manufactured by Nippon Aerosil Co., Ltd., and KE-P10, KE-P30, KE-P100, KE-P150, and the like, manufactured by NIPPON SHOKUBAI CO., LTD., and can be used.

In particular, AEROSIL 200V, R972V, NAX50, KE-P30, and KE-P100 are preferable since an effect of reducing an friction coefficient is large while a turbidity of a film is kept low.

Two or more of these fine particles can be used in combination. When two or more thereof are used in combination, they can be used in mixing at any ratio. Fine particles with different average particle diameters and materials, for example, AEROSIL 200V and R972V can be used within the range of a mass ratio from 0.1:99.9 to 99.9:0.1.

When a mat binder is added in a larger amount, the obtained film sliding property is more increased, but the more the mat binder is added, the more haze increases; therefore, the blending amount is suitably selected within the range which does not damage the object of the present invention. As one example, the blending amount to be added is preferably from 0.001 to 5 parts by mass, more preferably from 0.005 to 1 part by mass, and further more preferably from 0.01 to 0.5 part by mass with respect to the total amount of the surface-modified nanofiber (100 parts by mass).

(8) Optical Anisotropy Controlling Agent

A retardation increasing agent can be added to control optical anisotropy depending on cases. An aromatic compound having at least two aromatic rings is preferably used as the retardation increasing agent in order to adjust retardation of a film. The aromatic compound is used within the range from 0.01 to 20 parts by mass with respect to the total amount of the surface-modified cellulose nanofiber (100 parts by mass). The aromatic compound is preferably used within the range from 0.05 to 15 parts by mass, and more preferably within the range from 0.1 to 10 parts by mass. Two or more aromatic compounds may be used in combination. Aromatic rings in such an aromatic compound include an aromatic hetero ring in addition to an aromatic hydrocarbon ring. The aromatic hydrocarbon ring is particularly preferably a 6-membered ring (that is, a benzene ring). An aromatic hetero ring is generally an unsaturated hetero ring. The aromatic hetero ring is preferably a 5-membered ring, a 6-membered ring or a 7-membered ring, and more preferably a 5-membered ring or a 6-membered ring. An aromatic hetero ring generally has the highest number of double bonds. As a hetero atom, a nitrogen atom, an oxygen atom and a sulfur atom are preferable, and a nitrogen atom is particularly preferable. Examples of the aromatic hetero ring include a furan ring, a thiophene ring, a pyrrole ring, an oxazole ring, an isooxazole ring, a thiazole ring, an isothiazole ring, an imidazole ring, a pyrazole ring, a furazan ring, a triazole ring, a pyrimidine ring, a pyridine ring, a pyridazine ring, a pyrimidine ring, a pyrazine ring and a 1,3,5-triazine ring. The details of these aromatic hetero rings are described in Japanese Patent Application Laid-Open Nos. 2004-109410, 2003-344655, 2000-275434, 2000-111914, 12-275434, and so on.

(9) Crosslinking Agent

The sheet substrate can contain a crosslinking agent. By adding a crosslinking agent, intertwist among cellulose nanofibers can be close, transparency is improved and thermal expansion is reduced, thus being preferable.

As a crosslinking agent, metal oxides, for example, aluminum oxide, boric acid, and cobalt oxide are preferable. At least one selected from the group consisting of a compound having a vinyl sulfone group such as methaxylene vinyl sulfonic acid, a compound having an epoxy group such as bisphenol glycidyl ether, a compound having an isocyanate group, a compound having a blocked isocyanate group, a compound having an active halogen group such as 2-methoxy-4,6-dichlortriazine and 2-sodiumoxy-4,6-dichlortriazine, a compound having an aldehyde group such as formaldehyde and glyoxal, a compound having an ethyleneimine group such as mucochloric acid, tetramethylene-1,4-bis (ethyleneurea) and hexamethylene-1,6-bis (ethyleneurea), and a compound having an active ester generating group can be used. These crosslinking agents may be used in combination of two or more thereof. Among these compounds, a metal oxide, a compound having a vinylsulfone group, a compound having an ethyleneimine group, and a compound having an epoxy group are particularly preferable.

In the present invention, a compound having a vinylsulfone group means a compound having a vinyl group that is bound to a sulfonyl group or a compound having a group that can form a vinyl group, and is preferably a compound having at least two groups having a vinyl group that is bound to a sulfonyl group or groups that can form vinyl groups and expressed by the general formula (8) described below.

[Chemical Formula 14]

(CH_{2═CHSO}₂)ₙA General Formula (8)

In the formula, A represents as n-valent connecting group, examples thereof include an alkylene group, a substituted alkylene group, a phenylene group and a substituted phenylene group, and the n-valent connecting group may have an amide connecting moiety, an amino connecting moiety, an ether connecting moiety or a thioether connecting moiety in the middle of the group. As a substituent, examples include a halogen atom, a hydroxy group, a hydroxyalkyl group, an amino group, a sulfonic acid group and a sulfuric ester group, n represents 1, 2, 3 or 4.

Hereinbelow, typical examples of a vinylsulfone-based crosslinking agent will be shown.

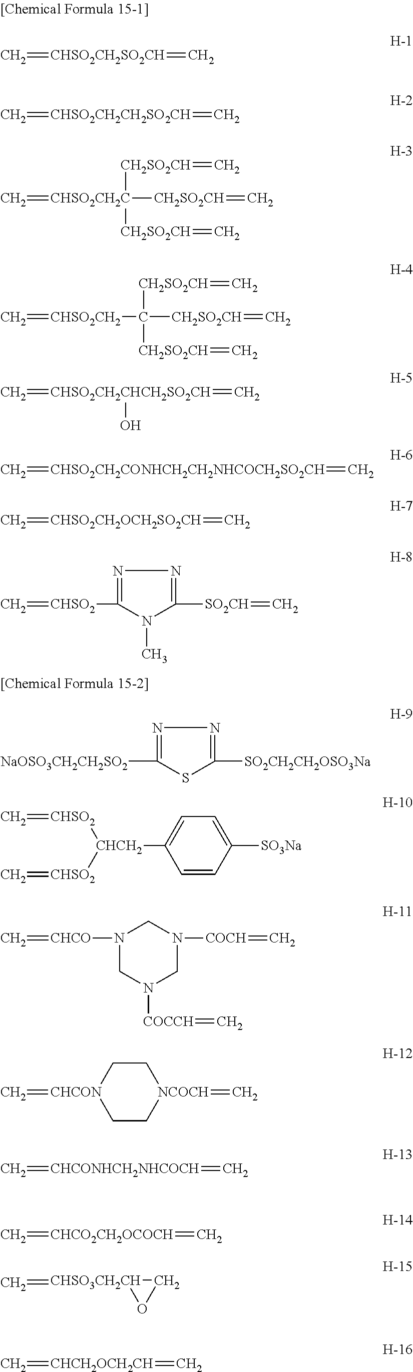

As a compound having an epoxy group, in particular, a compound having two or more epoxy groups and a molecular weight of 300 or less per one functional group is preferable. Hereinbelow, specific examples of a crosslinking agent having an epoxy group will be shown.

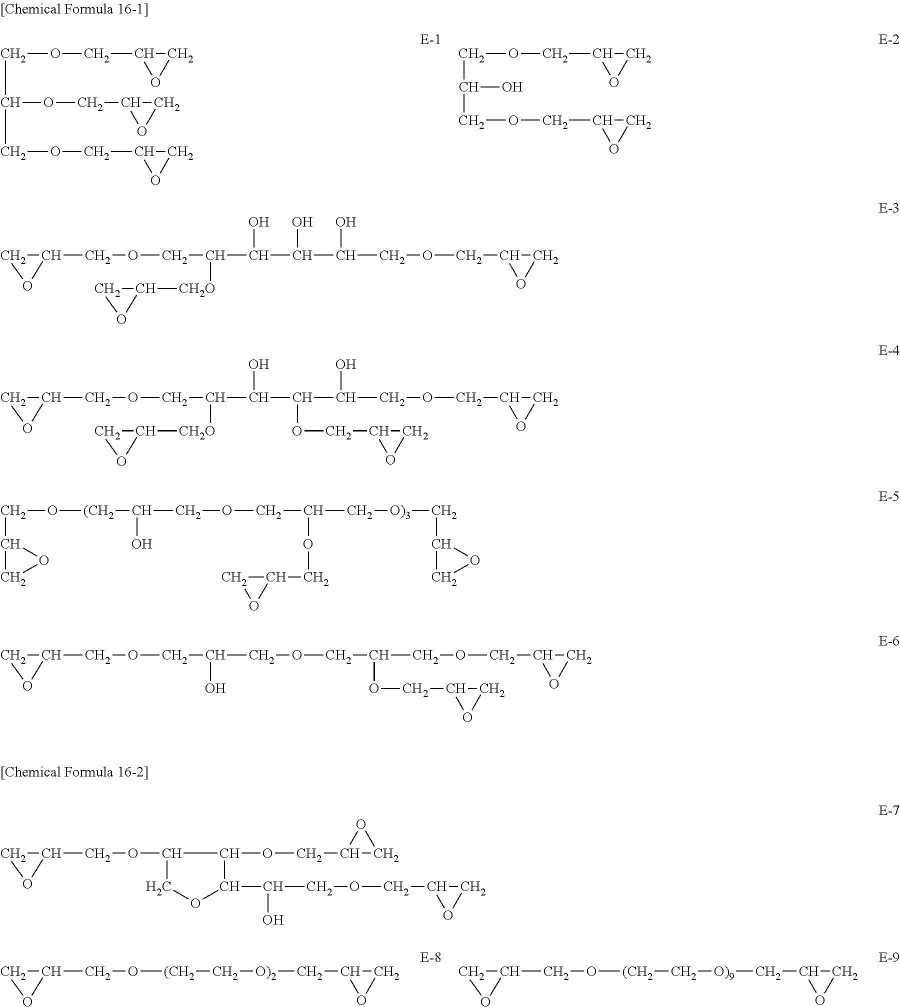

As a compound having an ethyleneimine group, in particular, a compound that is bifunctional or trifunctional and has a molecular weight of 700 or less is preferably used. Hereinbelow, specific examples of a crosslinking agent having an ethyleneimine group will be shown.

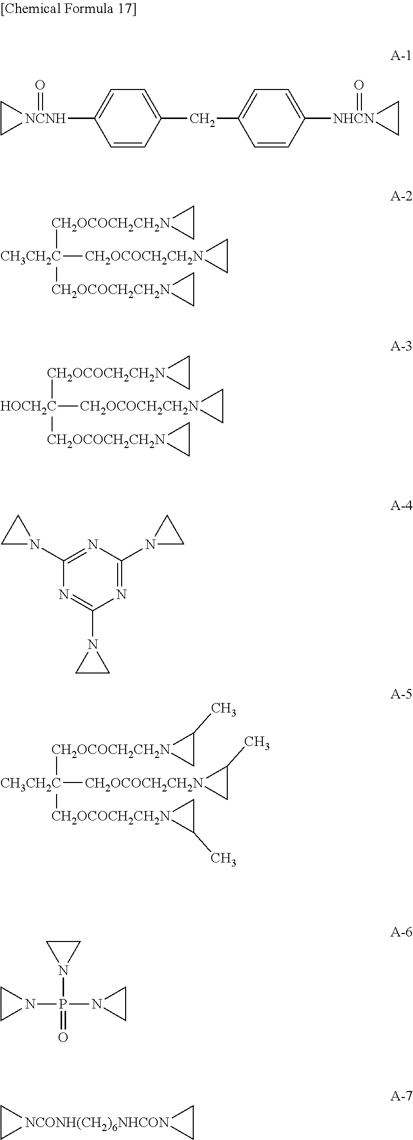

An amount to be used of a crosslinking agent is suitably selected within the range which does not damage the object of the present invention, and is preferably from 0.1 to 10% by mass, and more preferably from 1 to 8% by mass with respect to the total amount of the surface-modified cellulose nanofiber (100 parts by mass).

A thickness of a sheet substrate is not particularly limited, and is preferably from 10 to 200 μm, more preferably from 50 to 150 μm, and particularly preferably from 50 to 125 μm.

(Gas Barrier Layer)

A gas barrier layer is formed on at least one surface of the sheet substrate and means a layer having high gas barrier property mainly to water vapor and oxygen. A gas barrier layer is to prevent deterioration in a substrate and various electronic elements protected by the substrate particularly at high humidity.

A gas barrier layer is not particularly limited as long as it is an inorganic film having the above described functions and preferable transparency. From the viewpoint of transparency and gas barrier property, silicon oxide, silicon nitride, silicon oxynitride, aluminum oxide, tantalum oxide, aluminum oxynitride, SiAlON, and the like can be used.

Furthermore, from the viewpoint of acid resistance and alkali resistance, silicon oxide, silicon nitride, and/or silicon oxynitride are preferably used as a main component (30% by mass or more with respect to 100% by mass of constituting materials of a gas barrier layer), and the amount is more preferably 40% by mass or more, and further more preferably 50% by mass or more, with respect to 100% by mass of constituting materials of a gas barrier layer. The gas barrier, layer may nave a single layer structure or a laminated layer structure formed from plural layers for improving gas carrier property more.

The surface roughness (Ra) of the surface of the gas barrier layer is preferably 2 nm or less, and more preferably 1 nm or less. The surface roughness within the above described range gives an effect of improving light transmission efficiency through a smooth film surface with less unevenness and an effect of improving an energy conversion efficiency due to reduction of interelectrode leak current when used as an organic substrate for an electronic element. Note that the surface roughness (Ra) of the gas barrier layer is calculated according to the method described in examples using AFM (atomic force microscope).

The thickness of the gas barrier layer is not particularly limited and is from 0.01 to 5 μm, more preferably from 0.05 to 3 μm, and the most preferably from 0.1 to 1 μm.

(Intermediate Layer)

The gas barrier film of the present invention may have an intermediate layer interposed between a sheet substrate and a gas barrier layer, examples of such an intermediate layer include a flat and smooth layer, a bleed out preventing layer, and an anchor coat layer. By forming such an intermediate layer, improvement in adhesivity between a gas barrier layer and a substrate and gas barrier characteristics can be attempted.

(Physical Properties of Gas Barrier Film)

Gas barrier property can be measured according to the method in reference to JIS-K7129: 1992. An oxygen transmission can be measured according to the method in reference to JIS-K7126:1987. A water vapor permeability (60±0.5° C. relative humidity (90±2)% RH) may be 1×10⁻³ g/(m²·24 h) or less in the present invention. Since an oxygen transmission is generally smaller than a water vapor permeability, as long as gas barrier property satisfies the water vapor permeability described above, it scarcely becomes a problem as an organic element.

As for transparency, a gas barrier film preferably has high transparency such as having a total light transmittance of 85% or more, particularly 90% or more. When it is less than 85%, a range of application purposes is narrowed, in particular, an image may be disturbed or sharpness may deteriorate. High transparency as described above is also needed after heat processing in a manufacturing step. The light transmittance can be measured by a spectrophotometer.

A haze value is preferably less than 1.5%, more preferably less than 1%, and further more preferably less than 0.5%. A haze can be measured by using a turbidimeter.

A yellowness (yellow index, YI) can be used as an index of staining properties, and preferably 3.0 or less, and more preferably 1.0 or less. The yellowness can be measured based on JIS-K7103:1994.

A linear thermal expansion coefficient at 20 to 200° C. is preferably 15 ppm/K or less, more preferably 10 ppm/K or less, further more preferably 5 ppm/K or less. When of is larger than 15 ppm/K, because of difference in linear thermal expansion coefficients with inorganic films such as a conductive film and a barrier film, which form an element device, and also with a glass, there may cause problems such that a film is broken and the functions cannot be exerted, flexure and deformation are generated in a film, and imaging performance and a refraction index are wrong as element parts due to heat processing in a manufacturing step, and the like.

A film thickness of a gas barrier film is not particularly limited, and 10 to 200 μm is preferably used. The film thickness is particularly preferably from 50 to 150 μm. The film thickness is further more preferably from 75 to 125 μm.

(Method for Manufacturing Gas Barrier Film)

A method for manufacturing the above described gas barrier film is not particularly limited and the gas barrier film can be suitably prepared in reference to conventionally known methods.

According to another embodiment of the present invention, a method for manufacturing a gas barrier film is provided. The manufacturing method in the embodiment includes (1) a step A of obtaining a surface-modified cellulose nanofiber by substituting at least a part of hydrogen atoms in a hydroxyl group in the cellulose nanofiber with acyl groups each having 1 to 8 carbon atoms and forming the surface-modified cellulose nanofiber into a film by a melt extrusion method or a solution cast method, and (2) a step B of forming a bas barrier layer on the sheet substrate.

(1) Step A

(1-1) Manufacture of Surface-Modified cellulose Nanofiber

Firstly, a surface-modified cellulose nanofiber is obtained by substituting at least a part of hydrogen atoms in a hydroxyl group in the cellulose nanofiber with acyl groups.

As the cellulose nanofiber, one obtained by a fibrillation treatment on a raw material cellulose fiber may be used.

A method of substituting hydrogen atoms in a hydroxyl group in a cellulose nanofiber with acyl groups is not particularly limited and can be carried out according to a known method. For example, a cellulose nanofiber obtained by a fibrillation treatment is added to water or a suitable solvent and then dispersed, thereto was added a carboxylic acid halide, a carboxylic acid anhydride, carboxylic acid, or aldehyde to react under appropriate reaction conditions.

During the reaction, a reaction catalyst can be added, if necessary, for example, basic catalysts such as pyridine, N,N-dimethylaminopyridine, triethylamine, sodium methoxide, sodium ethoxide and sodium hydroxide, and acidic catalysts such as acetic acid, sulfuric acid and perchloric acid can be used, and in order to prevent reduction of a reaction speed and a polymerization degree, a basic catalyst such as pyridine is preferably used. A reaction temperature is preferably from about 40 to 100° C. from the viewpoint of suppressing deterioration such as yellowing of a cellulose fiber and reduction of a polymerization degree and securing a reaction speed. A reaction time may be suitably selected according to an acylating agent to be used and treatment conditions.

(1-2) Film Formation

Subsequently, the surface-modified cellulose nanofiber obtained above is formed into a film by a melt extrusion method or a solution cast method to thus obtain a sheet substrate.

(a) Melt Extrusion Method

When a melt extrusion method (melt flow cast method) is used, a sheet substrate can be manufactured by a method in which a cellulose nanofiber composition containing a surface-modified cellulose nanofiber and, if necessary, a trace amount of a matrix resin, and additives is molten at a high temperature and the obtained molten product is extruded from a pressure die, etc., and flow cast onto, for example, a flow cast support of an endlessly transferring metallic belt without edges or rotating metallic drum.

(a-1) Preparation of Cellulose Nanofiber Composition

Firstly, a cellulose nanofiber composition containing a surface-modified cellulose nanofiber and, a matrix resin and additives, which are added if necessary, is prepared. Preparation of the composition may be carried out in any step after the fibrillation treatment of a cellulose nanofiber and before melting. The composition is preferably mixed before melting and more preferably mixed before heating. Alternatively, additives may be added in a manufacturing process of a resin molten product. In this case, when a plurality of additives are used, the additives are previously mixed and dispersed in a solvent, and a solid substance obtained by vaporizing or precipitating the solvent is then obtained and can be added in the manufacturing step of the resin molten product.

A mixing means is not particularly limited and, for example, general mixing machines such as a V type mixer, a conical screw type mixer, a horizontal cylinder type mixer, a henschel mixer, a ribbon mixer, and an elongational flow dispersing machine can be used.

Further, the cellulose nanofiber composition is preferably dried with hot air or vacuum-dried before melting.

(a-2) Melt Extrusion

The cellulose nanofiber composition obtained above is molted and formed into a film using an extruder. During melt extrusion, the cellulose nanofiber composition is prepared, and may be then directly molten and formed into a film using an extruder, or the cellulose nanofiber composition may be pelletized and the pellet may be then molten and formed into a film with an extruder.

When the cellulose nanofiber composition contains plural materials with different melting points, a half-molten product in a so-called brittle state is prepared at a temperature of only melting a material with a lower melting point once and the half-molten product can also be charged into an extruder and formed into a film.

When a material that is easily thermally decomposed is contained in the cellulose nanofiber composition, a method of directly forming into a film without preparing pellets or forming a film after preparing a half-molten product in a brittle state as described above for the purpose of decreasing the number of melting is preferable.

As an extruder, various commercially available extruders cab be used, and a melt kneading extruder is preferable, and both a single screw extruder and a twin screw extruder may be used. When film formation is directly performed without preparing pellets from a cellulose nanofiber composition, a twin screw extruder is preferably used because a proper degree of mixing is necessary, but a proper degree of mixing can also be obtained oven with a single screw extruder by changing a screw shape to kneading type screw such as maddock type, unimelt and dulmage so that a simple screw extruder can be used. When pellets or a half-molten product in a brittle state is used once, both a single screw extruder and a twin screw extruder can be used.

A preferable condition for a melting temperature is different depending on a viscosity and a discharge amount of a cellulose nanofiber composition (film constituting material), a thickness of a sheet to be produced, and the like, but the melting temperature based on a glass transition temperature Tg of a film is generally Tg or more and Tg+100° C. or less, and preferably Tg+10° C. or more and Tg+90° C. or less.

Tg of a modified part with an acyl group in the cellulose nanofiber is used as a target in the present invention. However, thermal decomposition is the cellulose nanofiber is concern at a high temperature and, specifically, a temperature at a melt extrusion is preferably within the range from 150 to 300° C., more preferably from the range from 180 to 270° C., and further more preferably within the range from 200 to 250° C.

A melt viscosity during extrusion is preferably from 10 to 100,000 P (1 to 10,000 Pa·s), and more preferably from 100 to 10,000 P (10 to 1,000 Pa·s).

A retention time of a cellulose nanofiber composition in an extruder is preferably short, and preferably within 5 minutes, more preferably within 3 minutes, and further more preferably within 2 minutes. The retention time depends on a kind of an extruder 1 and extrusion conditions, but can be shortern by adjusting a supply amount and L/D of the composition, a screw rotational number, a groove depth of a screw, and the like.

(a-3) Cooling

Melt extrusion is preferably carried out by extruding into a film form by a T die. Further, it is preferred that, after extrusion, a film-form extrusion is closely attached to a cooling drum by an electrostatic application method, or the like, and solidified by cooling, to thus obtain an unstretched film. During cooling, the temperature of the cooling drum is preferably kept at 90 to 150° C.

It is preferable to decrease an oxygen concentration by replacing with an inert gas such as a nitrogen gas or reducing a pressure in an extruder or a cooling step after extrusion.

An unstretched film (sheet substrate) can be thus obtained according to the steps described above.

(b) Solution Cast Method

When a solution cast method is used, the step A includes a step of preparing a dope by dissolving a surface-modified cellulose nanofiber and, if necessary, a trace amount of a matrix resin, and additives in a solvent, a step of flow casting the dope onto an endlessly transferring metallic support without edges, a step of drying the flow cast dope as a web, a step of peeling off the web from the metallic support, and a step of rolling up a finished film.

(b-1) Dope Preparation Step

Firstly, a surface-modified cellulose nanofiber and, if necessary, a trace amount of a matrix resin, and additives are dissolved in a solvent to obtain a dope.

A solvent used in a dope may be used solely or in combination of two or more thereof, and a use of a good solvent and a poor solvent of the surface-modified cellulose nanofiber in mixture is preferable frost the viewpoint of production efficiency, and a use of a larger amount of a good solvent is preferable from the viewpoint of solubility of the surface-modified cellulose nanofiber. As for a preferable range of a mixing ratio of a good solvent and a poor solvent the good solvent is from 2 to 30% by mass, and the poor solvent is from 70 to 98% by mass. The good solvent and poor solvent are defined to be a solvent that dissolves a cellulose nanofiber to be used solely as a good solvent and a solvent that swells or does not dissolve a cellulose nanofiber solely as a poor solvent. These can be suitably selected because of changing depending on a substitution degree of acyl groups in the surface-modified cellulose nanofiber and a degree of crystallinity.

The good solvent is not particularly limited, and examples thereof include organic halogen compounds such as methylene chloride, dioxolane, acetone, methyl acetate and methyl acetoacetate. Methylene chloride or methyl acetate is particularly preferable.

The poor solvent is not particularly limited, and examples each as methanol, ethanol, n-butanol, cyclohexane and cyclohexanone are preferably used. Further, water in an amount of 0.01 to 2% by mass is preferably contained in a dope.

A concentration of the surface-modified cellulose nanofiber in a dope is preferably high since dry load can be reduced after flow casting onto a metallic support, but when the concentration of the surface-modified cellulose nanofiber is too high, a filtration accuracy deteriorates. As a concentration of achieving compatibility with the both, 10 to 35% by mass is preferable, and 15 to 25% by mass is more preferable.

As a method of dissolving the surface-modified cellulose nanofiber when the above descried dope is prepared, a general method can be used. Combination of heating and pressuring is preferable because of being able to heat at a boiling point or more under a normal pressure. That is, when the surface-modified cellulose nanofiber is dissolved by stirring while heating at a temperature within the range from a boiling point or more of a solvent under a normal pressure to a temperature at which the solvent does not boil under pressurization, generation of undissolved block substances called gel and lump is prevented, thus being preferable.

In addition, a method of mixing the surface-modified cellulose nanofiber with a poor solved to be humidified or swollen and then further adding a good solvent to dissolve the surface-modified cellulose nanofiber is also preferably used. Pressurization may be carried out by a method of pressing an inert gas sound as a nitrogen gas or a method of expressing a vapor pressure of a solvent by heating. Heating is preferably carried out from the outside and, for example, a jacket type is preferable since temperature control is easy.

A heating temperature after addition of a solvent is preferably high from the viewpoint of solubility of the cellulose nanofiber, but when the heating temperature is too high, a required pressure becomes large and productivity thus deteriorates. A heating temperature is preferably from 45 to 120° C. more preferably from 60 to 110° C. and further more preferably from 70° C. to 105° C. A pressure is adjusted so as not to allow a solvent to boil at a preset temperature. Alternatively, a cooling dissolution method is also preferably used.

Various additives may be batch-added to a dope before film formation, or a solution obtained by dissolving additives into an alcohol such as methanol, ethanol and butanol, an organic solvent such as methylene chloride, methyl acetate, acetone and dioxolan, or a mixed solvent of these solvents may be separately prepared and added inline. It is preferred that, in particular, a part or the whole amount of fine particles is added inline in order to reduce a load to a filtering material. In order to perform inline addition and mixing, for example, inline mixers such as a static mixer (manufactured by Toray Engineering Co., Ltd.) and SWJ (Static type inline mixer Hi-Mixer manufactured by Toray Industries, Inc.) are preferably used.

In the dope dissolved with the surface-modified cellulose nanofiber, impurities, particularly, a luminescent spot foreign matter, which is contained in the raw material cellulose nanofiber, is preferably removed and reduced by filtration. The luminescent spent foreign matter means a spot (foreign matter) from which leaked light is seen from the opposite side when two polarizing plates are placed in a crossed nichol state, an optical film, or the like, is placed between the polarizing plates, and light is irradiated from a side of one polarizing plate to observe from the other side of polarizing plate, and the number of luminescent spots having a diameter of 0.01 mm or more is preferably 200 spots/cm² or less. The number of luminescent spots is more preferably 100 spots/cm² or less, more preferably 50 spots/m² or less, and furthermore preferably 0 to 10 spots/cm² or less. In addition, luminescent spots with a diameter of 0.01 mm or less are preferably less.

A filtration method is not particularly limited and can be carried out in a general method, and filtration by use of an appropriate filtering material such as filter paper is preferable.

As a filtering material, one having a small absolute filtration accuracy is preferable to remove undissolved materials, but when the absolute filtration accuracy is too small, there is a problem of easily generating clogging is a filtering material. Therefore, a filtering material having the absolute filtration accuracy of 0.008 mm or less is preferable, a filtering material having the absolute filtration accuracy of 0.001 to 0.008 mm is more preferable, and a filtering material having the absolute filtration accuracy of 0.003 to 0.006 mm is further more preferable.

A material of a filtering material is not particularly limited, a general filtering material can be used, and a filtering material made of plastics such as polypropylene and Teflon (registered trademark) and a filtering material made of metals such as stainless steel are preferable because of no omission of fibers.

The filtration conditions are not particularly limited, and a method of filtering while heating within the temperature range from a boiling point or more under a normal pressure of a solvent to a temperature at which the solvent does not boil under pressure is preferable since an expression of difference in filtration pressures before and after filtration (referred to as a differential pressure) is small. A temperature is preferably from 45 to 120° C., more preferably from 45 to 70° C., and further more preferably 45 to 55° C. A filtration pressure is preferably small. The filtration pressure is preferably 1.6 MPa or less, more preferably 1.2 MPa or less, and further more preferably 1.0 MPa or less.

(b-2) Dope Flow Cast Step

Subsequently, a dope is flow cast (cast) on a metallic support.

The metallic support is preferably a mirror finished metallic support, and as the metallic support, a stainless steel belt or a drum plated on the surface with a cast metal is preferably used. The width of cast can be set from 1 to 4 m.

(b-3) Dry Step

Then, the flow-cast dope is dried as a web.

The surface temperature of the metallic support is within a range from −50° C. to less than a boiling point of a solvent. A higher temperature is preferable since a dry speed of a web can be made fast, but when the temperature is too high, the web may foam or planarity may deteriorate in cases. The temperature of the support is preferably from 0 to 40°0 C., and more preferably from 5 to 30° C.

A method of controlling a temperature of a metallic support is not particularly limited, and examples include a method of blowing warm air or cold air to a metallic support and a method of bringing warm water into contact with the backside of a metallic support. The method of using warm water is preferable since heat transfer is effectively performed and a time until the temperature of the metallic support becomes constant is thus short. When warm air is used, there is a case of using air at a higher temperature than a target temperature.

In addition, a solvent removed in the dry step is recovered and can be reused as a solvent that is used for dissolution of the above described surface-modified cellulose nanofiber in the dope preparation step (b-1) described above. Note that there is a case of containing a trace amount of additives (for example, a plasticizer, an ultraviolet absorber, a polymer and monomer components) in a recovered solvent, but the recovered solvent can be preferably reused even when these additives are contained and, if necessary, can be purified and then reused.

(b-4) Peeling Step

Subsequently, the web is peeled off from a metallic support.

In order that a film after film formation shows preferable planarity, a residual solvent amount when the web is peeled off from the metallic support is preferably 10 to 150% by mass, more preferably 20 to 40% by mass or 60 to 130% by mass, and particularly preferably 20 to 30% by mass or 70 to 120% by mass.

The residual solvent amount is defined by the following mathematical formula (2) in the present invention.

[Mathematical Formula 2]

Residual solvent amount (% by mass)={(M−N)/N}×100 Mathematical Formula (2)

In the formula, M represents a mass of a sample obtained at any point of time during manufacture of a film or after manufacturing a film, and N represents a mass after heating the obtained sample described above (sample having mass of M) at 115° C. for 1 hour.

However, gelating a web by cooling and peeling off the web from a drum in a state that the web contains a large amount of a residual solvent is also a preferable method.

In addition, it is desirable that the peeled web is further dried so that the amount of the residual solvent is preferably 1% by mass or less, more preferably 0.1% by mass or less, and particularly preferably 0 to 0.01% by mass or less.

For drying, a roll dry method (a method of drying a web by alternately passing the web through a large number of rolls that are placed up and down) or a method of drying with transporting the web in a tenter method is generally adopted.

(b-5) Film Roll Up Step

Finally, the obtained web (finished film) is rolled up, thereby obtaining a sheet substrate.

(1-3) Stretch Treatment

The above obtained sheet substrate can be stretched at least in one direction after film formation. A film retardation can be adjusted by the stretch treatment and optical characteristics can be thus improved.

As a stretch method, an unstretched film obtained by peeling off from a cooling drum as described above is preferably heated within the range from a glass transition temperature (Tg) −50° C. of a part which is modified with an acyl group in a cellulose nanofiber to Tg+100° C. through a plurality of roll groups and/or a hearing device such as an infrared heater and longitudinally stretched in one stage or multiple stages in the film transport direction (also called the longitudinal direction). Next, the stretched surface-modified cellulose film obtained as described above is also preferably stretched in a direction perpendicular to the film transport direction (also called the thickness direction). A tenter device is preferably used in order to stretch a film in the thickness direction.

When a film is stretched in the film transport direction or the direction perpendicular to the film transport direction, the film is preferably stretched by a stretching ratio of 2.5 times or less, and more preferably within the range from 1.1 times to 2.0 times. When the stretching ratio is 2.5 times or less, generation of gaps around the nanofiber can be prevented and degradation of transparency can be suppressed.

In addition, heat processing can be also carried out subsequently after stretching. The heat processing is preferably carried out within the range from Tg−100° C. to Tg+50° C. usually for 0.5 to 500 seconds while transporting a film.

A heat processing technique is not particularly limited and carried out generally by hot air, infrared rays, a heat roll, a micro wave, or the like, and from the viewpoint of simplicity, heat processing is preferably carried out by hot air.

A heat processed film is generally cooled to Tg or less, cut in clip grasp parts in the both edges of the film and rolled up. For cooling, a film is preferably gradually cooled from the final heat processing temperature to Tg at a cooling speed of 100° C. or less per second.

A cooling technique is not particularly limited, and can be carried out by a conventionally known technique, and these treatments are preferably carried out while sequentially cooling particularly in plural temperature regions from the viewpoint of improvement in size stability of a film. Note that a cooling speed is a value found by (Tl−Tg)/t when the final heat processing temperature is assisted to be Tl and a time until the film reaches Tg from the final heat processing temperature is assumed to be t.

(c) Multilayer Formation

In addition, a film formed into a multilayered structure by a co-flow cast method may be obtained. Forming into a multilayered structure is effective since warpage, strain, and the like, in heat processing in production steps can be adjusted and transparency and thermal expansion can be adjusted. For example, a fiber having a small substitution degree of acyl groups and a high degree of crystallinity is set in the center and a fiber having a large substitution decree of acyl groups and a small degree of crystallinity is set on both sides of the fiber; thereby, warpage, strain, and the like, in heat processing can be improved. When a film is formed into a multilayered structure by co-flow cast method, a film thickness structure can be suitably adjusted.

(1-4) Calendering Treatment

The sheet substrate obtained as described above can be made transparent, smooth and flat by a heat calendering treatment after film formation. In addition, a stretch treatment may be carried out in addition to the heat calendering treatment and when both of the stretch treatment and the calendering treatment are carried out after film formation, the order is not particularly limited, and either of the treatments may be performed first.

Due to the heat calendering treatment, a resin component (acyl group component) modified with cellulose nanofiber can be dispersed in a film, thereby improving transparency, productivity, thermal expansion, and smoothness.

For the heat calendering treatment, in addition to a general calendering apparatus by a single press roll, a a super calendering apparatus having a structure with these rolls set in multiple stages may be used. These apparatuses, and each material (hardness of material) and linear load of both sides of rolls in the calendering treatment can be selected according to a purpose.

(2) Step B

Subsequently, a gas barrier layer is formed on the sheet substrate.

A method of forming a gas barrier layer is not particularly limited, and known techniques such as coating, a sol-gel method, a vapor deposition method, CVD (chemical vapor deposition method), and sputtering method can be used.

However, a more uniform, smooth and flat gas barrier layer can be formed by coating film materials on a substrate surface than providing the film materials as a gas as a CVD method. In particular, there is a fear that a foreign substance called particles that are unnecessary in a gas phase at the same time in a step of depositing raw material substances having increased reactivity in a gas phase when CVD is used. From such a viewpoint, a method in which a precursor material of a gas barrier layer is coated on the sheet substrate and the coated film is then modified is preferably used. In a coating method, generation of these particles can be suppressed by not allowing the raw material to exist in a gas phase reaction space.

The precursor material may be selected according to a material of a gas barrier layer, and examples thereof include a polysilazane compound, a sol-state organic metal compound. As the organic metal compound, those capable of hydrolysis may be used, and an example of a preferable organic metal compound is not particularly limited and includes metal alkoxide.

A polysilazane compound is preferably used as a precursor material of a gas barrier layer. That is, the step B preferably includes a modification treatment (modification step) after applying a coating liquid containing a polysilazane compound onto the above described sheet substrate.

When a gas barrier layer is formed on a surface of a conventional cellulose nanofiber substrate in which a matrix resin is allowed to exist around the cellulose nanofiber by using a polysilazane compound, there is problems such that the matrix resin is affected by a modification treatment such as ultraviolet irradiation after coating the polysilazane-containing liquid, layer separation near the substrate surface and unevenness of fine surface properties are generated and gas barrier property is not improved, and also, adhesivity between the substrate and the gas barrier layer and surface smoothness are damaged. Further, in order to solve problems of smoothness and adhesivity, even when an intermediate layer is provided between the substrate and a gas barrier layer, adhesivity in the case of long storage is damaged and storage property deteriorates as a result.

The detailed mechanism of the present invention is not revealed, but since the sheet substrate of the present invention does not substantially contain a matrix resin, adhesivity between the sheet substrate and the gas barrier layer, in particular, adhesivity in the case of long storage (storage property) can be improved.

Hereinbelow, the preferable embodiment, is explained.

(2-1) Coating Step of Polysilazane Compound-Containing Coating Liquid

Firstly, a polysilazane compound is dissolved in an organic solvent to prepare a polysilazane compound-containing coating liquid.

The “polysilazane compound” is a polymer having a silicon-nitrogen bond, which is a ceramic precursor inorganic polymer of SiO₂, Si₃N₄ and an intermediate solid solution or the both, SiOₓN_{y}, made of Si—N, Si—H, N—H, and so on.

It is preferred to use a polysilazane compound having a constituting unit shown by the following general formula (9), which is formed into a ceramic and modified into silica at a comparatively low temperature for the purposes of forming a uniform coating layer on a sheet substrate to obtain a gas barrier layer having preferable gas barrier property after modification and also not damaging characteristics of the substrate.

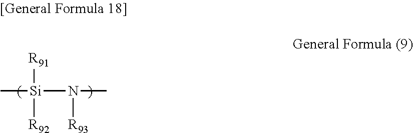

In the formula, R₉₁, R₉₂ and R₉₃ each independently represents a hydrogen atom, an alkyl group having 1 to 3 carbon atoms, an alkenyl group having 2 to 3 carbon atoms, an alkylsilyl group having 1 to 3 carbon atoms, an alkylamino group having 1 to 3 carbon atoms, and an alkoxy group having 1 to 3 carbon atoms.

From the viewpoint of precision of the obtained gas barrier film, perhydropolysilazane in which all of R₉₁, R₉₂ and R₉₃ are hydrogen atoms is particularly preferable,

Perhyodropolysilazane is supposed to have a structure wherein a linear chain structure and a ring structure having a 6-membered ring and a 8-membered ring are present in the center. The molecular weight is from about 600 to 2,000 (polystyrene conversion) by the number average molecular weight (Mn), and perhydropolysilazane is a substance that is a liquid or a solid at normal temperature and different depending on a molecular weight. Such perhydropolysilazane is commercially available in a solution state of dissolving in an organic solvent, and the commercially available product can be directly used as a state of a polysilazane-containing coating liquid.

On the other hand, organopolysilazane in which a part of hydrogen moieties bound to Si substituted with alkyl Groups (a compound having alkyl groups in R₉₁, R₉₂ and/or R₉₃) has advantages of being improved in adhesivity with a base substitute by having an alkyd group such as a methyl group, allowing a hard and brittle ceramic film made of polysilazane to have toughness, and suppressing generation of cracks even when an (average) film thickness is made larger.

Therefore, perhydropolysilazane and organopolysilazane may be suitably selected or can also be used by mixing according to applications.

Other examples of a polysilazane compound formed into a ceramic at a low temperature include silicon alkoxide addition polysilazane obtained by reacting silicon alkoxide with polysilazane expressed the above described general formula (9) (Japanese Patent Application Laid-Open No. 5-238827), glycidol addition polysilazane obtained by reacting glycidol (Japanese Patent Application Laid-open No. 6-122852), alcohol addition polysilazane obtained by reacting an alcohol (Japanese Patent Application Laid-Open No. 6-240208), metal carboxylic acid salt addition polysilazane obtained by reacting a metal carboxylic acid salt (Japanese Patent Application Laid-Open No. 6-299118), acetyl acetonate complex addition polysilazane obtained by reacting an acetyl acetonate complex containing a metal (Japanese Patent Application Laid-Open No. 6-306329), and metal fine particle addition polysilazane obtained by adding metal fine particles (Japanese Patent Application Laid-Open No. 7-196986).

The organic solvent is not particularly limited as long as it does not contain alcohols and water, which easily react with a polysilazane compound. Specific examples such as hydrocarbon solvents such as aliphatic hydrocarbon, alicyclichydrocarbon, and aromatic hydrocarbon; halogenated hydrocarbon solvents; and ethers such as aliphatic ether and alicyclic ether can be used. Specific examples include hydrocarbons such as pentane, hexane, cyclohexane, toluene, xylene, solvesso, and turpentine; halogenated hydrocarbons such as methylene chloride and trichloroethane; and ethers such as dibutyl ether, dioxane, and tetrahydrofuran. These solvents are selected according to a purpose in consideration of a solubility of polysilazane, an evaporation rate of a solvent, and the like, and a plurality of solvents may be mixed.

A polysilazane concentration in a polysilazane compound-containing coating liquid differs depending on a film thickness of a desired gas barrier layer and a pot life in the coating liquid, and is about 0.2 to 35% by mass with respect to the total mass of the coating liquid.

Amine and a metallic catalyst can also be added to the polysilazane compound-containing coating liquid in order to promote conversion into a silicon oxide compound. Specifically, examples include AQUAMICA NAX120-20, NN110, NN310, NN320, NL110A, NL120A, NL150A, NP110, NP140 and SP140 manufactured by AZ Electronic Materials Co.

Then, at least one layer of the polysilazane compound-containing coating liquid is coated on a sheet substrate.

As a coating method, any appropriate method can be adopted. Specific examples include a spin coat method, a roll coat method, a flow coat method, an inkjet method, a spray coat method, a print method, a dip coat method, a flow cast film forming method, a bar coat method, and a gravure print method.

A coating thickness can be appropriately set according to a purpose. For example, a thickness after drying as the coating thickness can be set preferably from about 1 nm to 100 μm, more preferably from about 10 nm to 10 μm, and the most preferably from about 10 nm to 1 μm.

(2-2) Dehumidification Step

A step of eliminating moisture from a coated film of a polysilazane-containing liquid (dehumidification step) is preferably included before the modification step subsequently after the coating step or during the modification step. By eliminating moisture before the modification treatment or during modification, a dehydration reaction of the polysilazane film converted into silanol can be promoted. Therefore, moisture is eliminated from the polysilazane film is the dehumidification step and the polysilazane film then preferably undergoes a modification treatment with keeping the state.

<Water Content in Polysilazane Film>

A water content in a polysilazane film is defined by a value found by dividing a water content obtained by the following analysis method with the volume of the polysilazane film. The water content in the polysilazane film in the state that moisture is eliminated in the dehumidification step is preferably 0.1% or less, and more preferably 0.01% or less (detection limit or less).

The water content of the polysilazane film can be detected by the analysis method described below

Head space-gas chromatography/mass spectrometry Devices: HP6890GC/HP5973MSD

Oven: 40° C. (2 min), then a temperature is increased to 150° C. by a rate of 10° C./min
Column: DB-624 (0.25 mmid×30 m)

### Inlet: 230° C.

Detector: SIM m/z=18
HS conditions: 190° C.·30 min

The dehumidification step more preferably includes the first dehumidification step of eliminating a solvent in a polysilazane film and the second dehumidification step of eliminating moisture in the polysilazane film followed by the first dehumidification step.

In the first dehumidification step, a dry condition mainly for eliminating a solvent may be appropriately sort by a method such as a heat treatment. However, moisture may also be removed by the condition in this step.

A heat treatment temperature is preferably a high temperature from the viewpoint of quick treatment, and the temperature and the treating time can be set in consideration of thermal damage to a resin substrate. As one example, when a glass transition temperature (Tg) of a sheet substrate (surface-modified cellulose nanofiber) is 70° C., the heat treatment temperature can be set at 200° C. or less.

The treating time is preferably set for a short time so that a solvent is removed and thermal damage to a substrate is lees; for example, when the heat treatment temperature is at 200° C. or leas, the treating time is preferably set within 30 minutes.

The second dehumidification step is a step for eliminating moisture in a polysilazane film.

A preferable method is a mode of maintaining a low humidity environment. A humidity in a low humidity environment varies depending on a temperature, and a preferable mode is thus shown as a relationship between the temperature and the humidity by prescription of a dew point. A preferable dew point is 4° C. or lower (temperature 25° C./humidity 25%), and a more preferable dew point is −8° C. or lower (temperature 25° C./humidity 10%), and a maintained time suitably changes depending on a film thickness of a polysilazane film. For example, in the condition of a polysilazane film thickness of 1 μ or less, a preferable dew point is −8 degree and a maintained timer is 5 minutes or more. Furthermore, drying under reduced pressure may be carried out in order to easily eliminate moisture. A pressure in reduced-pressure drying can be selected from normal pressure to 0.1 MPa.

As a combination of preferable conditions of the first dehumidification step and the second dehumidification step, an example includes a condition in which a solvent is eliminated at a temperature from 60 to 150° C. for a treating time from 1 minute to 30 minutes in the first dehumidification step, and moisture is eliminated at a dew point of 4° C. or lower for a treating time of 5 minutes to 120 minutes in the second dehumidification step. When the first dehumidification step and the second dehumidification step are provided, as for classification of these steps, the steps can be classified at the time point when change of dew points, that is, a gap in dew points in environments of the steps varies at 10° C. or more.

(2-3) Modification Step

A modification treatment in the present invention means a treatment of adding a polysilazane compound that is a precursor material of a gas barrier layer to silicon oxide or silicon nitride oxide by irradiation of active energy rays or a heat treatment.

A known method based on a conversion reaction of a polysilazane compound can be selected as a method of a modification treatment. However, since a conversion reaction of a silazane compound by a heat treatment requires a high temperature at 450° C. or higher, there is a fear that substrate performance may deteriorate due to the modification treatment. From such a viewpoint, a conversion reaction using plasma or ultraviolet ray irradiation, which is capable of a conversion treatment at a lower temperature is preferable in the present invention, and an addition reaction by ultraviolet ray irradiation, in particular, excimer irradiation is more preferable.

(a) Plasma Treatment

A known method can be used as a plasma treatment, and an atmospheric pressure plasma treatment is preferable. In the case of the atmospheric pressure plasma treatment, a nitrogen gas and/or a noble gas (specifically, such as helium, neon, argon, krypton, xenon and radon) is used as a discharge gas. Among these gases, nitrogen, helium and argon are preferably used, and nitrogen is particularly preferable because of a low cost.

<<Atmospheric Pressure Plasma Forming Two or More Electric Fields with Different Frequencies>>

Then, a preferable embodiment for the above described atmospheric pressure plasma is explained. The atmospheric pressure plasma specifically forms two or more electric fields with different frequencies in a discharge space as described in WO No. 2007-026545, and preferably forms electric fields overlapped with the first high-frequency electric field and the second high-frequency electric field.

A frequency ω₂ of the second high-frequency electric field is higher than a frequency ω₁ of the first high-frequency electric field, and the relationship among an intensity V₁ of the first high-frequency electric field, an intensity V₂ of the second high-frequency electric field, and an intensity IV of the discharge initiation electric field satisfies the following mathematical formula (3):

[Mathematical Formula 3]

V₁≧IV>V₂ or V₁>IV≧V₂ Mathematical Formula (3)

and an input density of the second high-frequency electric field is 1 W/cm² or more.

By providing such discharge conditions, even with a discharge gas having a high discharge initiation electric field intensity such as a nitrogen gas, discharge is initiated, a stable plasma state with a high density can be kept, and formation of a thin film having high performance can be carried out.

When a nitrogen gas is used as a discharge gas according to the measurement described above, the discharge initiation electric field intensity IV(½Vp−p) is about 3.7 kV/mm. Thus, a nitrogen gas is excited by applying the first applied electric field intensity set to VI≧3.7 kV/mm in the absent descried relationship and can be formed into a plasma state.

Herein, as the frequency of the first electric power supply, 200 kHz or less is preferably used. The wave shape of this electric field may be a continuous wave or a pulse wave. The lower limit is desirably about 1 kHz.

On the other hand, as the frequency of the second electric power supply, 800 kHz or store is preferably used. The higher the frequency of the second electric power supply is, the higher the plasma density becomes, and a precise and good-quality thin film is obtained. The upper limit is desirably about 200 MHz.

Formation of a high-frequency electric field from such two electric power supplies is necessary for initiation of discharge of a discharge gas having a high discharge initiation electric field intensity by the first high-frequency electric field, and a plasma density increased by a high frequency and a high output density of the second high-frequency electric field and a precise and good-quality thin film can be thus formed.

(b) Ultraviolet Ray Irradiation Treatment

As a method of a modification treatment, a treatment by ultraviolet ray irradiation is also preferable. In the present invention, the “ultraviolet ray” is generally referred to as an electromagnetic wave having a wavelength from 10 to 400 nm, but in the case of an ultraviolet ray irradiation treatment other than a vacuum ultraviolet ray (10 to 200 nm) treatment described later, an ultraviolet ray having a wavelength from 210 to 350 nm is preferably used.

Ozone and an active oxygen atom, which are generated by ultraviolet rays (used synonymously with ultraviolet radiation), have high oxidation ability and can prepare a silicon oxide film or a silicon oxynitride film each hiving high precision and insulating property at a low temperature.

Due to this ultraviolet ray irradiation, a substrate is heated, and O₂ and H₂O which contribute to ceramization (silica conversion), an ultraviolet absorber, and a polysilazane compound itself are excited and activated, ceramization (conversion reaction) of the polysilazane compound is thus promoted and the obtained gas barrier layer becomes more precise. The ultraviolet ray irradiation is effective if it is performed at any time point after formation of a coated film.

As an ultraviolet ray irradiation apparatus, any of usually used ultraviolet ray generation apparatuses can be used.

An irradiation intensity and/or an irradiation time should be set within the range in which a substrate carrying a coated film to be radiated does not receive damage in the ultraviolet ray irradiation. As one example, a distance between a substrate and a lamp is set so that the intensity of the substrate surface is from 20 to 300 mW/cm³, and more preferably from 50 to 200 mW/cm², using a lamp with 2kW (80 W/cm/25 cm), and irradiation can be carried out for 0.1 second to 10 minutes.

In general, when a substrate temperature at the time of an ultraviolet ray irradiation treatment is 150° C. or higher, the e substrate is deformed in the case of a plastic film, and the like, or the intensity deteriorates so that the substrate is damaged. Therefore, the temperature of the substrate at the time of this ultraviolet ray irradiation is preferably lower than 150° C. In addition, an ultraviolet ray irradiation atmosphere is not particularly limited and may be carried out in the air.

As a method of generating such ultraviolet rays, examples include a metal halide lamp, a high-pressure mercury lamp, a low-pressure mercury lamp, a xenon-arc lamp, a carbon-arc lamp, an excimer lamp (single wavelength of 172 nm, 222 nm, 308 nm, for example, manufactured by USHIO INC.), and a UV light laser, but are not particularly limited. When generated ultraviolet rays radiate to a polysilazane coated film, the ultraviolet rays desirably radiate to a coated film after reflecting the ultraviolet rays from the generation source by a reflecting plate, in order to achieve uniform irradiation for improvement in efficiency.

Ultraviolet ray irradiation is applicable to both of a batch treatment and a continuous treatment, and can be suitably selected according to a shape of a substrate to be coated. For example, in the case of a batch treatment, a substrate having a polysilazane coated film in the surface (e.g., silicon wafer) can be treated in an ultraviolet ray calcination furnace provided with an ultraviolet ray generation source as described above. The ultraviolet ray calcination furnace is generally known, and for example, an ultraviolet ray calcination furnace manufactured by EYE GRAPHICS CO., LTD. can be used. In addition, when a substrate having a polysilazane coated film in the surface is in a long film state, the substrate can be formed into a ceramic by continuously irradiating ultraviolet rays in a dry zone provided with the ultraviolet ray generation source as above described while transporting the substrate.

A time needed for ultraviolet ray irradiation depends on a substrate to be coated, a composition of a coated film, and a concentration but is generally from 0.1 second to 10 minutes, and preferably 0.5 second to 3 minutes.

In the present invention, modification is particularly preferably performed by vacuum ultraviolet ray (excimer) irradiation. That is, in a particularly preferable embodiment of the present invention, the step B includes an excimer irradiation treatment after coating a polysilazane compound-containing coating liquid on the above described sheet substrate.

(Excimer Irradiation Treatment)

The excimer light is laser light using noble ours excimer or heteroexcimer as an operation medium. Noble gas atoms such as Xe, Kr, Ar and Ne are excited by obtaining energy from discharge, or the like, and bound to other atoms to be able to form molecules. For example, when a noble gas is xenon,

e+Xe→e+Xe⁺

Xe⁺+Xe+Xe→Xe₂⁺+Xe [Chemical Formula 19]

Xe₂⁺ that is an excited excimer molecule emits 172 nm-excimer light when it is transferred to ground state,

The treatment by irradiation of vacuum ultraviolet rays (excimer) is a method in which, using a light energy of 100 to 200 nm (preferably 100 to 180 nm) which is greater than the atomic bonding force in the polysilazane compound, an atomic bonding is directly broken only by an action of photon called as a photon process and an oxidation reaction by active oxygen or ozone is allowed to proceed, thereby, formation of a silicon oxide film can be achieved at a relatively low temperature.

As a vacuum ultraviolet light source necessary for excimer irradiation, a noble gas excimer lamp is preferably used. An example of characteristics of an excimer lamp includes having high efficiency because emission concentrates on one wavelength and light other than necessary light is scarcely irradiated. In addition, since extra light is not irradiated, a temperature of an object to be irradiated can be kept high. Further, because a time is not requested for start and restart, instantaneous lighting and blinking are possible. Therefore, a noble gas excimer lamp is appropriate for a flexible film material that is supposed to be susceptible to heat affection.

An Xe excimer lamp excellent in an emission efficiency is more preferable since ultraviolet rays with a short wavelengths of 172 nm are irradiated with a single wavelength. This light has a large absorption coefficient of oxygen, and therefore, radical oxygen atom species and ozone can be generated at a high concentration with a very small amount of oxygen. In addition, light energy with a short wavelength at 172 nm, which dissociates a bond of an organic material, has been known for having high ability. Modification of a polysilazane film can be achieved within a short time due to high energy that this active oxygen and ozone, and ultraviolet ray irradiation have. Therefore, the xe excimer lamp makes it possible to irradiate to an organic material or a plastic substrate, which is susceptible to damages due to reduction of a process time and reduction of a facility area accompanied by high throughput and heat, as compared to a low pressure mercury lamp emitting a wavelength of 185 nm or 254 nm and plasma washing.

A kind of an excimer lamp is not particularly limited, and a double tube type lamp and a tabular type excimer lamp can be used. The double tube type lamp is easily damaged in its handling and transportation as compared to the tubular type lamp. The tubular, type excimer lamp has a simple structure and can provide a very inexpensive light source, however, wiser; an cancer diameter of a tabular type lamp is too thick, a high voltage is needed for start-up.

A discharge mode may be dielectric material barrier discharge or electrodeless electric field discharge. The dielectric material barrier discharge is discharge called very thin micro discharge similar to lightning, which is generated in a gas space by setting the gas space through a dielectric material (quartz in the case of an excimer lamp) between both electrodes and applying a high-frequency high voltage of several 10 kHz to the electrodes. On the other hand, the electrodeless electric field discharge is also called by another name, PF discharge, a lamp and electrodes and the placement may be basically the same as the dielectric material barrier discharge, but a high frequency applied between the both electrodes is lighted at several MHz. Uniform discharge can be obtained in terms of space and time by the electrodeless electric field discharge and a long-life lamp without flickering can be therefore obtained as compared to the dielectric material barrier discharge.

As a shape of an electrode, the surface contacting with a lamp may be a flat surface, but when the shape is conformed to the curved surface of the lamp, the lamp can be firmly fixed and, at the same time, the electrode is closely attached to the lamp and discharge is therefore more stable. In addition, when the curved surface is a mirror surface by aluminum, it also becomes a light reflecting plate.

In addition, when an intermediate layer is placed between a sheet substrate and a gas barrier layer, the intermediate layer may be formed on the sheet substrate after film formation of the sheet substrate and the gas barrier layer may be forward on the intermediate layer. A method of forming an intermediate layer is not particularly limited, and the method described in Patent Literature 5 can be referred or the method can be e appropriately modified and applied.

[Substrate for Electronic Element]

The above descried gas barrier film is excellent in transparency, surface smoothness, gas barrier property and adhesivity and can be therefore used for a transparent substrate for an electronic element (a substrate for an electronic element). In particular, the gas barrier film can be applied to substrates for liquid crystal and an organic element, and as the organic element, an organic electroluminescence element, an organic photoelectric conversion element, and the like are included.

When the gas barrier film of the present invention is used as a transparent substrate for an electronic element, a transparent conductive film and a hard coat layer can be set on the gas barrier film, if necessary.

(Transparent Conductive Film)

A transparent conductive film that can be used in the substrate for an electronic element of the present invention is not particularly limited, and can be selected according to an element structure. For example, in the case of being used as a transparent electrode, it is preferably an electrode transmitting a light with 380 to 800 nm. Examples of a material including transparent conductive metallic oxides such as indium tin oxide (ITO), SnO₂ and ZnO; metallic thin films of gold, silver, platinum, and the like; metallic nanowire, and carbon nanotube can be used. In addition, conductive polymers selected from the group consisting of various derivatives such as polypyrrole, polyaniline, polythiophene, polythienylenevinylene, polyazulene, polyisothianaphthene, polycarbazole, polyacetylene, polyphenylene, polyphenylenevinylene, polyacene, polyphenylacetylene, polydiacetylene and polynaphthalene can also be used. A plurality of these conductive compounds can also be used in combination.

(Hard Coat Layer)

A hard coat layer that can be used in the substrate for an electronic element of the present invention is not particularly limited, and can be selected according to an element structure. By setting a hard coat layer, hardness, smoothness, transparency and heat resistance can be imparted to a substrate.

An applicable hard coat resin is not particularly limited as long as it forms a transparent resin composition by curing, and examples thereof include a silicon resin, an epoxy resin, a vinyl ester resin, an acrylic resin, an aryl ester-based resin. An acrylic resin can be particularly preferably used from the viewpoint. Both of light and heat can be used for a curing method, but curing by light, in particular, UV light is preferable from the viewpoint of productivity.

### EXAMPLES

Hereinbelow, the present invention is described specifically by referring to examples, however, the present invention is not limited to them.

In the Examples, the term “5” or “parts” is used. Unless particularly mentioned, this represents “parts by weight” or “% by weight”.

In examples, a substitution degree was calculated according to the method prescribed in ASTM-D817-96, and a degree or crystallinity was calculated from a diffraction peak intensity measured by an X-ray diffraction method using the apparatus described below.

X ray generation apparatus: RINT TTR2 manufactured by Rigaku Corporation

X ray source: CuKα
Output: 50 kV/300 mA
1^{st} slit: 0.04 mm
2^{nd} slit: 0.03 mm
Light acceptance slit: 0.01 mm
<Digital recording apparatus>
2θ/θ: continuous scan
Measurement range: 2θ=2 to 45°

### Sampling: 0.02°

Integrated time: 1.2 seconds

[Preparation of Cellulose Nanofibers]

### Production Example 1

### Cellulose Nanofiber A

A sulfurous acid bleached pulp (cellulose fiber) obtained from a coniferous tree was added with pure water so as to have an content of 0.1% by mass and grinding treatments (rotational number: 1500 rotations/min) were carried out 50 times using a stone mill (Pure Fine Mill KMG1-10; manufactured by KURITA MACHINERY MFG. CO., LTD.) to fiberillate a cellulose fiber. This water dispersion is filtered and then washed with pure water and dried at 70° C. to thus obtain a cellulose nanofiber A.

From observation by a scanning electron microscope (SEM), the obtained cellulose nanofiber A was fiberillated to have an average fiber diameter of 32 nm and confirmed to be formed into microfibril.

### Production Example 2

### Cellulose Nanofiber B

The cellulose nanofiber A obtained in Production Example 1 described above in an amount of 10 parts by mass was added to 500 parts by mass of a propionic anhydride/pyridine (molar ratio of 1/1) solution to be dispersed and stirred at room temperature for 1 hour. Subsequently, the dispersed cellulose nanofiber was filtered and washed three times with 500 parts by mass of water, and then washed twice with 200 parts by mass of ethanol. Furthermore, the cellulose fiber was washed twice with 500 parts by mass of water and then dried at 70° C. to thus obtain a cellulose nanofiber B in which hydrogen atoms in a hydroxyl group in the cellulose fiber were substituted with propanoyl groups.

It was confirmed from observation by a scanning electron microscope (SEM) that the average fiber diameter was kept to be 32 nm in the obtained cellulose nanofiber B.

The substitution degree of a propanoyl group was 0.5 and the degree of crystallinity was 89%.

### Production Example 3

### Cellulose Nanofiber C

A cellulose nanofiber C in which hydrogen atoms in a hydroxyl group in the cellulose fiber were substituted with propanoyl groups was obtained in the same manner as in Production Example 2 except for changing a stirring time of a solution obtained by dispersing the cellulose nanofiber A into a propionic anhydride/pyridine (molar ratio of 1/1) solution to 6 hours.

It was confirmed from observation by a scanning electron microscope (SEM) that the average fiber diameter was kept to be 32 nm in the obtained cellulose nanofiber C.

The substitution degree of propanoyl groups was 2.0 and the degree of crystallinity was 56%.

### Production Example 4

### Cellulose Nanofiber D

The cellulose nanofiber A in a dry mass corresponding to 1 g, 0.0125 g of TEMPO (2,2,6,6-tetramethylpiperidine-N-oxyl) and 0.125 g of sodium bromide were dispersed into 100 m. of water and 13% by mass of an aqueous sodium hypochlorite solution (an amount containing an amount of sodium hypochlorite of 2.5 mmol) was added thereto to initiate a reaction. A 0.5 M-aqueous sodium hydroxide solution was dropped during the reaction and the pH was kept to be 10.5. The time point when pH change was not observed was regarded as completion of the reaction. The reaction product was filtered through a glass filter and washing with sufficient water, and filtration were then repeated 5 times, and the reaction product was further treated with an ultrasonic dispersing apparatus for 1 hour. The reaction precinct was dried at 70° C. to thus obtain a cellulose nanofiber D.

As a result of observation of a scanning electron microscope (SEM), the average fiber diameter of the cellulose nanofiber D was 4 nm.

### Production Example 5

### Cellulose Nanofiber E

A cellulose nanofiber E in which hydrogen atoms in a hydroxyl group in the cellulose fiber were substituted with propanoyl groups was obtained in the same manner as in Production Example 2 except for changing the cellulose nanofiber A into the cellulose nanofiber D.

It was confirmed from observation by a scanning electron microscope (SEM) that the average fiber diameter was kept to be 4 nm in the obtained cellulose nanofiber E.

The substitution degree of propanoyl groups was 0.6. The degree of crystallinity was 88%.

### Production Example 6

### Cellulose Nanofiber F

A cellulose nanofiber F in which hydrogen atoms in a hydroxyl group in the cellulose fiber were substituted with propanoyl groups was obtained in the same manner as in Production Example 3 except for changing the cellulose nanofiber A into the cellulose nanofiber D.

It was confirmed from observation by a scanning electron microscope (SEM) that the overage fiber diameter was kept to be 4 nm in the obtained cellulose nanofiber F.

The substitution degree of propanoyl groups was 2.2, and the degree of crystallinity was 52%

### Production Example 7

### Cellulose Nanofiber G

A cellulose nanofiber G in which hydrogen atoms in a hydroxyl group in the cellulose fiber were substituted with acetyl groups was obtained in the scene manner as in Production Example 2 except for changing propionic anhydride into acetic anhydride.

It was confirmed from observation by a scanning electron microscope (SEM) that the average fiber diameter was kept to be 32 nm in the obtained cellulose nanofiber G.

The substitution degree of acetyl groups was 1.0, and the degree of crystallinity was 82%

### Production Example 8

### Cellulose Nanofiber H

A cellulose nanofiber H in which hydrogen atoms in a hydroxyl group in the cellulose fiber were substituted with butanoyl groups was obtained in the same manner as in Production Example 2 except for changing propionic anhydride into butanoic anhydride.

If was confirmed from observation by a scanning electron microscope (SEM) that the average fiber diameter was kept to be 32 nm in the obtained cellulose nanofiber H.

The substitution degree of butanoyl groups was 0.9, and the degree of crystallinity was 84%

As for the cellulose nanofibers A, B, C, D, E, F, G and H prepared in the above described Production Examples 1 to 8, production methods, substitution degrees, degrees of crystallinity and average fiber diameters are shown an Table 1.

TABLE 1

| | Cellulose | Fibrillation | | Substitution | Substitution | Degree of | Average fiber |
|---|---|---|---|---|---|---|---|
| | nanofiber | method | Substituent | degree | method | crystallinity (%) | diameter (nm) |
| Production Example 1 | A | Grinder | None | 0.0 | — | 100 | 32 |
| Production Example 2 | B | Grinder | Propanoyl group | 0.5 | Propionic anhydride | 83 | 32 |
| Production Example 3 | C | Grinder | Propanoyl group | 2.0 | Propionic anhydride | 56 | 32 |
| Production Example 4 | D | TEMPO | None | 0.0 | — | 100 | 4 |
| Production Example 5 | E | TEMPO | Propanoyl group | 0.6 | Propionic anhydride | 88 | 4 |
| Production Example 6 | F | TEMPO | Propanoyl group | 2.2 | Propionic anhydride | 52 | 4 |
| Production Example 7 | G | Grinder | Acetyl group | 1.0 | Acetic anhydride | 82 | 32 |
| Production Example 8 | H | Grinder | Butanoyl group | 0.9 | Butanoic anhydride | 84 | 32 |

[Preparation of Film Substrates]

### (Melt Film Formation Method)

### Film Formation Example 1

### Film Substrate 1

1. Melt Extrusion

100 parts by mass of the cellulose nanofiber A obtained in Production Example 1 described above was dried at a hot air temperature of 150° C. and a dew point or −36° C. by a dehumidifying hot air dryer manufactured by MATSUI MFG. CO., LTD. and then mixed with 8 parts by mass of a plasticizer P-1, 1 part by mass of an antioxidant A-1, and 0.5 part by mass of an antioxidant A-2 by a V-type tumbler for 30 minutes. Note that the following materials were used as the plasticizer P-1 and the antioxidants A-1 and A-2.

Plasticizer P-1: Trimethylolpropane Tribenzoate

Primary antioxidant A-1: IRGANOX-1010 (manufactured by BASF JAPAN LTD.)

Secondary antioxidant A-2: Sumilizer GP (Sumitomo Chemical Company, Limited.)

Then, the mixture was supplied by a twin screw extruder (manufactured by TECHNOVEL CORPORATION) at 120 kg/hr. The number of kneading discs was less in the screw design to suppress kneading heat generation. A temperature of a barrel was set from 200° C. to 250° C., and a bent was provided near the tip to remove a volatile portion. A filter, a gear pump and a filter were placed in the downstream of the extruder, the mixture was extruded from a coat hanger-type T-die and dropped between two chromium plating mirror surface rolls that were adjusted at a temperature of 120° C. and taken up to pass through three rolls and the edge was slit, thereafter rolling up the film with a winder. A retention time of the cellulose nanofiber composition in the extruder was 1 minute 30 minutes. The extrusion amount and the rotational speed of the take-up rolls were adjusted so as to have the thickness of the rolled film of 125 μm.
2. Calendering Treatment

A calendering treatment was performed on the obtained film using a roll press apparatus manufactured by YURI ROLL CO. LTD. In the calendering treatment, metallic rolls were used for both of the upper part and the bottom part, the roll temperature was set at 200° C. and the treatment was carried out at a running speed of 2 m/min with a linear load of 0.5 ton.
3. Stretch Treatment

Subsequently, the film obtained by the calendering treatment was preheated and then stretched in the film transport direction (longitudinally stretched) by a roll speed gap, thereafter leading into a tenter type stretching machine, the film was stretched in the direction perpendicular to the film transport direction (thickness-wise stretched). A stretching ratio was set to 1.5 times for longitudinal stretching and 1.5 times for thickness-wise stretching.

The film substrate 1 was obtained according to the above described steps.

### Film Formation Examples 2 to 7

### Film Substrates 2 to 7

Film substrates 2 to 7 were obtained in the same manner as in Film Formation Example 1 except for changing the cellulose nanofiber A into the cellulose nanofiber D, G, H, B, C or E.

### Film Formation Example 8

### Film Substrate 8

A film substrate 8 was obtained in the same manner as in Film Formation Example 1 except for changing the cellulose nanofiber A into a mixture of the cellulose nanofiber E and the cellulose nanofiber F (mass ratio of E:F=70:30).

### Film Formation Example 9

### Film Substrate 9

A polymer molten from a die was extruded in a simultaneous extrusion method using a feed block to obtain a film substrate. That is, cellulose nanofibers were laminated to form a lamination of cellulose nanofiber C/cellulose nanofiber B/cellulose nanofiber C and developed into a die as the same total solution sending amount as in Film Formation Examples 1 to 8 at a flow ratio corresponding to a mass ratio of each layer and extruded, thereby preparing the film substrate cellulose made of nanofibers C/B/C, which has a three-layered structure constituted with the cellulose nanofiber C, the cellulose nanofiber B, and the cellulose nanofiber C from the lower layer to the top layer (mass ratio of respective layers=15:70:15).

A film substrate 9 was obtained in the same manner as in Film Formation Example 1 except for changing the cellulose nanofiber A into the above described cellulose nanofiber C/B/C.

### Film Formation Example 10

### Film Substrate 10

95 parts by mass of the cellulose nanofiber A was dried at a hot air temperature of 150° C. and a dew point of −36° C. by a dehumidifying hot air dryer manufactured by MATSUI MFG. CO., LTD. and mixed with 5 parts by mass of cellulose acetate propionate (CAP) (acetyl group substitution degree=1.5, propionyl group substitution degree 1.5, number average molecular weight Mn=70,000, weight average molecular weight Mw=220,000, Mw/Mn=3) as a matrix resin, 8 parts by mass of the plasticizer P-1, 1 part by mass of the antioxidant A-1 and 0.5 part by mass of the antioxidant A-2 by a V-type tumbler for 30 minutes. Note that the plasticizer P-1 and the antioxidants A-1 and A-2 were the same as used in Comparative Example 1 described above.

A film substrate 10 was obtained in the same manner as in Film Formation Example 1 except for carrying out melt extrusion, a calendering treatment and a stretch treatment using the above described mixture.

### Film Formation Example 11

### Film Substrate 11

A film substrate 11 was obtained in flue same manner as in Film Formation Example 10 except for mixing 90 parts by mass of the cellulose nanofiber A, 10 parts by mass of cellulose acetate propionate (CAP) as a matrix resin, 8 parts by mass of the plasticizer P-1, 1 part by mass of the antioxidant A-1 and 0.5 part by mass of the antioxidant A-2.

### Film Formation Example 12

### Film Substrate 12

A film substrate 12 was obtained in the same manner as in Film Formation Example 10 except for mixing 85 parts by mass or the cellulose nanofiber A, 15 parts by mass of cellulose acetate propionate (CAP) as a matrix resin, 8 parts by mass of the plasticizer P-1, 1 part by mass of the antioxidant A-1 and 0.5 part by mass of the antioxidant A-2.

### Film Formation Example 13

### Film Substrate 13

A film substrate 13 was obtained an the same manner as in film Formation Example 10 except for mixing 95 parts by mass of the cellulose nanofiber C, 5 parts by mass of cellulose acetate propionate (CAP) as a matrix resin, 8 parts by mass of the plasticizer P-1, 1 part by mass of the antioxidant A-1 and 0.5 part by mass of the antioxidant A-2.

### Film Formation Example 14

### Film Substrate 14

A film substrate 14 was obtained in the same manner as in Film Formation Example 10 except for mixing 90 parts by mass of the cellulose nanofiber C, 10 parts by mass of cellulose acetate propionate (CAP) as a matrix resin, 8 parts by mass of the plasticizer P-1, 1 part by mass of the antioxidant A-1 and 0.5 part by mass of the antioxidant A-2.

### Film Formation Example 15

### Film Substrate 15

A film substrate 15 was obtained in the same manner as in Film Formation Example 10 except for mixing 85 parts by mass of the cellulose nanofiber C, 15 parts by mass of cellulose acetate propionate (CAP) as a matrix resin, 8 parts by mass of the plasticizer P-1, 1 part by mass of the antioxidant A-1 and 0.5 part by mass of the antioxidant A-2.

(Solution Cast Film Formation Method)

### Film Formation Example 16

### Film Substrate 16

1. Solution Cast

An ethanol solution of the cellulose nanofiber A (solid content of 10% by mass) was charged into a closed container with stirring and mixed with heating and stirring for 30 minutes to prepare a doped liquid.

Subsequently, 840 parts by mass of the doped liquid was added with 10 parts by mass of triphenyl phosphate as a plasticizer, 5 parts by mass of ethyl phthalyl ethyl glycolate as a plasticizer, 140 parts by mass of methylene chloride as a good solvent, and 5 parts by mass of a crosslinking agent E-5, completely mixed at 70° C., cooled to a temperature for flow casting and stood still for one night, and defoaming operation was performed and the doped solution was then filtered using AZUMI filter paper No. 244 manufactured by AZUMI FILTER PAPER CO., LTD. to thus obtain a dope A.

The dope A prepared as described above (temperature: 35° C.) was uniformly flow cast on a stainless belt support at 30° C. using a belt flow-cast apparatus. Then, the dope A was dried to a range capable of peeling and then peeled off from the stainless belt support. The residual solvent amount in the web in this step was 80% by mass.

The web obtained above was dried with roll transporting a dry zone at 85° C. to obtain a film (film thickness: 125 μm). The residual solvent amount at the time of rolling up was less than 0.1% by mass.
2. Stretch Treatment

The obtained film was stretched in the film transport direction (longitudinally stretched) by a roll speed gap after preheating when the residual solvent amount became less than 35% by mass, then lead to a tenter type stretching machine to stretch the film to the direction perpendicular to the film transport direction (thickness-wise stretched). Stretching ratios were 1.5 times for longitudinal stretching and 1.5 times for thickness-wise stretching.
3. Calendering Treatment

A calendering treatment was performed on the obtained film using a roll press device manufactured by YURI POLL CO., LTD. The calendering treatment was carried out by using metallic rolls in both of the upper part and the bottom part and setting at 200° C. as a roll temperature and 2 m/minutes of a running a speed with a linear load of 5.5 ton.

A film substrate 16 was obtained by the above described stops.

### Film Formation Examples 17 to 22

### Film Substrates 17 to 22

Film substrates 17 to 22 were obtained in brut same manner as in Film Formation Example 16 except for changing the cellulose nanofiber a into the cellulose nanofiber D, G, H, B, C or E.

### Film Formation Example 23

### Film Substrate 23

A film substrate 23 was obtained in the same manner as in Film Formation Example 16 except for changing the cellulose nanofiber A into a mixture of the cellulose nanofiber E and the cellulose nanofiber F (mass ratio of E:F=70:30).

### Film Formation Example 24

### Film Substrate 24

A film substrate 24 made of the cellulose nanofibers C/B/C, which has a three-layered structure constituted with the cellulose nanofiber C, the cellulose nanofiber B and the cellulose nanofiber C from the bottom layer to the top layer (mass ratio of respective layers=13:70:15) was prepared by division cast by sending a solution from three supply lines as the same total solution sending amount as in Film Formation Examples 16 to 23 at a flow amount ratio corresponding to the mass ratio of respective layers. In addition, division cast was carried out by placing a die coaters at three points on the metallic support and forming a film so as to have the composition of the layer structure and the film thickness ratio in Table 2. Note that conditions for film formation other than the above description were the same as in Film Formation Example 16.

### Film Formation Example 25

### Film Substrate 25

A film substrate 25 was obtained in the same manner as in Film Formation Example 16 except for using an ethanol solution (solid content of 10% by mass) of 95 parts by mass of the cellulose nanofiber A and 5 parts by mass of cellulose acetate propionate (CAP) (acetyl group substitution degree=1.5, propionyl group substitution degree of 1.2, number average molecular weight Mn=70,000, weight average molecular weight Mw=220,000, Mw/Mn=3) as a matrix resin in place of an ethanol solution of the cellulose nanofiber A (solid content of 10% by mass).

### Film Formation Example 26

### Film Substrate 26

A film substrate 26 was obtained in the same manner as in Film Formation Example 26 except for using an ethanol solution (solid content of 10% by mass) of 90 parts by mass of the cellulose nanofiber A and 10 parts by mass of cellulose acetate propionate (CAP) (acetyl group substitution degree=1.5, propionyl group substitution degree of 1.2, number average molecular weight Mn=70,000, weight average molecular weight Mw=220,000, Mw/Mn=3) as a resin in place of an ethanol solution of the cellulose nanofiber A (solid content of 10% by mass).

### Film Formation Example 27

### Film Substrate 27

A film substrate 27 was obtained in the same manner as in Film Formation Example 16 except for using an ethanol solution (solid content of 10% by mass) of 80 parts by mass of the cellulose nanofiber A and 20 parts by mass of cellulose acetate propionate (CAP) (acetyl group substitution degree=1.5, propionyl group substitution degree of 1.2, number average molecular weight Mn=70,000, weight average molecular weight Mw=220,000, Mw/Mn=3) as a matrix resin in place of an ethanol solution of the cellulose nanofiber A (solid content of 10% by mass).

### Film Formation Example 28

### Film Substrate 28

A film substrate 28 was obtained in the same manner as in Film Formation Example 16 except for using an ethanol solution (solid content of 10% by mass) of 95 parts by mass of the cellulose nanofiber C and 5 parts by mass of cellulose acetate propionate (CAP) (acetyl group substitution degree=1.5, propionyl group substitution degree of 1.2, number average molecular weight Mn=70,000, weight average molecular weight Mw=220,000, Mw/Mn=3) as a matrix resin in place of an ethanol solution of the cellulose nanofiber A (solid content of 10% by mass).

### Film Formation Example 29

### Film Substrate 29

A film substrate 29 was obtained in the same manner as in Film Formation Example 16 except for using an ethanol solution (solid content of 10% by mass) of 90 parts by mass of the cellulose nanofiber C and 10 parts by mass of cellulose acetate propionate (CAP) (acetyl group substitution degree=1.5, propionyl group substitution degree of 1.2, number average molecular weight Mn=70,000, weight average molecular weight Mw=220,000, Mw/Mn=3) as a matrix resin in place of an ethanol solution of the cellulose nanofiber A (solid content at 10% by mass).

### Film Formation Example 30

### Film Substrate 30

A film substrate 30 was obtained in the same manner as in Film Formation Example 16 except for using an ethanol solution (solid content of 10% by mass) of 85 parts by mass of the cellulose nanofiber C and 15 parts by mass of cellulose acetate propionate (CAP) (acetyl group substitution degree =1.5, propionyl group substitution degree or 1.2, number average molecular weight Mn=70,000, weight average molecular weight Mw=220,000, Mw/Mn=3) as a matrix resin in place of an ethanol solution of the cellulose nanofiber A (solid content of 10% by mass).

The structures and the production methods of the film substrates 1 to 30 prepared in Film Formation Examples 1 to 30 described above are shown in Table 2.

TABLE 2

| | Film structure | | | |
|---|---|---|---|---|
| Film | | | | Film |
| substrate | | Celluose nanofiber | | formation |
| No. | Matrix resin | Type | Ratio | method |
| 1 | — | A | 100 | Melting |
| 2 | — | D | 100 | Melting |
| 3 | — | G | 100 | Melting |
| 4 | — | H | 100 | Melting |
| 5 | — | B | 100 | Melting |
| 6 | — | C | 100 | Melting |
| 7 | — | E | 100 | Melting |
| 8 | — | E + F | 70/30 | Melting |
| 9 | — | C/B/C¹⁾ | 15/70/15 | Melting |
| 10 | CAP | A | 5/95²⁾ | Melting |
| 11 | CAP | A | 10/90²⁾ | Melting |
| 12 | CAP | A | 15/85²⁾ | Melting |
| 13 | CAP | C | 5/95²⁾ | Melting |
| 14 | CAP | C | 10/90²⁾ | Melting |
| 15 | CAP | C | 15/85²⁾ | Melting |
| 16 | — | A | 100 | Melt casting |
| 17 | — | D | 100 | Melt casting |
| 18 | — | G | 100 | Melt casting |
| 19 | — | H | 100 | Melt casting |
| 20 | — | B | 100 | Melt casting |
| 21 | — | C | 100 | Melt casting |
| 22 | — | E | 100 | Melt casting |
| 23 | — | E + F | 70/30 | Melt casting |
| 24 | — | C/B/C¹⁾ | 15/70/15 | Melt casting |
| 25 | CAP | A | 5/95²⁾ | Melt casting |
| 26 | CAP | A | 10/90²⁾ | Melt casting |
| 27 | CAP | A | 15/85²⁾ | Melt casting |
| 28 | CAP | C | 5/95²⁾ | Melt casting |
| 29 | CAP | C | 10/90²⁾ | Melt casting |
| 30 | CAP | C | 15/85²⁾ | Melt casting |

¹⁾C/B/C: has three-layered structure constituted with the cellulose nanofiber C, the cellulose nanofiber B and the cellulose nanofiber C from the center to the outside.
²⁾shows a content ratio (mass ratio) of CAP and the cellulose nanofiber A or C.

(Preparation of Gas Barrier Film)

### (Formation of Intermediate Layer)

While each of the film substrates 1 to 30 was transported at a speed of 30 m/minutes, an intermediate layer 1 was formed on the surface side and an intermediate layer 2 was formed on the back side by the following forming method to thus obtain each of film laminated materials 1 to 30.

(Intermediate Layer 1)

A UV curable organic/inorganic hybrid hard coat material, OPSTAR Z7535, manufactured by JSR CORPORATION was coated on one surface of a film substrate by a wire bar to have an average film thickness after drying of 4 μm. Then, the film substrate was dried under the dry condition (80° C. 3 minutes), thereafter curing by use of a high pressure mercury lamp in the air atmosphere under the curing condition of 1.0 J/cm² to thus form an intermediate layer 1.

(Intermediate Layer 2)

A UV curable organic/inorganic hybrid hard coat material. OPSTAR Z7501, manufactured by JSR CORPORATION was coated on the opposite surface of the film substrate by a wire bar to have an average film thickness after drying of 4 μm. Then, the film substrate was dried under the dry condition (80° C. 3 minutes), thereafter curing by use of a high pressure mercury lamp in the air atmosphere under the curing condition of 1.0 J/cm² to thus form an intermediate layer 2.

The maximum cross sectional height Rt(p) of the intermediate layer 2 was 8 nm.

(Formation of Gas Barrier Layer)

A. Melt Extrusion Film

### (Excimer Irradiation to Polysilazane Film)

### Comparative Example 1

### Gas Barrier Film 1

1. Coating Step

A dibutyl ether solution containing 20% by mass of perhydropolysilazane (PHPS; AQUAMICA NN320, manufactured by AZ Electronic Materials Co.) was prepared as a polysilazane-containing coating liquid.

The polysilazane-containing coating liquid was coated on both sides of the film laminated material 1 provided with the intermediate layer 1 and the intermediate layer 2 by a wireless bar to have an average film thickness after drying of 0.30 μm.

2. Dehumidification Step

The obtained coated film was dried for 1 minutes under atmosphere at a temperature of 85° C. and a humidity of 55% RH (dew point: 70° C.) to obtain a dried sample (the first dehumidification step).

The above described dried sample was maintained for 10 minutes under atmosphere at a temperature of 25° C. and a humidity of 10% RH (dew point: −8° C.) to carry out a dehumidification treatment (the second dehumidification step).

3. Modification Step

The sample on which the dehumidification treatment was carried out was fixed onto the operational stage of the modification treatment apparatus described below and a modification treatment was carried out in the following conditions to thus obtain a gas barrier film 1. The dew point during the modification treatment was −8° C.

(Modification Treatment Apparatus)

Excimer irradiation apparatus MODEL: MECL-M-1-200, manufactured by M. D. COM. Inc., wavelength: 172 nm, lamp filler gas: Xe

### (Conditions of Modification Treatment)

Excimer light intensity: 130 mW/cm² (172 nm)
Distance between sample and light source: 1 mm
Stage heating temperature: 70° C.
Oxygen concentration in irradiation apparatus: 1%
Excimer irradiation time: 3 seconds.

### Comparative Example 2, Examples 1 to 7, Comparative Examples 3 to 5, Examples 8 and 9, Comparative Example 6

### Gas Barrier Films 2 to 15

Gas barrier films 5 to 15 were obtained as the same manner as in Comparative Example 1 except for changing the film laminated material 1 provided with the intermediate layer 1 and the intermediate layer 2 into the film laminated materials 2 to 15 each provided with the intermediate layer 1 and the intermediate layer 2.

### Comparative Example 7, Example 10

### Gas Barrier Films 16 and 17

Gas barrier films 16 and 17 were obtained in the same manner as in Comparative Example 1 except for changing the film laminated material 1 provided with the intermediate layer 1 and the intermediate layer 2 into the film substrate 1 or the film substrate 6, which is not provided with the intermediate layer 1 and the intermediate layer 2.

### Comparative Example 8

### Gas Barrier Film 18

A gas barrier film 18 was obtained in the same manner as in Comparative Example 1 except for changing an excimer light intensity of 130 mw/cm² (172 nm) that is a modification treatment condition in the modification step into 180 mW/cm² (172 nm).

### Example 11

### Gas Barrier Film 19

A gas carrier film 19 was obtained in tee same assessor in comparative Example 8 except for changing the film laminated material 1 provided vita the intermediate lever 1 the intermediate layer 2 into the film laminated material 6 provided with the intermediate layer 1 and the intermediate layer 2.

### Comparative Example 9

### Gas Barrier Film 20

A gas barrier film 20 was obtained in the same manner as in Comparative Example 1 except for changing an excimer light intensity of 130 mW/cm² (172 nm) that is a modification treatment condition in the modification step into 80 mW/cm² (172 nm).

### Example 12

### Gas Barrier Film 21

A gas barrier film 21 was obtained in the same manner as in Comparative Example 9 except for changing the film laminated material 1 provided with the intermediate layer 1 and the intermediate layer 2 into the film laminated material 6 provided with the intermediate layer 1 and the intermediate layer 2.

### Comparative Example 10, Example 13

### Gas Barrier Films 22 end 23

Gas barrier films 22 and 23 were obtained in the same manner as in Comparative Example 9 except for changing the film laminated material 1 provided with the intermediate layer 1 and the intermediate layer 2 into the film laminated material 1 or the film laminated material 6, which is not provided with the intermediate layer 1 and the intermediate layer 2.

(Plasma Spatter of SiOₓ)

### Comparative Example 11

### Gas Barrier Film 24

A gas barrier layer made of SiOₓ (x=1.8, by XPS) having a film thickness of 70 nm was formed on both surfaces of the film substrate 1 which is not provided with the intermediate layer 1 and the intermediate layer 2, by reactive spatter introduced with an argon gas and an oxygen gas as process gases at a film formation temperature of 180° C. using Si as a target by DC magnetron spatter by use of a plasma generation spatter roll coat apparatus to thus obtain a gas barrier film 24. During the film formation, the film thickness of the gas barrier layer was adjusted according to a reaction time.

### Example 14

### Gas Barrier Film 25

A gas barrier film 25 was obtained in the same manner as in Comparative Example 11 except for changing the film substitute 1 which is not provided with the intermediate layer 1 and the intermediate layer 2 into the film substitute 6 which is not provided with the intermediate layer 1 and the intermediate layer 2.

B. Melt Cast Film

(Excimer Irradiation to Polysilazane Film)

### Comparative Example 11

### Gas Barrier Film 20

1. Coating Step

A dibutyl ether solution containing 20% by mass of perhydropolysilazane (PHPS; AQUAMICA NN320, manufactured by AZ Electronic Materials Co.) was prepared as a polysilazane-containing coating liquid.

The polysilazane-containing coating liquid was coated on both sides of the film laminated material 16 provided with the intermediate layer 1 and the intermediate layer 2 by a wireless bar to have an average film thickness after drying of 0.30 μm.

2. Dry Step

The obtained coated film was dried for 1 minute under atmosphere at a temperature of 85° C. and a humidity of 55% RH to obtain a dried sample.

3. Dehumidification Step

The above described dried sample was maintained for 10 minutes under atmosphere at a temperature of 25° C. and a humidity of 10% RH (dew point: −8° C.) to carry out a dehumidification treatment.

4. Modification Step

The sample on which the dehumidification treatment was carried out was fixed onto the operational stage of the modification treatment apparatus described below and a modification treatment was carried out in the following conditions to thus obtain a gas barrier film 26. The dew point during the modification treatment was −8° C.

(Modification Treat Stent Apparatus)

Excimer irradiation apparatus MODEL: MECL-M-1-200, manufactured by M. D. COM. Inc., wavelength: 172 nm, lamp filler gas: Xe

### (Conditions of Modification Treatment)

Excimer light intensity: 130 mW/cm² (172 nm)
Distance between sample and light source: 1 mm
Stage heating temperature: 70° C.
Oxygen concentration in irradiation apparatus: 1%
Excimer irradiation time: 3 seconds.

### Comparative Example 13, Examples 15 to 21, Comparative Examples 14 to 16, Examples 22 and 23, Comparative Example 17

### Gas Barrier Films 27 to 40

Gas barrier films 27 to 40 were obtained in the same manner as in Comparative Example 12 except for changing the film laminated material 16 provided with the intermediate layer 1 and the intermediate layer 2 into the film laminated materials 17 to 30 each provided with the intermediate layer 1 and the intermediate layer 2.

### Comparative Example 18, Example 24

### Gas Barrier Films 41 and 42

Gas barrier films 41 and 42 were obtained in the same manner as in Comparative Example 12 except for changing the film laminated material 16 provided with the intermediate layer 1 and the intermediate layer 2 into the film substrate 16 or the film substrate 21, which is not provided with the intermediate layer 1 and the intermediate layer 2.

### Comparative Example 19

### Gas Barrier Film 43

A gas barrier film 43 was obtained in the same manner as in Comparative Example 12 except for changing an excimer light intensity of 130 mw/cm² (172 nm) that is a modification treatment condition in the modification step into 180 mW/cm² (172 nm).

### Example 25

### Gas Barrier Film 44

Gas barrier film 44 was obtained in the same manner as in Comparative Example 19 except for changing the film laminated material 16 provided with the intermediate layer 1 and the intermediate layer 2 into the film laminated material 21 provided with the intermediate layer 1 and the intermediate layer 2.

### Comparative Example 20

### Gas Barrier Film 45

A gas barrier film 45 was obtained in the same manner as in Comparative Example 12 except for changing an excimer light intensity of 130 mW/cm² (172 nm) that is a modification treatment condition in the modification step into 80 mW/cm² (172 nm).

### Example 20

### Gas Barrier Film 46

Gas barrier film 46 was obtained in the same manner as in Comparative Example 20 except for changing the film laminated material 16 provided with the intermediate layer 1 and the intermediate layer 2 into the film laminated material 21 provided with the intermediate layer 1 and the intermediate layer 2.

### Comparative Example 21, Example 27

### Gas Barrier Films 47 and 48

Gas barrier films 47 and 48 were obtained in the same manner as in Comparative Example 20 except for changing the film laminated material 16 provided with the intermediate layer 1 and the intermediate layer 2 into the film substrate 16 or the film substrate 21, which is not provided with the intermediate layer 1 and the intermediate layer 2.

(Plasma Spatter of SiOₓ)

### Comparative Example 22

### Gas Barrier Film 49

A gas barrier layer made of SiOₓ (x=1.8, by XPS) having a film thickness of 70 nm was formed on beach surfaces of the film substrate 16 which is not provided with the intermediate layer 1 and the intermediate layer 2, by reactive spatter introduced with an argon gas and an oxygen gas as process oases at a film formation temperature of 180° C. using Si as a target by DC magnetron spatter by use of a plasma generation spatter roll coat apparatus to thus obtain a gas barrier film 49. During the film formation, the film thickness of the gas barrier layer was adjusted according to a reaction time.

### Example 28

### Gas Barrier Film 50

A gas barrier film 50 was obtained in the same manner as in Comparative Example 22 except for changing the film substrate 16 which is not provided with the intermediate layer 1 and the intermediate layer 2 into the film substrate 21 which is not provided with the intermediate layer 1 and the intermediate layer 2.

Constitutions and production methods of the gas barrier films 1 to 50 prepared in Comparative Examples 1 to 22 and Examples 1 to 28 described above are shown in Tables 3 and 4.

[Evaluation]

Water vapor permeability (water vapor barrier evaluation), surface roughness (surface smoothness evaluation), transparency, bending characteristics, cutting processability and storage property of the gas barrier films 1 to 50 were evaluated in the methods described below.

(Water Vapor Permeability)
1. Preparation of Cell for Evaluation of Water Vapor Barrier Property

Metal calcium (granular) as a transparent conductive file was deposited on one surface of a gas barrier layer in each of the gas barrier films 1 to 50, using a vacuum deposition apparatus (vacuum deposition apparatus, JEE-400, manufactured by JEOL Ltd). In this time, deposition was carried out with masking places other then a part to which she transparent conductive film is deposited (9 parts with a size of 12 mm×12 mm). Note that calcium is a metal that corrodes by reacting with moisture.

Thereafter, the mask was removed while keeping the vacuum condition, and aluminum that is a water vapor impermeable metal (φ 3 to 5 mm, granular) was deposited on the other entire surface of each of the gas barrier films 1 to 44 from the other metal deposition source.

The vacuum condition was removed after sealing with aluminum and, in a dry nitrogen gas atmosphere, a quartz glass having a thickness of 0.2 mm was rapidly adhered onto the aluminum-sealed surface using an ultraviolet curing resin for sealing (manufactured by Nagase ChemteX Co., Ltd.), and ultraviolet rays were irradiated to prepare a cell for evaluating water vapor barrier property.
2. Measurement of Moisture Permeation Amount

The obtained evaluation cell that was sealed on both surfaces was preserved under a higher temperature and high humidity at 60° C., 90% RH, using a constant temperature and high humidity oven (Yamato Humidic Chamber IG47M) and a water content permeated into the cell was calculated from a corrosion amount of metal calcium based on the method described in Japanese Patent Application Laid-Open No. 2005-283561.

In addition, in order to confirm no permeation of water vapor other than water vapor permeation from the barrier film surface, a sample obtained by depositing metal calcium onto a quartz glass plate with a thickness of 0.2 mm was preserved under a higher temperature and a high humidity at 60° C., 90% RH, using a constant temperature and humidity oven (Yamato Humidic Chamber IG47M) as a comparative sample in the same manner as described above in place of a gas barrier film, and it was confirmed that there was no generation of corrosion of metal calcium even after an elapsed time for 1000 hours.

The obtained moisture permeation amounts more classified into 5 stages described below.
5: Less than 1×10⁻⁴ g/m²/day
4: 1×10⁻⁴ g/m²/day or more, less than 1×10⁻³ g/m²/day
3: 1×10⁻³ g/m²/day or more, less than 1×10⁻² g/m²/day
2: 1×10⁻² g/m²/day or more, less than 1×10⁻¹ g/m²/day
1: 1×10⁻¹ g/m²/day or more

The results are given in Tables 3 and 4.

(Surface Roughness Ra: Surface Smoothness)

The surface roughness Ra was calculated from an uneven cross sectional curve continuously measured with a detector having a sensing pin with a minute tip radium using an atomic force microscope (AFM; DI3100 manufactured by Digital Instruments, Inc.) and measured within else section of 30 μm in the measurement direction by a sensing pin with a minute tip radium many times, and the surface roughness was found from an average roughness relating to amplitude of fine unevenness.

The results are given in Tables 3 and 4.

(Transparency: Haze Values)

A haze value (%) was measured using a haze meter (NDH2000, manufactured by NIPPON DENSHOKU INDUSTRIES CO., LTD.) as a measure of transparency.

The results are given in Tables 3 and 4.

(Bending Characteristics)

Bending at an angle of 180° was repeated on the gas barrier films 1 to 50 one hundred times so as to have a curvature of a radius of 10 mm.

Cells for water vapor barrier property evaluation were prepared using the gas barrier films 1 to 50 after bending in the same method as described above and evaluation of a water vapor permeability was carried out.

A ratio of a water vapor permeability of a gas barrier film after bending to a water vapor permeability of a gas barrier film before bending (water vapor permeability after bending/water vapor permeability before bending×100(%)) was calculated and a degree of deterioration due to bending was evaluated.

Wearer vapor permeability after bending/water vapor permeability before bending×100(%)
◯: 85% or more
Δ: Less than 60%
X: Less than 30%
   The results are given in Tables 3 and 4.

(Cutting Processability)

When the gas barrier films 1 to 50 were cut into a B5 size using a disc cutter DC-230 (CADL Co.), cracks generated in the cut edges were evaluated.
◯: No generation of crack
Δ: Generation of 5 or less cracks
X: Generation of 5 or more cracks

(Adhesivity)

A heat treatment was carried out on the gas barrier films 1 to 50 in an oven at 100° C. for 5 hours.

After the heat treatment, the gas barrier films 1 to 50 were cut in a cross-cut state using a cutter guide with a gap interval of 2 nm in accordance with the cross-cut test in reference to JIS K 5400 and 180° peeling was performed using a tape, and a residual ratio of a film (%) was measured to be evaluated as adhesivity.

The results are given in Tables 3 and 4.

TABLE 3

| | Gas | | | | | | Water | Bending | | | |
|---|---|---|---|---|---|---|---|---|---|---|---|
| | barrier | Film | | Gas barrier | | Trans- | vapor | charac- | Cut | Adhesivity (%) | |
| | property | substrate | Intermediate | layer formation | Surface | parency | perme- | teris- | process- | Before | After |
| | film No. | No. | layer | method | roughness Ra | (%) | ability | tics | ability | heating | heating |
| Comparative | 1 | 1 | Present | Excimer | 6.5 | 2.10 | 1 | x | Δ | 79 | 47 |
| Example 1 | | | | (130 mW/cm²) | | | | | | | |
| Comparative | 2 | 2 | Present | Excimer | 6.1 | 1.67 | 1 | x | Δ | 83 | 52 |
| Example 2 | | | | (130 mW/cm²) | | | | | | | |
| Example 1 | 3 | 3 | Present | Excimer | 3.3 | 0.89 | 4 | ∘ | ∘ | 100 | 100 |
| | | | | (130 mW/cm²) | | | | | | | |
| Example 2 | 4 | 4 | Present | Excimer | 3 | 0.83 | 4 | ∘ | ∘ | 100 | 100 |
| | | | | (130 mW/cm²) | | | | | | | |
| Example 3 | 5 | 5 | Present | Excimer | 2.6 | 0.77 | 5 | ∘ | ∘ | 100 | 100 |
| | | | | (130 mW/cm²) | | | | | | | |
| Example 4 | 6 | 6 | Present | Excimer | 2.4 | 0.74 | 5 | ∘ | ∘ | 100 | 100 |
| | | | | (130 mW/cm²) | | | | | | | |
| Example 5 | 7 | 7 | Present | Excimer | 1.7 | 0.76 | 5 | ∘ | ∘ | 100 | 100 |
| | | | | (130 mW/cm²) | | | | | | | |
| Example 6 | 8 | 8 | Present | Excimer | 1.8 | 0.75 | 5 | ∘ | ∘ | 100 | 100 |
| | | | | (130 mW/cm²) | | | | | | | |
| Example 7 | 9 | 9 | Present | Excimer | 1.6 | 0.75 | 5 | ∘ | ∘ | 100 | 100 |
| | | | | (130 mW/cm²) | | | | | | | |
| Comparative | 10 | 10 | Present | Excimer | 4.4 | 1.65 | 1 | Δ | Δ | 82 | 50 |
| Example 3 | | | | (130 mW/cm²) | | | | | | | |
| Comparative | 11 | 11 | Present | Excimer | 8.4 | 1.83 | 1 | x | Δ | 41 | 21 |
| Example 4 | | | | (130 mW/cm²) | | | | | | | |
| Comparative | 12 | 12 | Present | Excimer | 8.9 | 2.14 | 1 | x | Δ | 26 | 0 |
| Example 5 | | | | (130 mW/cm²) | | | | | | | |
| Example 8 | 13 | 13 | Present | Excimer | 2.8 | 0.78 | 5 | ∘ | ∘ | 99 | 96 |
| | | | | (130 mW/cm²) | | | | | | | |
| Example 9 | 14 | 14 | Present | Excimer | 3.3 | 0.84 | 4 | Δ | Δ | 94 | 90 |
| | | | | (130 mW/cm²) | | | | | | | |
| Comparative | 15 | 15 | Present | Excimer | 6.7 | 1.25 | 3 | x | Δ | 84 | 68 |
| Example 6 | | | | (130 mW/cm²) | | | | | | | |
| Comparative | 16 | 1 | None | Excimer | 7.2 | 2.22 | 1 | x | x | 56 | 32 |
| Example 7 | | | | (130 mW/cm²) | | | | | | | |
| Example 10 | 17 | 6 | None | Excimer | 2.7 | 0.80 | 4 | Δ | ∘ | 100 | 97 |
| | | | | (130 mW/cm²) | | | | | | | |
| Comparative | 18 | 1 | Present | Excimer | 7.1 | 0.24 | 1 | x | Δ | 76 | 52 |
| Example 8 | | | | (180 mW/cm²) | | | | | | | |
| Example 11 | 19 | 6 | Present | Excimer | 2.5 | 0.78 | 4 | ∘ | ∘ | 100 | 130 |
| | | | | (180 mW/cm²) | | | | | | | |
| Comparative | 20 | 1 | Present | Excimer | 6.5 | 2.02 | 1 | x | Δ | 80 | 63 |
| Example 9 | | | | (80 mW/cm²) | | | | | | | |
| Example 12 | 21 | 6 | Present | Excimer | 2.3 | 0.73 | 5 | ∘ | ∘ | 100 | 100 |
| | | | | (80 mW/cm²) | | | | | | | |
| Comparative | 22 | 1 | None | Excimer | 6.8 | 2.18 | 1 | x | Δ | 61 | 29 |
| Example 10 | | | | (80 mW/cm²) | | | | | | | |
| Example 13 | 23 | 6 | None | Excimer | 2.7 | 0.78 | 4 | Δ | ∘ | 100 | 99 |
| | | | | (80 mW/cm²) | | | | | | | |
| Comparative | 24 | 1 | None | Plasma | 6.4 | 2.40 | 2 | x | x | 44 | 26 |
| Example 11 | | | | | | | | | | | |
| Example 14 | 25 | 6 | None | Plasma | 2.2 | 0.95 | 3 | Δ | Δ | 100 | 100 |

TABLE 4

| | Gas | | | | | | Water | Bending | | | |
|---|---|---|---|---|---|---|---|---|---|---|---|
| | barrier | Film | | Gas barrier | | Trans- | vapor | charac- | Cut | Adhesivity (%) | |
| | property | substrate | Intermediate | layer formation | Surface | parency | perme- | teris- | process- | Before | After |
| | film No. | No. | layer | method | roughness Ra | (%) | ability | tics | ability | heating | heating |
| Comparative | 26 | 16 | Present | Excimer | 4.8 | 1.89 | 1 | x | Δ | 80 | 51 |
| Example 10 | | | | (130 mW/cm²) | | | | | | | |
| Comparative | 27 | 17 | Present | Excimer | 4.5 | 1.60 | 1 | x | Δ | 85 | 55 |
| Example 11 | | | | (130 mW/cm²) | | | | | | | |
| Example 17 | 28 | 18 | Present | Excimer | 3.1 | 0.82 | 4 | ∘ | ∘ | 100 | 100 |
| | | | | (130 mW/cm²) | | | | | | | |
| Example 18 | 29 | 19 | Present | Excimer | 2.8 | 0.84 | 4 | ∘ | ∘ | 100 | 100 |
| | | | | (130 mW/cm²) | | | | | | | |
| Example 19 | 30 | 20 | Present | Excimer | 2.5 | 0.74 | 5 | ∘ | ∘ | 100 | 100 |
| | | | | (130 mW/cm²) | | | | | | | |
| Example 20 | 31 | 21 | Present | Excimer | 2.2 | 0.72 | 5 | ∘ | ∘ | 100 | 100 |
| | | | | (130 mW/cm²) | | | | | | | |
| Example 21 | 32 | 22 | Present | Excimer | 1.7 | 0.71 | 5 | ∘ | ∘ | 100 | 100 |
| | | | | (130 mW/cm²) | | | | | | | |
| Example 22 | 33 | 23 | Present | Excimer | 1.7 | 0.70 | 5 | ∘ | ∘ | 100 | 100 |
| | | | | (130 mW/cm²) | | | | | | | |
| Example 23 | 34 | 24 | Present | Excimer | 1.6 | 0.70 | 5 | ∘ | ∘ | 100 | 100 |
| | | | | (130 mW/cm²) | | | | | | | |
| Example 24 | 35 | 25 | Present | Excimer | 3.4 | 1.16 | 2 | Δ | Δ | 79 | 43 |
| | | | | (130 mW/cm²) | | | | | | | |
| Example 25 | 36 | 26 | Present | Excimer | 6.1 | 1.26 | 1 | x | x | 44 | 22 |
| | | | | (130 mW/cm²) | | | | | | | |
| Comparative | 37 | 27 | Present | Excimer | 7.7 | 1.33 | 1 | x | Δ | 31 | 0 |
| Example 12 | | | | (130 mW/cm²) | | | | | | | |
| Example 26 | 38 | 28 | Present | Excimer | 2.3 | 0.76 | 5 | ∘ | ∘ | 100 | 97 |
| | | | | (130 mW/cm²) | | | | | | | |
| Example 27 | 39 | 29 | Present | Excimer | 2.6 | 0.93 | 4 | Δ | Δ | 36 | 97 |
| | | | | (130 mW/cm²) | | | | | | | |
| Comparative | 40 | 30 | Present | Excimer | 3.3 | 1.23 | 3 | x | Δ | 86 | 63 |
| Example 13 | | | | (130 mW/cm²) | | | | | | | |
| Comparative | 41 | 16 | None | Excimer | 5.2 | 2.04 | 1 | x | Δ | 56 | 39 |
| Example 14 | | | | (130 mW/cm²) | | | | | | | |
| Example 28 | 42 | 21 | None | Excimer | 2.5 | 0.80 | 4 | ∘ | ∘ | 100 | 99 |
| | | | | (130 mW/cm²) | | | | | | | |
| Comparative | 43 | 16 | Present | Excimer | 5.5 | 1.90 | 1 | x | Δ | 79 | 83 |
| Example 15 | | | | (180 mW/cm²) | | | | | | | |
| Example 29 | 44 | 21 | Present | Excimer | 2.4 | 0.74 | 4 | ∘ | ∘ | 100 | 100 |
| | | | | (180 mW/cm²) | | | | | | | |
| Comparative | 45 | 16 | Present | Excimer | 5.1 | 1.87 | 1 | x | Δ | 83 | 83 |
| Example 16 | | | | (80 mW/cm²) | | | | | | | |
| Example 30 | 46 | 22 | Present | Excimer | 2.1 | 0.72 | 5 | ∘ | ∘ | 100 | 100 |
| | | | | (80 mW/cm²) | | | | | | | |
| Comparative | 47 | 16 | None | Excimer | 5.3 | 1.97 | 1 | x | Δ | 63 | 31 |
| Example 17 | | | | (80 mW/cm²) | | | | | | | |
| Example 31 | 48 | 21 | None | Excimer | 2.3 | 0.76 | 4 | ∘ | ∘ | 100 | 100 |
| | | | | (80 mW/cm²) | | | | | | | |
| Comparative | 49 | 16 | None | Plasma | 5.9 | 2.29 | 2 | x | x | 48 | 29 |
| Example 18 | | | | | | | | | | | |
| Example 32 | 50 | 21 | None | Plasma | 1.9 | 0.94 | 3 | Δ | Δ | 100 | 100 |

According to Tables 3 and 4, it is confirmed that gas barrier films of examples each obtained by forming a gas barrier layer on a sheet substrate containing a surface-modified cellulose nanofiber in which at least a part of hydrogen atoms in a hydroxyl group in a cellulose in the surface of the cellulose nanofiber accounting to the present invention are substituted with acyl groups and not substantially containing a matrix resin are excellent in transparency, smoothness (surface roughness Ra), gas barrier property (water vapor permeability), adhesivity, bending characteristics, and cutting processability. In particular, preferable adhesivity can be kept in the gas barrier films of examples even when thermally treated.

The gas barrier films in which a gas barrier layer is formed by excimer irradiation to a polysilazane compound coated film in examples are significantly improved in gas barrier property and cutting processability as compared to the gas barrier films (Nos. 25 and 50) in which gas barrier layers were formed by reactive spatter with plasma in Examples 14 and 28.

A gas barrier film in which a cellulose nanofiber is substituted with a propanoyl group is significantly improved in smoothness and transparency as compared to the case of being substituted with an acetyl group or a butanoyl group (Examples 1, 2, 15 and 16).

When as intermediate layer is placed (Examples 4, 12, 18 and 26), it is found that gas barrier property is improved as compared to the case of not placing an intermediate layer (Examples 10, 13, 24 and 27).

On the contrary, gas barrier films using unsubstituted cellulose nanofibers in comparative examples are inferior to transparency, smoothness (surface roughness Ra), gas barrier property (water vapor permeability) and storage property (adhesivity) as compared to the gas barrier films in examples. In particular, smoothness and storage property significantly deteriorate in the gas barrier films (Nos. 12 and 37) containing large contents of matrix resins in Comparative Example 5 and Comparative Example 16.

### EXPLANATION OF SYMBOLS

1 Sheet, substrate,
2a, 2b Intermediate layer,
3a, 3b Gas barrier layer,
10 Gas barrier film.

1. A gas barrier film comprising a sheet substrate which contains a surface-modified cellulose nanofiber in which at least a part of hydrogen atoms in a hydroxyl group in a cellulose nanofiber are substituted with acyl groups each having 1 to 8 carbon atoms and has a content of a matrix resin of 10% by mass or less with respect to the total amount of the cellulose nanofiber and the matrix resin, and
a gas barrier layer which is formed on at least one surface of the sheet substrate.

2. The gas barrier film according to claim 1, wherein the acyl group comprises a propanoyl group.

3. The gas barrier film according to claim 1, wherein the gas barrier layer comprises at least one of silicon oxide, silicon nitride oxide and silicon oxynitride.

4. A manufacturing method of a gas barrier film, comprising a step A of obtaining a surface-modified cellulose nanofiber by substituting at least a part of hydrogen atoms in a hydroxyl group in a cellulose nanofiber with acyl groups each having 1 to 8 carbon atoms and forming the surface-modified cellulose nanofiber into a film by a melt extrusion method or a solution cast method, and
a step B of forming a gas barrier layer on the sheet substrate.

5. The manufacturing method according to claim 4, wherein a stretching treatment or/and a heat calendering treatment are performed after film formation in the step A.

6. The manufacturing method according to claim 4, wherein the step B comprises an excimer irradiation treatment after applying a coating liquid containing a polysilazane compound onto the sheet substrate.

7. A substrate for an electronic element using the gas barrier film according to claim 1.

8. A substrate for an electronic element using a gas barrier film which is manufactured by the manufacturing method according to claim 4.
